(19) United States
(12) Patent Application Publication
(10) Pub. No.: US 2023/0278039 A1
(43) Pub. Date: Sep. 7, 2023

(54) LABORATORY EQUIPMENT, CORRESPONDING USES AND METHODS

(71) Applicant: THERMO FISHER SCIENTIFIC GENEART GMBH, Regensburg (DE)

(72) Inventors: Ansgar ROMIG, Regensburg (DE); Alexander LOCHNER, Regensburg (DE); Mark KERZHNER, Regensburg (DE)

(21) Appl. No.: 18/040,500

(22) PCT Filed: Aug. 6, 2021
(86) PCT No.: PCT/EP2021/072026

§ 371 Date: Feb. 3, 2023

(30) Foreign Application Priority Data
Aug. 6, 2020 (GB) 2012261.0

(51) Int. Cl. B01L 9/00; B01L 3/00

(52) U.S. Cl. CPC B01L 9/527; B01L 3/502738; B01L 3/502715; B01L 2200/027; B01L 2200/10; B01L 2300/047; B01L 2400/0487; B01L 2400/0644; B01L 2300/0609; B01L 2300/042; B01L 2200/0689

(57) ABSTRACT

The present invention relates to devices, system and methods for synthesizing and post-processing nucleic acids. The system comprising a fluid supply unit, a synthesis unit comprising a microfluidic chip, configured for the synthesis of nucleic acids, a valve assembly, comprising at least one multiport valve, and a collection unit configured to collect nucleic acids. The method for synthesising nucleic acids utilizes the system and comprises synthesising nucleic acids on the microfluidic chip, selectively releasing synthesised nucleic acids from the microfluidic chip, guiding released nucleic acids to the collection unit, and collecting released nucleic acids in a well plate comprised by the collection unit. The method for post-processing synthesized nucleic acids comprises providing one or more nucleic acids attached to a solid support in a first compartment, adding a first solution to cleave the nucleic acids off the support and adding a second solution to elute the nucleic acids into a second compartment.

The present invention generally relates to laboratory equipment and corresponding uses and methods. While the present invention will be described with primary reference to equipment to synthesize nucleic acids, it should be understood that the present technology may also be applied in other fields (e.g. synthesis of peptides).

WO 2016094512 A1 discloses a technology to synthesize nucleic acids. This technology utilizes a microfluidic chip comprising a plurality of wells. In each well, there may be located a bead to which nucleic acids can be added. Each well can be individually electrically controlled. By means of this control, at least one property of the well can be changed. For example, by applying a voltage or a current to an individual well, a pH in this well can be changed, which pH change may lead to coupling of nucleotides to the bead. Thus, one can supply a solution containing nucleotides (e.g. phosphoramidites) to the microfluidic chip and control the environment in the individual wells to thus define onto which beads the nucleotide is attached. This process can be repeated to build up sequences of nucleic acids on the beads. The nucleic acids thus generated may have lengths of approximately 30 to 100 bases, and such nucleic acids may be referred to as oligonucleotides. Thus, there may be one bead per well and to each such bead, a defined oligonucleotide is attached.

Further, one can use the electrical control of the individual wells to release one or more beads to which the oligonucleotides are attached in a defined manner. More particularly, one can apply a voltage or a current to selected wells where the beads should be released to thereby release the beads from these wells. In WO 2016094512 A1, for example, bubbles may form in response to the voltage or current, lifting the bead out of the well. Thus, when flushing the microchip with a liquid, the beads which are lifted up can be released from the microchip. Thus, beads with defined oligonucleotides may be selected and removed from individual wells for further processing.

Known systems or workflows for oligonucleotide synthesis typically comprise separate units or modules for synthesis, collection and processing of oligonucleotides.

While such modular technology may be satisfactory in some regards, it has certain drawbacks and limitations. In particular, systems consisting of separate or independent modules for conducting isolated steps of the workflow may not be particularly efficient and may require a high amount of labour from highly trained personnel. Further, some implementations may not be optimal as regards operational safety and ease of use. In addition, an integrated system as described herein allows for improved control and documentation.

In light of the above, it is an object to overcome or at least alleviate the shortcomings and disadvantages of the prior art. That is, it is an object of the present invention to provide laboratory equipment (and corresponding uses and methods), particularly for use in nucleic acids synthesis, which is easy to use, requires less supervision, is safer and/or more efficient.

These objects are met by the present invention.

In a first embodiment, the present invention relates to a gas distribution unit. The gas distribution unit comprises an inlet configured to receive a gas, at least one outlet, and at least one valve. Further, the gas distribution unit is configured to supply the gas at the at least one outlet at a predetermined pressure.

The gas distribution unit may further comprise a vent. Additionally, the at least one valve of the gas distribution unit may comprise a valve inlet, a valve outlet, and a ventilation outlet, wherein the ventilation outlet may be fluidly connected to the vent.

The at least one valve may be a proportional valve. That is, the valve may be configured to regulate the pressure at the output proportional to an applied signal, e.g. an electrical signal such as a signal corresponding to a pressure setpoint. Thus, the proportional valve may allow for continuously changing the valve configuration between fully opened and fully closed.

The proportional valve may further comprise a proportioning mechanism configured to control the extent to which the valve outlet is fluidly connected to the valve inlet in a continuous fashion. That is, the fluid connection between the valve inlet and the valve outlet may comprise a maximal cross-section and the proportioning mechanism may continuously alter the cross section from closed (no fluid connection) to a fully open (maximal cross-section). That is, it may assume any position in between and including both extrema.

The proportioning mechanism may comprise a piezoelectric element. For example, it may comprise a piezoelectric ceramic or crystal, which may for example be contracted by applying an electrical field. Alternatively, the proportioning mechanism may comprise an electromagnetic coil. That is, the proportioning mechanism may be based on at least one element interacting with a magnetic field to regulate the pressure at the output of the valve. In some embodiments the proportioning mechanism may comprise mechanical means, e.g. a set screw.

The at least one valve may be configured to assume a ventilation configuration wherein the valve outlet is fluidly connected to the ventilation outlet. Thus, the valve may be configured to assume a configuration, wherein a connected gas conduit may for example be depressurized by connecting it to the vent.

The gas distribution unit may further comprise a pressure sensor for each of the at least one outlet, respectively. Further, each pressure sensor may be configured to determine a pressure at the respective outlet and to provide a corresponding pressure signal. For example, the pressure sensor may be comprised by the at least one valve.

The at least one valve of the distribution unit may further comprise an interface configured for receiving a signal comprising at least one setpoint value for the predetermined pressure or at least one control signal for regulating an extent to which the valve outlet is fluidly connected to the valve inlet.

In some embodiments, the interface may further be configured to provide the pressure signal of at least one pressure sensor. That is, the interface may enable other components to access the pressure signal of one or more pressure sensors. Furthermore, the interface may be configured for receiving a signal comprising at least one pressure determined by an external pressure sensor.

The gas distribution unit may be configured to provide the gas at each of the at least one outlet at an individual predetermined pressure. That is, the gas distribution unit may supply the gas at each of its outlets at a predetermined pressure, wherein the pressure may be different for each outlet of the gas distribution unit.

The gas distribution unit may comprise a safety valve for each of the at least one outlet, wherein each safety valve may comprise a safety valve inlet, a safety valve outlet, and a safety valve ventilation outlet, wherein the safety valve ventilation outlet may be fluidly connected to the vent.

The safety valve may be configured to assume a safety configuration whenever the safety valve is not supplied with power, wherein in the safety configuration the safety valve outlet may be fluidly connected to the safety valve ventilation outlet. This may advantageously ensure, that all fluid containers are depressurized when the system is shut down, e.g. planned or due to a power cut. Thus, it may ensure that no energy is stored in the system.

Further, the safety valve inlet may be fluidly connected to a valve outlet and the safety valve outlet may be fluidly connected to one of the at least one outlets of the gas distribution unit. That is, the safety valve may be downstream of the respective valve outlet, and upstream of the respective outlet of the gas distribution unit.

The gas distribution unit may be configured to assume a default mode when not supplied with electric power, wherein the at least one outlet may be at atmospheric pressure in the default mode. Again, such a default mode may be advantageous for the safe operation of the system as it ensures that the connected components, e.g. fluid containers, are depressurized if the system is shut down either planned or unplanned, e.g. due to a power cut.

The gas distribution unit may be configured to supply gas at the at least one outlet at pressures in the range of 0 bar to 3 bar, preferably 0.1 bar to 2 bar, more preferably 0.2 bar to 1 bar.

Very generally, pressures within this specification are specified relative to the surrounding atmospheric pressure of the fluid supply unit, e.g. an atmospheric pressure of essentially 1 bar. Therefore, a range of 0 bar to 2 bar as specified above, would correspond to an absolute pressure of 1 to 3 bar if the surrounding atmospheric pressure amounts to 1 bar. However, the exact value of the atmospheric pressure may vary for example due to different environmental conditions.

In a further embodiment, the present invention relates to a fluid supply unit comprising a plurality of fluid containers each configured to store a fluid, a gas supply, configured to provide a gas at a controlled pressure through at least one outlet, and at least one valve manifold. The valve manifold comprises a plurality of inlets and an outlet, wherein each of the at least one valve manifold is configured to selectively fluidly connect at least one inlet to the outlet.

Very generally, the fluid supply unit may be configured to selectively provide fluids stored in the fluid containers to connected components, e.g. for nucleic acid synthesis.

The plurality of fluid containers may each contain a liquid. In particular, fluid containers of the fluid supply unit may for example comprise the nucleobases cytosine, guanine, adenine, thymine and/or uracil, and/or liquids, e.g. reagents, for processing and/or washing oligonucleotides, such as any of acetonitrile and activator, oxidizer and capping solutions.

Further, each of the plurality of fluid containers may be fluidly connected to an outlet of the gas supply by means of a gas conduit. That is, each fluid container may be fluidly connected to the gas supply through gas-tight tubing. In some embodiments, a subset of fluid containers may be fluidly connected to the same output of the gas supply via a gas supply branch. It will be understood that a subset of fluid containers may comprise a single fluid container, all fluid containers or any number of fluid containers therebetween. Thus, in some embodiments, the gas supply branch merely comprises a single gas conduit.

Thus, individual gas conduits may be interconnected, e g utilizing T- or Y-connectors, to form a gas supply branch which may be connected to an outlet of the gas supply. That is, all fluid containers connected to the same gas supply branch may be supplied with gas from a single outlet of the gas supply, particularly they may all be supplied with gas at the same pressure.

The gas conduits may be formed of a polymer. That is, the gas-tight tubing may be a polymer tubing, which may advantageously be flexible. This may advantageously allow for flexible, less stringent (relative) positioning of fluid containers and/or gas supply with respect to each other and for example facilitate exchanging or refilling a fluid container. Alternatively, the gas conduits may be formed of stainless steel. Stainless steel tubing may for example be more durable and/or provide a better resistance to certain chemicals compared to some polymer tubing.

Furthermore, a connection between a gas conduit and the respective fluid container may be configured such that the gas conduit is not directly fluidly connected to the liquid contained by the fluid container. That is, the gas conduit may be connected to the fluid container such that there is no direct connection between the gas conduit and the liquid stored in the fluid container, e.g. it may be inserted into the fluid container such that it ends above the surface of the contained liquid. For example, the gas conduit may end in the upper third of an interior volume of the fluid container, such as within the bottleneck in case the fluid container resembles the shape of a bottle. Generally, such a connection may be advantageous, as it may prevent contamination of the gas conduits and/or gas supply branches with liquids and particularly prevent cross contamination between different fluid containers connected to the same gas supply branch.

Each gas conduit may be configured for pressures of at least 0.5 bar, preferably at least 1 bar, more preferably at least 2 bar Again, pressures within this specification are defined relative to atmospheric pressure surrounding the respective component, e.g. the gas conduit.

Further, each fluid container may be fluidly connected to an inlet of at least one of the at least one valve manifold by means of a fluid conduit. In some embodiments, each inlet of the at least one valve manifold may be fluidly connected to at most one fluid container.

A connection between a fluid conduit and the respective fluid container may be configured such that the fluid conduit is directly connected to the liquid contained by the fluid container. That is, the fluid conduit may be connected to the fluid container such that there is a direct connection to the liquid stored in the fluid container, e.g. it may be inserted into the fluid container such that it extends below the surface of the contained liquid. For example, the fluid conduit may end close to the bottom of the fluid container. This may advantageously allow to provide a fluid flow through the fluid conduit by pressurizing the fluid container with gas provided by the gas supply.

Each fluid conduit may be configured for pressures of at least 0.5 bar, preferably at least 1 bar, more preferably at least 2 bar.

Further, at least one of the at least one valve manifold may comprise a multiport coupling valve, wherein the multiport coupling valve may be configured to fluidly connect at any time at most one of the plurality of inlets of the valve manifold to the outlet of the respective valve manifold. A multiport coupling valve may for example be a rotary valve comprising a plurality of valve connections and a single groove, wherein the rotary valve is configured to directly fluidly connect two fluid connections via the groove.

At least one of the at least one valve manifold may comprise a respective coupling valve for each of the plurality of inlets. Such a coupling valve may for example be a 2-port valve, configured to open and close the fluid connection between the two ports. Advantageously, the valve may allow flow in both directions through the valve when in an open configuration, i.e. flow from port 1 to port 2 as well as flow from port 2 to port 1.

Each of the coupling valves may be configured to selectively fluidly connect or disconnect the corresponding inlet of the at least one valve manifold to the outlet of the respective valve manifold. For example, the one port of each coupling valve may be directly fluidly connected to an inlet of the valve manifold and the other port of each coupling valve may be fluidly connected to the output of the valve manifold. That is, the ports may for example be combined utilizing T- or Y-pieces to be simultaneously fluidly connected to the outlet of the valve manifold.

Further, at least one of the at least one valve manifold may be configured to fluidly connect at any time at most one of the plurality of inlets of the valve manifold to the outlet of the respective valve manifold. That is, in some embodiments, the valve manifold may only provide a fluid connection between one of its inlets and the outlet at a point in time.

At least one of the at least one valve manifold may be configured to enable a fluid flow from the outlet of the manifold to any of the plurality of inlets of the respective valve manifold. This may for example be advantageous for backflushing at least portions of the system, e.g. to remove a fluid from fluidic conduits downstream of the valve manifold prior to introducing another fluid.

An inlet of at least one of the at least one valve manifold may be directly fluidly connected to the gas supply. That is, an inlet of the respective valve manifold may be fluidly connected to the gas supply without the fluid connection comprising any other part of the fluid supply system, particularly no fluid container. In other words, a gas conduit may directly connect an outlet of the gas supply to an inlet of the valve manifold.

In some embodiments, the fluid supply unit may comprise two valve manifolds. Additionally, at least one of the plurality of fluid containers may be fluidly connected to both valve manifolds. Thus, such a fluid container may provide the contained fluid to both valve manifolds. This may be advantageous, as the output of each valve manifold may for example be fluidly connected to different components and therefore the fluid comprised by the fluid container may be delivered to each of said components.

Furthermore, the at least one valve manifold may be configured to allow for mixing of fluids supplied at the plurality of inlets of the at least one valve manifold by alternately connecting the respective inlets to the outlet of the corresponding valve manifold. That is, the at least one valve manifold may be configured to allow mixing of fluids before they are supplied to other components of the system, e.g. a synthesis unit. It has been found that certain reagents can be efficiently mixed in the at least one valve manifold by alternate injection as described below.

The gas supply may comprise a gas reservoir configured to provide a gas and a gas distribution unit. A gas reservoir may for example be a gas bottle, a gas tank or a gas pipe, which provides the respective gas.

The gas distribution unit may comprise an inlet and at least one outlet. Further, the gas distribution unit may be configured to receive gas from the gas reservoir at the inlet and to provide the gas at the at least one outlet at a predetermined pressure.

The gas distribution unit may be configured to provide the gas at each of the at least one outlet at an individual predetermined pressure. That is, the gas distribution unit may supply the gas at each of its outlets at a predetermined pressure, wherein the pressure may be different for each outlet of the gas distribution unit.

In some embodiments of the fluid supply unit, the gas distribution unit may be a gas distribution unit as described above.

The gas supply may be configured to provide gas at a pressure in the range of 0 bar to 3 bar, preferably 0.1 bar to 2 bar, more preferably 0.2 bar to 1 bar. That is, generally the gas supply may be configured to supply gas at a pressure that is higher than (or equal to) atmospheric pressure.

The gas reservoir may provide argon or N₂. Advantages of using argon or N₂ may be that both gases are non-toxic and naturally occurring. Further, they are also chemically inert, which may advantageously prevent any undesired chemical reactions between the gas and any fluids in the fluid containers.

The fluid supply unit may be configured to pressurize each of the plurality of fluid containers with gas provided by the gas supply. That is, the fluid supply unit may be configured to provide the fluid containers with gas at a pressure above the atmospheric pressure surrounding the fluid containers. That is, the fluid supply unit may be configured to supply gas to the fluid containers at an elevated pressure with respect to the surrounding atmospheric pressure such that the fluidic containers may be pressurized, i.e. there may be a pressure difference established between the inside and the outside of the fluid containers, wherein the inside may be at a higher pressure than the outside of the fluid container.

Each of the plurality of fluid containers may comprise an internal volume and the internal volume of each of the plurality of fluid containers may be pressurized to a pressure in the range of 0.1 bar to 2 bar, preferably 0.2 bar to 1 bar, more preferably 0.3 bar to 0.8 bar.

The fluid supply system may further comprise at least one pressure sensor, configured to determine a pressure of a fluid and provide a corresponding pressure signal. Such a pressure sensor may for example be configured to measure the pressure in a fluid or gas conduit, or in a fluid container. In some embodiments, the pressure sensor may be comprised by the gas supply.

The fluid supply system may further comprise at least one flow sensor, configured to determine a flow rate of a fluid and provide a corresponding flow signal. Similarly to the pressure sensor, the flow sensor may be configured to measure the flow rate of a fluid in a gas or fluid conduit of the fluid supply unit.

The fluid supply unit may be configured to supply a fluid at the outlet of the at least one valve manifold at a pressure in the range of 0 bar to 3 bar, preferably 0.1 bar to 2 bar, more preferably 0.2 bar to 1 bar.

The fluid supply unit may be configured to supply a fluid at the outlet of the at least one valve manifold at a flow rate in the range of 0.1 ml/min to 50 ml/min, more preferably 0.5 ml/min to 20 ml/min.

In some embodiments, a subset of the plurality of fluid containers may be surrounded by a safety housing. That is, a subset of the fluid containers may be encased by a safety housing. The safety housing may comprise a tray, configured to contain any liquid leaking out of a fluid container. That is, the safety housing may advantageously protect the surrounding from any spillage of a fluid, e.g. in case a fluid container within the safety housing is leaking.

Further, the safety housing may in some embodiments be configured to be fluid tight. That is, it may be configured to prevent any uncontrolled leakage of a fluid, e.g., liquid, out of the safety housing. Additionally or alternatively, the safety housing may comprise a ventilation. The ventilation may for example allow for a controlled removal of any excess gas within the safety housing.

Furthermore, the safety housing may be explosion-resistant. That is, the safety housing may be configured to withstand and/or contain an explosion. This may be advantageous, as the fluid containers may typically be pressurized during operation, such that a damaged fluid container may break during operation. That is, due to the pressure difference between the inside and the outside of the fluid container, fragments of the broken fluid container may be accelerated and present a risk to humans and equipment in the surrounding area. Therefore, the safety housing may provide a measure to at least significantly reduce the risk of damages due to a breaking fluid container.

The safety housing may comprise a control mechanism configured to indicate if a fluid container within the safety housing is pressurized. That is, the control mechanism may for example receive at least one pressure signal of a pressure sensor within the fluid supply unit, e.g. comprised by the gas supply, and based thereon indicate if the fluid containers within the safety housing are pressurized or not. Thus the control mechanism may advantageously prevent a user from opening the safety housing while fluid containers are still pressurized.

In some embodiments, the safety housing may be configured to be locked as long as any fluid container within the safety housing is pressurized. That is, the safety housing may only be opened when all fluid containers are depressurized, i.e. when all fluid containers are at atmospheric pressure The safety housing may comprise a temperature sensor configured to measure a temperature within the safety housing.

In a further embodiment, the present invention relates to a chip holder comprising a body, a cover plate, a chip cover, a chip receiving section, configured to accommodate a microfluidic chip, a sealing mechanism configured to maintain a leak-tight connection between the microfluidic chip and the chip cover, and a connecting mechanism configured to establish an electrical connection between a plurality of electrical contacts comprised by the microfluidic chip and corresponding electrical contacts comprised by the chip holder.

The chip holder may further comprise a drawer, configured to be moved in and out of the body, and wherein the drawer may comprise the chip receiving section. Further, the chip holder may be configured to assume an open configuration, wherein at least 60% of the drawer is located outside of the body, and a closed configuration, wherein at least 90% of the drawer is located inside the body. The drawer may aid with the exchange and correct placement of the microfluidic chip within the chip holder. For example, a user may move the drawer out of the body into the open configuration, which may advantageously allow for an easy access to the microfluidic chip which may be accommodated, e.g. placed in, the chip receiving section. In contrast, the closed configuration may allow to establish required connections (e.g. fluidic and/or electric) to the microfluidic chip required for processing.

The drawer may comprise at least one gliding element and the body comprises at least one guiding element, wherein the gliding element may be received by the guiding element. That is, the chip holder may comprise a gliding and/or guiding mechanism, which may advantageously facilitate for easy and secure movement of the drawer. In some embodiments, the at least one gliding element may comprise a runner and the at least one guiding element may comprise a complementary track configured to receive and guide the runner. That is, the guiding and gliding element in combination with the runner may provide a mechanism such as typically used for a drawer in a cabinet. Alternatively, the at least one gliding element may comprise a freely rotating rod and the at least one guiding element may comprise a notch or a slot configured to receive the freely rotating rod and to guide the rod and limit its range of movement.

In some embodiments, the chip holder may not comprise a drawer, instead the chip holder may comprise a slot-loading mechanism, configured to receive the microfluidic chip. The slot-loading mechanism may comprise a slit in the body of the chip holder and at least one motorized roller configured to draw the microfluidic chip into the chip receiving section. Generally, such a slot-mechanism may resemble the slot-mechanism known for example from CD drives. It may allow for a user to exchange the microfluidic chip without requiring the user to physically move components of the chip holder. Thus, a slot-mechanism may advantageously reduce the risk of user errors and therefore provide an easy and reliable way for exchanging microfluidic chips in the chip holder.

The chip holder may comprise at least one alignment aid, configured to aid with the correct alignment of the microfluidic chip within the chip holder. An alignment aid may generally be any structure suited to provide a reference point for positioning and/or obstruct movement of the microfluidic chip. Examples for alignment aids may be a pin, a recess, a notch a shoulder or any other suitable structure.

In some embodiments, the chip receiving section may comprise at least one of the at least one alignment aid. For example, the chip receiving section may comprise a recess configured to receive the microfluidic chip, wherein the recess may constitute one of the at least one alignment aids. That is, the recess may be configured to hold the chip in a designated position. At least one of the at least one alignment aid may further be configured to aid with the correct alignment of the chip cover with respect to the microfluidic chip.

In some embodiments, the microfluidic chip may comprise at least one alignment orifice configured for receiving an alignment aid. That is, the microfluidic chip may comprise an orifice into or through which a respective alignment aid may be guided. For example, the chip receiving surface may comprise an alignment pin configured to be guided through a respective alignment orifice in the microfluidic chip to therefore ensure correct positioning of the chip with respect to the chip holder.

The chip receiving section may comprise at least one shoulder, configured to restrain movement of the microfluidic chip in a direction orthogonal to a plane defined by the chip receiving section and/or aid with the insertion of the microfluidic chip into the chip receiving section. Thus, the at least one shoulder may also serve as an alignment aid and/or help to restrain the chip within the chip receiving section.

The chip holder may further comprise a sealing element configured to enable a leak-tight connection between the microfluidic chip and the chip cover. That is, the sealing element may be configured to be placed between the microfluidic chip and the chip cover in order to establish a fluid-tight connection between said components. In some embodiments, the sealing element may be fixedly mounted to the cover plate. In other words, the sealing element may be attached to the cover plate, e.g. it may be glued to the cover plate. Therefore, the sealing element may advantageously not require individual placement with respect to the microfluidic chip and the chip cover. That is, the number of components/elements that require careful positioning by the user may be advantageously reduced. The sealing element may comprise an elastomer, i.e. a polymer comprising elastic properties such as for example silicone or ethylene propylene diene (EPDM).

In some embodiments, the chip cover may be attached to the cover plate. This may advantageously reduce the number of elements/components that require correct placement through the user. In other words, the chip cover may be aligned with respect to the chip holder, the chip receiving surface and/or the respective alignment aids, such that it may be correctly aligned with the microfluidic chip once placed in the chip receiving surface. Thus, the placement and/or relative alignment of chip cover, microfluidic chip and/or sealing element may advantageously be more reliable and less complicated.

The chip holder may further comprise a cover mount configured to receive the chip cover and aid with alignment and/or fixation of the chip cover within the chip holder. That is, the chip cover may be held by a cover mount, which may aid with placement and/or alignment of the cover plate with respect to the chip holder and the microfluidic chip. The cover mount may be configured to be attached to the cover plate. That is, the cover mount may further be mounted/attached to the cover plate and thus advantageously ensure correct relative alignment of the chip cover with the cover plate and thus the chip holder, and particularly the chip receiving recess. The cover mount may comprise an elastomer. For example, the cover mount may be formed of an elastomer such as silicone or EPDM.

Additionally or alternatively, the cover mount may comprise a rigid material. For example, the cover mount may be formed of a rigid polymer, such as a polyamide (PA), acrylonitrile butadiene styrene (ABS) or polyether ether ketone (PEEK). Furthermore, the cover mount may comprise at least one structurally elastic portion. That is, the cover mount may for example comprise at least one extendable and/or compressible portion, such as a spring, which may provide elasticity to the cover mount. This may be particularly advantageous if the cover mount is formed of a rigid material and aid with securing the chip cover in the cover mount and/or enable small movements of the chip cover with respect to the cover plate if the cover mount is attached to the cover plate. The small movements may advantageously aid with correct alignment of the cover plate relative to the microfluidic chip and/or the chip receiving surface.

The chip holder may be configured to assume a configuration wherein at least a portion of the cover plate is located above a portion of the chip receiving section. Further, the chip holder may be configured to assume a configuration wherein the microfluidic chip, the chip cover, the sealing element and the cover plate are aligned with respect to each other, such that by applying a force to the cover plate, that is directed towards the chip receiving section, the chip holder may be brought into a sealing position wherein a leak-tight connection is established between the chip cover and the microfluidic chip.

The sealing mechanism may be configured to provide a sealing force to the cover plate in the sealing position. That is, the sealing mechanism may provide a sealing force to the cover plate, which may for example press the cover pate, cover mount, chip cover, sealing element in the direction of the chip receiving surface and thus onto the microfluidic chip. Thus, it may establish and/or maintain a fluid-tight connection between the elements.

The sealing mechanism may comprise at least one magnet configured to provide the sealing force. It will be understood that the force of the magnet may be overcome such that the cover plate may be brought out of the sealing position. That is, the magnet may be configured to hold the cover plate in the sealing position provided no force exceeding the magnetic force is applied in order to bring the cover plate out of the sealing position.

The sealing mechanism may comprise at least one biasing element configured to provide the sealing force to hold the cover plate in the sealing position Again, it will be understood that the sealing mechanism, in this case the at least one biasing element, may keep/hold the cover plate in the sealing position provided no force is applied to overcome the sealing force exerted by the sealing mechanism, e g no force is applied that may overcome the force provided by the basing element. Further, the sealing force provided by the biasing element may be configured to further bring the cover plate into the sealing position. The at least one biasing element may be a spring.

The sealing force may be in the range of about 20 N to about 300 N, preferably in the range of about 60 N to about 150 N. Additionally or alternatively, the leak-tight connection established between the chip cover and the microfluidic chip in the sealing position may be pressure resistant up to at least 0.3 bar, preferably at least 0.8 bar.

The chip holder may further comprise a locking mechanism comprising at least one locking device configured to lock the cover plate in an elevated position, wherein in the elevated position no leak-tight connection between the chip cover and the microfluidic chip is provided. In the elevated position, the cover plate and any components attached thereto may not interfere with any portion of the drawer or the microfluidic chip when the drawer is moved in and out of the body.

The locking device may be configured to transmit a force to the cover plate such that the force acts to push the cover plate away from the chip receiving surface. That is, the force transmitted by the locking device may generally act against the sealing force, e.g. in the opposite direction.

The at least one locking device may comprise a biasing element. The biasing element may be configured to exert a force onto the cover plate that is configured to push the cover plate into the elevated position and further to lock the cover plate in the elevated position Again, the force exerted onto the cover plate by the biasing element of the at least one locking device may act against the sealing force, that is generally in a direction away from the chip receiving surface.

The chip holder may further be configured to provide a fluid connection to the volume between the chip surface and the chip cover when the cover plate is in the sealing position. That is, generally, it may be preferable that at least a portion of the microfluidic chip, e.g. an active surface of the chip, may be sealingly covered (i.e. connected in a leak-tight manner) to the cover plate, such that a volume may form between the cover plate and the microfluidic chip, e.g. with the aid of a sealing element. Said volume may be provided with a fluid for example to synthesise nucleic acids or peptides.

The chip cover may comprise a plurality of fluid ports and the cover plate may comprise a plurality of fluid connectors. Further, in the sealing position, the fluid connectors may establish a fluid connection between orifices in the chip cover and external fluid conduits. That is, a fluidic connection may be established between external fluid conduits and the volume between the chip surface and the chip cover. In other words, the volume between the chip surface and the chip cover may be fluidly accessible through the fluid connectors comprised by the cover plate.

Alternatively, the chip cover may comprise a plurality of fluid connectors, configured to provide the fluid connection to the volume between the chip surface and the chip cover. That is, the fluid connectors may for example be permanently mounted to the chip cover or integrally formed with the chip cover. The chip cover may further be attached to the cover plate by means of the fluid connectors.

The fluid connection may be configured for a flow rate in the range of 0.1 ml/min to 10 ml/min, preferably preferably 0.8 ml/min to 5 ml/min.

The connecting mechanism may be independent of the sealing mechanism. That is, the fluid connection and the electrical connection may be established independently of each other. In particular, the electrical connection may be established by the connecting mechanism prior to establishing a fluid connection by means of the sealing mechanism.

The electrical contacts comprised by the chip holder may be spring-loaded electrical contacts, such as spring-loaded electrical pins. Additionally or alternatively, the electrical contacts comprised by the chip holder may be located within the chip receiving section.

The connecting mechanism may be configured to provide a connection force to establish the electrical connection. In some embodiments, the connecting mechanism may comprise at least one tappet comprised by the drawer and an eccentric element mounted to the body, wherein the tappet is configured to interact with the eccentric element when the drawer is moved between the open and closed configuration and wherein the eccentric element is configured to exert the connection force when the drawer is in the closed configuration.

The connecting mechanism may comprise an oblique area configured to reduce the free space above the chip receiving section when the drawer is moved from an open to a closed configuration. That is, by reducing the free space above the chip receiving section, e.g. the distance between the chip receiving section and the oblique area, the microfluidic chip may be pressed into the chip receiving section, for example when the drawer is moved into the body of the chip holder.

Generally, the connection force is in the range between 1 N and 100 N, preferably between 2 N and 60 N, such as between 3 N and 50 N.

The electrical connection established by the connecting mechanism may be configured for voltages in the range of about 3 V to about 20 V, preferably about 5 V to about 10 V. Additionally or alternatively, the electrical connection established by the connecting mechanism may be configured for currents in the range of about 2 mA to about 500 mA, preferably from about 3 mA to about 300 mA.

The electrical contacts comprised by the microfluidic chip may be located at an underside of the chip. That is, the side opposite to the active chip area or in other words, the side of the chip that may typically be in contact with the chip receiving section.

The chip cover may comprise at least one cover electrode. That is, the cover may comprise an electrode which may for example serve as a counter electrode to electrodes comprised by the microfluidic chip. Further, the chip receiving section may comprise at least one contact pin, wherein the contact pin may be configured to establish an electrical connection to the at least one cover electrode. The at least one contact pin may be a spring-loaded electrical contact pin. In some embodiments, the contact pin may further serve as alignment aid.

The microfluidic chip may comprise a pin orifice, configured for guiding the at least one contact pin through the respective pin orifice when placing the microfluidic chip in the chip receiving section. In some embodiments, the pin orifice may further serve as alignment orifice.

In a further embodiment, the present invention may relate to a rotary valve comprising a stator comprising a plurality of channels, a rotor comprising at least one groove and a plurality of tubes, wherein each tube extends into a channel, respectively. Such a rotary valve may constitute a multiport valve comprising a plurality of valve connections through the tubes/channels. Furthermore, it may not require specific connectors such as plugs and sockets for connecting the tubes to the channels as the tubes may extend into the channel and form a leak-tight interface between the tube and the channel. Thus, such a valve may advantageously be less complex and/or space demanding than standard rotary valves known in the art.

The rotary valve may be configured such that the at least one groove can fluidly connect the channels. In other words, the valve may generally be configured to fluidly connect the channels to each other, i.e., for each channel, the valve may be configured to assume a respective configuration, wherein said channel is directly fluidly connected to another channel of the valve by means of the groove. It will be understood that the at least one groove may only be configured to fluidly connect a limited number of channels at the same time, e.g. 2 channels, and that it may not allow to connect each channel to any other channel. That is, the number of possible connections for each channel may be limited, e.g. to 1, however, the valve may be configured to fluidly connect each channel to at least on other channel.

Each of the channels may comprise a portion having a first inner channel diameter. Similarly, the tubes may have an uncompressed outer tube diameter in an uncompressed state. Further, first inner channel diameter may be smaller than the uncompressed outer tube diameter.

The stator may be formed from a plastic material or stainless steel. Similarly, the rotor may be formed from a plastic material or stainless steel. Further, in some embodiments, at most one of the stator and the rotor may be formed of stainless steel.

An outer surface of the tubes and an inner surface of the respective channels may form a sealing interface, when in contact with each other. That is, if a tube is guided into the channel, either the tube or the material surrounding the channel, e.g. a portion of the stator comprising the channel, may be compressed. Therefore, an outer surface of the tube and an inner surface of the channel may be pressed against each other and form a sealing interface, which may be a substantially leak-tight interface. In other words, the outer surface of the tube and the inner surface of the channel may provide sealing surfaces, which are pressed against each other by a sealing force provided due to the compression of the tube and/or the stator. Further, the sealing interface may be substantially leak tight for pressures of at least 0.3 bar, preferably at least 0.6 bar, more preferably at least 1 bar. Thus, at least below an above defined pressure threshold, only negligible amounts of fluid may leak through the sealing interface.

The channels may define a first direction of the stator and the channels may have a channel length along the first direction. In some embodiments, the tubes may extend for at least 1.5 mm, preferably at least 2 mm into the respective channels.

Generally, the stator may comprise a connection face and a gliding face, wherein at least a portion of the gliding face is configured to contact the rotor in use. In some embodiments, the stator may comprise a single block between the connection face and the gliding face. The block(s) may also be referred to as material section(s). That is, the stator may be formed of a single block of material, e.g. it may be integrally formed. The tubes may extend for at least 80%, preferably at least 90% of the channel length into the channels. In some embodiments, the tubes may extend from the connection face to the gliding face. In other words, they may extend over the complete channel length. i.e. 100% of the channel length. For example, the tubes may be guided through the stator from the connection face to the gliding face, such that they extend out of the gliding face. Subsequently the tubes may be cut flush with the gliding face. Tubes, they extend through 100% of the channel length, which may advantageously maximise the sealing surface between the tube and the channel and/or minimize (e.g. prevent) dead volume within the channel.

Alternatively, the stator may comprise a first block and a second block between the connection face and the gliding face. In other words, the stator may be formed of two parts, which may for example be individually formed. In such an embodiment, each of the channels may extend through both blocks, and wherein each channel has a first channel portion extending through the first block and a second channel portion extending through the second block.

The first channel portion may comprise the first inner channel diameter. Further, the second channel portion may comprise a first channel section with a first section channel diameter and a second channel section with a second section channel diameter. The first section channel diameter may be greater than the second section channel diameter. Furthermore, the first section channel diameter may be greater than or equal to the uncompressed outer tube diameter and/or the second section channel diameter may be smaller than the uncompressed outer tube diameter.

The respective tube may extend over the entire first channel section along the first direction. That is, for a channel in the stator, the respective tube may extend through the first channel portion comprised by the first block, i.e. over the entire length of the first channel portion in the first direction and further, the tube may extend over the entire first channel section comprised by the second block.

The plurality of tubes may comprise at least 5 tubes, preferably at least 10 tubes, further preferably at least 25 tubes. Additionally or alternatively, each of the tubes in the channels has a central axis, and wherein the central axes of two tubes are distanced by not more than 8 mm, preferable not more than 5, more preferable not more than 3.5 mm. That is, the tubes may allow for a close spacing thereof as no further components, such as fluid connectors, may be required to connect the tubes to the stator. In other words, the connection of the tubes to the stator may advantageously be less complex and more space-efficient compared to utilizing fluid connectors as commonly used in the state of the art.

The rotor may comprise a rotor gliding face and a back face, wherein the rotor gliding face is configured to contact the stator in use. Further, the gliding face may comprise the at least one groove. That is, the gliding face of the rotor may typically comprise the at least one groove and be configured to be in contact with at least a portion of the gliding face of the stator.

In some embodiments, the rotary valve may further comprise a biasing element connected to the back face of the rotor and configured to bias the rotor gliding face against the stator. Thus, the biasing element may exert a force configured to press/bias the rotor against the stator, and in particular the gliding face of the rotor against the gliding face of the stator. Furthermore, the rotary valve may comprise a ball bearing, and the biasing element may be connected to the back face via the ball bearing. That is, the ball bearing may be located between the biasing element and the rotor and it may be configured to transmit the force of the biasing element to the rotor, while advantageously reducing the friction between the rotor and the biasing element when the rotor is turning.

In some embodiments, the rotor may further comprise a sealing lip, wherein the sealing lip is located to the rotor gliding face and surrounds the at least one groove, and wherein the sealing lip is configured to seal the channels of the stator that are not fluidly connected to the groove of the rotor. The sealing lip may advantageously reduce the required force pressing the rotor and stator together, e.g. it may allow for a smaller and/or weaker biasing element. In some embodiments, the sealing lip may be formed integrally with the rotor. That is, the rotor and the sealing lip may be made of a single block of material, for example by milling. Alternatively, the sealing lip may be formed of an elastomer, e.g. silicone or ethylene propylene diene (EPDM) or perfluoroelastomeric (FFKM). Such an elastic sealing lip may be placed on and/or attached to the rotor such that it surrounds the at least one groove, while being configured to seal the channels of the stator that are not fluidly connected to the groove of the rotor.

In another embodiment, the present invention relates to a collection unit configured to collect nucleic acids comprising an adapter plate, configured to be connected with a plurality of fluid tubes and a well plate, comprising a plurality of wells, wherein the collection unit is configured to maintain a connection between the adapter plate and the well plate. In some embodiments, the nucleic acids the collection unit is configured to collect may be oligonucleotides. Additionally or alternatively, the nucleic acids the collection unit is configured to collect may be attached to a support. That is, the collection unit may be configured to collect supports, e.g. beads, carrying nucleic acids, such as oligonucleotides, which may subsequently be further processed. For example, they may be washed, dried, connections between nucleic acids and supports (e.g. beads) may be destroyed, and/or protection groups attached to the nucleic acids may be removed.

The connection between the adapter plate and the well plate may be leak tight. That is, the connection may substantially be tight as regards liquids and/or gases. This may advantageously allow to pressurize a volume comprised by a well of the well plate.

Further, the collection unit may comprise a connection mechanism, wherein the connection mechanism is configured to connect the adapter plate and the well plate such that the connection therebetween is maintained. For example, the connection mechanism may be configured to restrain the parts of the collection unit in a position, wherein the leak-tight interface between the adapter plate and the well plate may be maintained.

Each well of the well plate may comprise a filter material. The filter material may for example be configured to be permeable to fluids. Thus, when a fluid comprising for example beads is introduced in a well, the fluid may drain out of the permeable filter material, while the beads (and potentially attached nucleic acids, e.g. oligonucleotides) may be retained in the well.

In some embodiments, each well may comprise an individual portion of the filter material. That is, each well may comprise filter material for example at the bottom or in the mid or lower portion of the well. Alternatively, a mat of filter material may be attached to the bottom of the wells, wherein the mat of filter material may be attached such that each well is fluidly separated from the other wells. That is, a mat of filter material may simultaneously be attached to a plurality of wells, in particular to the bottoms thereof, such that each well comprises a portion of filter material at its bottom. In particular, the filter material mat may be attached such that each well remains fluidly separated from the other wells, i.e. such that there is substantially no cross contamination via the mat of filter material. The mat of filter material may be glued to the bottom of the wells or fused to the bottom of the wells utilizing heat.

Generally, the filter material may be formed of polyether ether ketone (PEEK), polytetrafluorethylene (PTFE), ethylene tetrafluoroethylene (ETFE), polypropylene (PP), polyethylene (PE) or glass fibre. In other words, it may preferably be formed of an inert material, which may advantageously limit (e.g. suppress) any interaction of chemicals with the filter material when brought into contact. The filter material may comprise a pore size and wherein the pore size is in the range of 0.05 μm to 200 μm, preferably in the range of 0.1 μm to 20 μm. The pore size of the filter material may advantageously be chosen such that the supports (e.g. beads) utilized during the synthesis process cannot pass the filter material, while fluids and nucleic acids which are not attached to a support may pass through the pores of the filter material.

The well plate may be formed of a polymer, preferably a thermoplastic. In particular, the well plate may be formed of polyether ether ketone (PEEK), polypropylene (PP), polyethylene (PE) or polyphenylene sulphide (PPS). Thus, the well plate may advantageously be formed of a chemically inert material and, in some embodiments, the well plate and the filter material may be formed of the same material. In such embodiments, the filter material and the well plate may be integrally formed in one process.

The collection unit may further comprise at least one sealing member. The sealing member may generally be located between the adapter plate and the well plate and may for example allow for a fluid-tight connection between the adapter plate and the well plate.

The adapter plate may comprise a plurality of channels for guiding a fluid through the adapter plate, wherein the fluid is guided in the direction of the well plate. That is, the adapter plate may comprise a plurality of channels running through the adapter plate from an upstream side of the adapter plate to a downstream side of the adapter plate, wherein the downstream side is typically directed towards the well plate. It will be understood that guiding a fluid through the adapter plate also comprises guiding a fluid tube through the adapter plate, wherein the fluid may then be flowing through the fluid tube. Further, the adapter plate may comprise a fluid connector for each channel, wherein the fluid connector is fluidly connected to an upstream end of the channel. Additionally, each channel may be configured to guide a fluid introduced at a fluid connector through the respective channel and into a respective well.

The adapter plate may comprise at least one extension, wherein each of the at least one extension extends into a respective well. In other words, the adapter plate may comprise one or more extensions, wherein each extension extends from the adapter plate into a respective well, i.e. in the downstream direction. Further, the adapter plate may comprise an extension for each of the plurality of channels, wherein each channel runs through a respective extension into the respective well.

The at least one sealing member may comprise a sealing mat contacting the adapter plate and the well plate. The sealing mat may comprise an orifice for each channel for guiding a fluid or tube through the adapter plate. That is, the sealing mat may generally comprise an orifice for each channel in the adapter plate, such that for example any fluid guided through the channel may also be guided through the sealing mat and into the respective well. Additionally or alternatively, each of the at least one extension of the adapter plate may extend through a respective orifice in the sealing mat. For example, the sealing mat may be in contact with the downstream side of the adapter plate, while all of the at least one extension of the adapter plate may be guided through a respective orifice of the sealing mat. Further, the sealing mat may be configured to seal the adapter plate against the well plate, wherein each well in contact with the sealing mat is fluidly separated from the other wells of the well plate. In other words, the sealing mat may provide a sealed connection between the adapter plate and the well plate, which may fluidly separate the wells covered by the sealing mat and/or adapter plate, from the other wells so as to prevent any cross contamination between the wells.

Generally, the sealing member may be formed of an elastic material. Elastic properties may advantageously aid with a connection between the adapter plate and the well plate and in particular allow for evening out any unevenness, e.g. of the well plate, due to production limitations. In particular, the sealing member may be formed of silicone, preferably foamed silicone, or a plastic material, such as an elastomer, and preferably a perfluoroelastomer.

The connection mechanism may further be configured for providing a plate sealing force that establishes the connection between the adapter plate and the well plate. That is, the connection mechanism may not only be configured to connect the adapter plate and the well plate such that the connection therebetween is maintained, but may further also be configured to establish the connection between the adapter plate and the well plate. For example, the connection mechanism may allow for manual and/or electric or pneumatic application of a plate sealing force, that establishes a connection between the adapter plate and the well plate. As already mentioned, the connection may be sealed and/or leak tight, particularly by means of at least one sealing member which may be part of the connection.

The connection mechanism may comprise at least one lever arm configured for applying the plate sealing force to establish the connection between the adapter plate and the well plate Again, the plate sealing force may be applied via the lever arm manually, electrically and/or pneumatically. At least one of the at least one lever arm may be connected to the adapter plate. Thus, the adapter plate may be moved and/or the plate sealing force may be applied to the adapter plate through the at least one leaver arm.

In some embodiments, the at least one lever arm may be configured to transform a rotational movement into a substantially linear movement when establishing the connection between the adapter plate and the well plate. In other words, the at least one lever arm may be configured to provide a substantially linear movement of the adapter plate relative to the well plate when establishing the connection, i.e. when they are close together and/or touching each other. Here the term “substantially” serves to allow for residual movement other than strictly linear, which may be compensated for by additional space provided between the nozzles and the wall of the well of the plate, the elastic behavior of the sealing and/or some margin for establishing the connection. A radius of the lever arm may be so large that the movement of the lever arm in the section when the nozzles connect to the filter plate is almost linear, such that the nozzles do not come into contact with the edge of the wells of the filter plate.

In some embodiments, the connection mechanism may comprise a freewheel bearing connecting two lever arms, wherein said connected lever arms may be configured to assume at least two different configurations corresponding to two different relative positions of the adapter plate and the well plate. A freewheel bearing may for example be a ball bearing. Further, a first position of the at least two different relative positions may correspond to a position wherein the connection between the adapter plate and the well plate is established, and a second position of the at least two different relative positions may correspond to a position wherein the connection between the adapter plate and the well plate is not established. Thus, the two lever arms connected by a freewheel bearing may allow to alter the relative position between the adapter plate and the well plate and thus allow to establish a connected state and an unconnected state therebetween.

The connection mechanism may comprise an electric or pneumatic actor, such as a motor, a linear actuator or a pneumatic cylinder, configured to apply the plate sealing force configured to establish the connection between the adapter plate and the well plate. That is, the connection mechanism may for example comprise an electric motor or linear actuator or a pneumatic cylinder for providing the plate sealing force and establishing the connection between the adapter plate and the well plate. Further, the electric or pneumatic actor may be configured to change the configuration assumed by the connected lever arms. For example, the electric or pneumatic actor may drive the at least one lever arm to alter the relative position of the adapter plate and the well plate and/or to apply the plate sealing force. In particular, the electric or pneumatic actor may be configured to change the configuration assumed by the connected lever arms by changing direction of the force provided by the electric or pneumatic actor. In other words, the direction of movement of the electric or pneumatic actor may be changed.

Generally, at least one of the at least one sealing member may be part of the connection between the adapter plate and the well plate. For example, a sealing mat may be placed between the adapter plate and the well plate.

Put differently, a plate sealing force may be applied to the adapter plate manually or with an electric or pneumatic actor like a motor, a linear actuator or a pneumatic cylinder. There may be a lever arm to transform the rotation movement into an almost linear movement close to the well plate, for example if the plate sealing force is applied with an electric motor. Furthermore, there may be a freewheel bearing which connects two lever arms to move the adapter plate in two different positions, e.g. if a motor is used. These positions can be addressed by changing the movement direction of the motor and/or the leaver arm.

The connection mechanism may comprise at least one fastening member connected to the adapter plate and at least one locking member to lock a location of the at least one fastening member and thus the adapter plate with respect to the well plate.

The at least one fastening member may be formed integrally with the adapter plate. For example, the adapter plate and the at least one fastening member may be formed of a single block of material. The at least one fastening member comprises a plurality of fastening members, and wherein the adapter plate is located between the fastening members. In other words, the fastening members may be located at opposing sides of the adapter plate.

In some embodiments, the collection unit may further be configured to heat fluid contained in the wells. This may advantageously enable and/or speed up desired chemical processes within the well, e.g. the cleavage and deprotection of nucleic acids such as oligonucleotides. Further, collection unit may comprise at least one heating element configured to heat at least a portion of the collection unit. The heating element may be an electrical heating element. For example, the heating element may be an electrical resistance wire, which heats up depending on a current passed through the wire.

In some embodiments, the adapter plate may comprise at least one of the at least one heating element. In other words, the adapter plate may comprise at least one heating element configured to heat the adapter plate. This may for example be advantageous for heating a fluid in a well since the adapter plate may be directly (or via the at least one sealing member) in contact with the well plate. Further, in some embodiments, extensions of the adapter plate may reach into the wells of the well plate and thus provide an efficient and controllable way of heating fluids in the wells. The adapter plate may be formed of a material with a thermal conductivity greater than 10 W/(m×K), preferably greater than 100 W/(m×K), further preferably greater than 200 W (m×K). That is, the adapter plate may advantageously be made of a material with high thermal conductivity in order to facilitate an efficient heat transfer to the well plate and/or fluids in the wells. For example, the adapter plate may be formed of a metal.

The collection unit may further comprise a support element configured to support the well plate. For example, the well plate may typically be placed on top of the support structure. The support element may comprise a plurality of recesses, wherein each recess receives a section of a well, respectively. This may advantageously aid with correct positioning of the well plate with respect to the support structure and/or prevent any uncontrolled shift thereof. Further, the support element may comprise a channel for each well. Thus, any fluid draining through the filter material and out of the well may be guided into a respective channel of the support structure, which may for example be fluidly connected to waste, e.g. configured to collect undesired fluids in a waste container. In some embodiments, the support element may comprise at least one of the at least one heating element. In other words, the support element may be configured to be heated and to thus heat fluid contained in the wells. The support element may be formed of a material with a thermal conductivity greater than 10 W/(m×K), preferably greater than 100 W/(m×K), further preferably greater than 200 W (m×K). Thus the support element may advantageously be made of a material with high thermal conductivity in order to facilitate an efficient heat transfer to the well plate and/or fluids in the wells. The support element may be formed of metal.

The collection unit may further comprise at least one temperature sensor. The at least one temperature sensor may advantageously provide a temperature signal which may be utilized to control the temperature of any heated element, e.g. adapter plate, support element, well plate or fluid in the wells. For example, the temperature sensor may be utilized to ensure that a maximum temperature is not exceeded to prevent any damage to components of the collection unit, e.g. the well plate. Additionally or alternatively, the at least one temperature sensor and temperature signal may be utilized to control the temperature of fluid in wells to a desired temperature, e.g. processing temperature. For example, the at least one temperature sensor may comprise two temperature sensors, one of which may measure a temperature of a heated element, and the other may measure a processing temperature in a well.

In some embodiments, the adapter plate may comprise at least one temperature sensor. In particular, at least one of the at least one temperature sensor may be comprised by an extension of the adapter plate. That is, the at least one temperature sensor may be comprised by an extension of the adapter plate which may for example reach in a respective well. The temperature sensor may thus be configured to determine the temperature close to (or at) the downstream end of the extension. Consequently, the temperature sensor may provide a temperature signal which may allow to approximate (or determine) the temperature within the well, which may for example be relevant to chemical processes taking place within the wells.

Additionally or alternatively, the support element may comprise a temperature sensor.

In some embodiments, the at least one sealing member may be a plurality of sealing members, wherein each sealing member may comprise a sealing extension, wherein each sealing extension is configured to extend into a respective well and to seal against the respective well. Further, each sealing member comprises a biasing element biasing the respective sealing extension towards the respective well. The biasing elements may be springs. The biasing elements (e.g. springs) may advantageously enable each sealing extension to move independently of each other along the direction of flow. Thus, they may be configured to even out any unevenness of the well plate, e.g. due to limitations of the manufacture.

In some embodiments, each sealing extension may be located downstream of the respective channel. That is, each sealing extension may be associated to a respective channel, which may for example guide a fluid or tube into the sealing extension.

The sealing extensions may have a conical shape. Additionally or alternatively, the wells may have a conical shape. Thus, the sealing extensions and the respective wells may advantageously provide a sealed connection by means of a cone-cone sealing.

Each of the plurality of fluid tubes may be received in a respective channel of the adapter plate and/or in a respective channel of the sealing extension. Further, at least a portion of the respective channel of the adapter plate and/or the sealing extension may comprise an inner diameter that is smaller than an outer diameter of the respective uncompressed tube. Thus, a sealing interface between a portion of the outer surface of the tube and at least a portion of the inner surface of the channel may be formed, wherein the sealing force may be provided through the compressed tube and/or compressed material through which the channel runs (e.g. sealing extension or adapter plate). In other words, tubes may advantageously be fluidly connected to the collection unit and in particular to the adapter plate and/or sealing extensions without the need of specific fluid connectors, which may render the overall design of the collection unit less complex and more robust.

The sealing extensions may be formed of silicone, polytetrafluorethylene (PTFE), polyether ether ketone (PEEK), polyurethane (PUN) or perfluoroalkoxy alkanes (PFA).

The adapter plate may be configured to heat the fluid contained in the wells. Additionally or alternatively, the sealing member may be configured to heat the fluid contained in the wells.

The collection unit may be configured to maintain an elevated pressure in the wells.

In some embodiments, the support element may further comprise a well plate sealing element configured to provide a seal for a connection between the well plate and the support element. In other words, the well plate sealing element may be positioned between a main portion of the support element and the well plate in order to seal a connection or respectively an interface therebetween when the collection unit is in an assembled state.

The well plate sealing element may be configured to seal against nozzles of the well plate. That is, the well plate may comprise nozzles ad its downstream side, e.g. a nozzle for each well, and the well plate sealing element may be configured to sealingly fit around a portion of these nozzles so as to provide a sealed connection or respectively a sealed interface between the support element and the well plate.

Additionally or alternatively, the well plate sealing element may be configured to seal flat against a downstream side of the well plate. For example, the well plate sealing element may seal flat against a downstream end of the nozzles and/or the filter plate.

The well plate sealing element may be located at an upstream side of the support element.

Overall, the well plate sealing element may thus advantageously allow to level out irregularities of the well plate, e.g. due to uncertainties in the manufacturing process, and/or prevent leakage or evaporation of vaporized chemicals through an interface between the support element and the well plate.

The well plate sealing element may be made of one of silicone, preferably foamed silicone, or a plastic material, such as an elastomer. In some embodiments, the well plate sealing element may be made of one of ethylene propylene diene (EPDM), polytetrafluorethylene (PTFE), perfluoroelastomer (FFKM), polyurethane (PUN) or perfluoroalkoxy alkanes (PFA)

The collection unit may further comprise a sheet, configured to hold the well plate sealing element in place. That is, the well plate sealing element may be located between a main portion of the support element and the sheet and therefore fixed by means of the sheet, which may be attached to the main portion of the support element by fastening means, e.g. screws. The sheet may be made of metal.

In some embodiments the collection unit may further comprise a waste bin. Very generally, the waste bin may be configured to collect fluids and guide them to waste. The waste bin may be located downstream of the support element. The waste bin may be configured to collect and dispose of any fluid passing through the well plate and/or the support element.

The waste bin may comprise at least one waste bin chamber configured to collect fluids passing though the well plate and/or the support element. Further, each of the at least one waste bin chamber may be fluidly connected to a waste bin outlet configured to guide fluids from the respective waste bin chamber to waste. That is, the waste bin may comprise at least one waste bin chamber in which fluids passing through the well plate and/or the support element may be collected and then guided to waste via a respective waste bin outlet, i.e. the fluids may be collected and disposed of.

The waste bin may be made of material that is resistant to the applied chemicals. This may advantageously prevent the waste bin from suffering any damage due to chemicals such as reagents used. Furthermore, the waste bin may be made of material that is configured to insulate against heat of the well plate and/or the support element. That is, the waste bin may be less heat conductive then the support element and/or the well plate, which may be heated through respective heating elements as described elsewhere herein. In some embodiments, the waste bin may be made of PEEK.

The waste bin may further comprise at least one flushing element configured for flushing the at least one waste bin chamber with a fluid. Flushing the waste bin and particularly the at least one waste bin chamber may advantageously prevent (or avoid) depositing or sedimentation of any reagents (e.g. salt) within the at least one waste bin chamber.

Further, the waste bin may comprise at least one flushing inlet configured to receive a fluid for flushing the at least one waste bin chamber and to guide the received fluid to at least one of the at least one flushing element.

The flushing element may be configured to guide the fluid to an inner surface of the circumferential wall of the at least one waste bin chamber. That is, the at least one waste bin chamber may be formed through circumferential walls and a bottom surface in the downstream direction wherein the top of the at least one waste bin chamber may be formed by the support element. Thus, the circumferential wall may substantially extend from the upstream side of the waste bin (e.g. from the support element when assembled to the bottom of the waste bin chamber, i.e. in the downstream direction of the waste bin.

The flushing element may be configured to equally distribute the fluid on the inner surface.

The flushing element may be a frame-like structure. Further, an outer circumference of the frame-like structure may match an inner circumference of the respective at least one waste bin chamber.

The flushing element may comprise channels for guiding the fluid within the flushing element and at least one flushing element outlet for releasing the fluid into the waste bin chamber. The at least one flushing element outlet of the flushing element may be located such that the fluid is released in the direction of the circumferential wall of the at least one waste bin chamber. The channels may be provided e.g. by drilling holes comprised by the flushing element.

The number of flushing elements comprised by the waste bin may match the number of waste bin chambers comprised by the waste bin.

The number of flushing inlets comprised by the waste bin may match the number of waste bin chambers comprised by the waste bin.

The number of flushing inlets comprised by the waste bin may match the number of flushing elements comprised by the waste bin.

The collection unit may further comprise a waste bin sealing element configured to seal a connection between the support element and the waste bin. The waste bin sealing element may advantageously restrict evaporation or leakage of chemicals through an interface between the support element and the waste bin. The waste bin sealing element may be made of one of silicone, preferably foamed silicone, or a plastic material, such as an elastomer. The waste bin sealing element may be made of one of ethylene propylene diene (EPDM), polytetrafluorethylene (PTFE), perfluoroelastomer (FFKM), polyurethane (PUN) or perfluoroalkoxy alkanes (PFA).

The collection unit may further comprise a positioning element configured to aid with the positioning of the waste bin sealing element relative to the waste bin and/or the support element. Further, the positioning element may be configured to predetermine a compression of the waste bin sealing element when the collection unit is in an assembled state. Additionally or alternatively, the positioning element may further be configured for insulating the waste bin from the support element. That is, the positioning element may provide heat insulation between the support element and waste bin. The positioning element may be made of a polyamide material.

In some embodiments, the collection unit may further comprise a support element sealing component configured to provide a seal for leakage from the well plate sealing element. In other words, the support element sealing component may advantageously provide an additional sealing layer for the unlikely event, that any leakage may occur at the well plate sealing element. The support element sealing component may comprise an aperture at least the size of the well plate sealing element and/or the sheet. The support element sealing component may be configured to provide a seal for an interface between the support element and the well plate, preferably an outer rim of the well plate.

The collection unit may comprise at least one pressure sensor configured to determine a pressure within the collection unit. The pressure sensor may advantageously allow to determine the tightness of the collection unit, e.g. by pressurizing the collection unit and measuring how well the pressure is maintained. In some embodiments tightness of the collection unit may be checked prior to each synthesis run. This may advantageously reduce the risk of evaporation and/or leakage of fluids out of the collection unit, which may otherwise for example cause a risk for the environment and/or safety of a user of the collection unit.

In a further embodiment, the present invention relates to a system comprising a fluid supply unit, a synthesis unit comprising a microfluidic chip, configured for the synthesis of nucleic acids, a valve assembly, comprising at least one multiport valve, and a collection unit configured to collect nucleic acids. It should be understood that a collection unit that is configured to collect nucleic acids should also encompass collection units that are configured to collect such nucleic acids when they are connected to beads. In some embodiments, the nucleic acids the microfluidic chip is configured to synthesize and/or the nucleic acids the collection unit is configured to collect are oligonucleotides.

Notably, the system as discussed herein may be an integrated system. That is, the system may be configured to assume a configuration to fluidly connect the different components (e.g., the fluid supply unit, the synthesis unit, the valve assembly, and the collection unit) to one another. Thus, e.g., steps like nucleic acid synthesis, fluid management, collection of nucleic acids, and processing of collected nucleic acids may be performed by the system in an automated manner, without the need of a user taking manual steps (e.g., a user manually transferring liquids from one component to another). This may be advantageous, as it may lead to improved efficiency and fail safety.

The valve assembly may be configured to direct fluid between the synthesis unit and the collection unit, the fluid supply unit and the synthesis unit, and the fluid supply unit and the collection unit.

The valve assembly may be configured to establish two fluid streams between fluid connections of the valve assembly without the two fluid streams coming into contact. In other words, the valve assembly may be configured such that two separate fluid streams may flow through the valve assembly without interfering with each other, i.e. without getting into contact to each other.

The valve assembly may be configured to guide fluid to a waste. The waste may for example be common to the whole system and collect fluids, that may have no further use, e.g. fluids from purging the system or undesired products of chemical processes.

The valve assembly may comprise at least one distribution valve comprising a plurality of valve connections, wherein the distribution valve is configured to establish a maximum of one direct fluidic connection between two valve connections. Further, the distribution valve may comprise at least 10 or at least 15 valve connections, preferably at least 20 valve connections, more preferably at least 24 valve connections. In some instances at least 28 or at least 30 valve connections may be used. In some embodiments, at least one of the valve connections of at least one of the at least one distribution valve may be fluidly connected to the fluid supply unit, without the synthesis unit being part of said fluid connection. For example, a fluid connection of the distribution valve may be fluidly connected to a fluid container, a valve manifold or the gas supply of the fluid supply unit without the synthesis unit being part of said fluid connection.

At least one of the valve connections of at least one of the at least one distribution valve may be fluidly connected to the waste.

Additionally or alternatively, one of the plurality of valve connections of each of the at least one distribution valve may be a distribution valve connection, wherein each distribution valve may be configured to establish a direct fluidic connection between the distribution valve connection and any other valve connection of the distribution valve. In other words, the distribution valve may distribute a fluid supplied at the distribution valve connection to any of the other valve connections or vice versa. That is, a fluid may generally flow through the distribution valve in both directions.

The valve assembly may further comprise a selection valve, and wherein the selection valve may be fluidly connected to the distribution valve connection of each of the at least one distribution valve. In other words, the selection valve may for example select which fluid source and/or system component is fluidly connected to the distribution valve.

The selection valve may be fluidly connected to the synthesis unit. Additionally or alternatively, the selection valve may be fluidly connected to a valve manifold comprised by the fluid supply unit, without the synthesis unit being part of the fluid connection.

In some embodiments the valve assembly may comprise two distribution valves and one selection valve. Thus, the selection valve may for example fluidly connect the distribution valve to the synthesis unit and at the same time fluidly connect the other distribution valve to a valve manifold comprised by the fluid supply unit. Therefore, the valve assembly may establish two independent fluid streams through the valve assembly that do not get into contact with each other.

The system may comprise a gas distribution unit as described above. For example, the gas distribution unit may be comprised by the fluid supply unit of the system.

The fluid supply unit may be the fluid supply unit as described above.

The system may further comprise the chip holder as described above. For example, the synthesis unit of the system may comprise the chip holder.

The at least one multiport valve may comprise a rotary valve as described above.

The collection unit may be a collection unit as described above.

The synthesis unit may be fluidly connected to the fluid supply unit without the valve assembly being part of the fluid connection. Further, the system may comprise a purge valve, wherein the purge valve is a multiport valve located in the fluid connection between the fluid supply unit and the synthesis unit. In other words, a fluid supplied by the fluid supply unit may be guided to the synthesis unit by means of the purge valve, i.e. it may flow through the purge valve. The purge valve may be configured to assume a first configuration, wherein the fluid supply unit is fluidly connected to the synthesis unit, and a second configuration, wherein the fluid supply unit and/or the synthesis unit are fluidly connected to a waste. Thus, the purge valve may either fluidly connect the fluid supply unit to the synthesis unit or fluidly connect the synthesis unit and/or the fluid supply unit to waste, depending on the assumed configuration. Thus, the synthesis unit may be purged, e.g. with a fluid supplied by the valve assembly, and the fluid may be guided from the synthesis unit to the purge valve and to waste. This may advantageously enable efficient purging of specific system components. The purge valve may be a rotary valve according to any of the preceding rotary valve embodiments.

In some embodiments, the system may comprise a single waste. In other words, the system may comprise a single waste configured to collect fluids, which are no longer required, in a waste, e.g. a waste system. Additionally or alternatively, the waste may comprise a bellows container. That is, the waste may for example comprise a waste container comprising an interior volume that may extend to equalize the pressure within the waste to the surrounding pressure. In other words, a fluid entering the waste container may inflate said waste container.

The system may comprise a controller configured to control and/or operate the system. The controller may be operatively connected to the fluid supply unit, the synthesis unit and the valve assembly. Additionally or alternatively, the controller may be operatively connected to the collection unit. The controller may be operatively connected to the purge valve.

The controller may comprise a data processing unit and/or a central processing unit. The controller may comprise a microprocessor. The controller may comprise a memory. The memory may for example be configured to store data and/or instructions for carrying out method steps and/or operating the system.

The controller may be a programmable logic controller.

The system may further comprise a chip power supply configured to supply the synthesis unit and particularly the comprised microfluidic chip with a voltage, electric current and/or charge.

The system may further comprise at least one pressure sensor, located at an internal flow path of the system. Such a pressure sensor may advantageously allow to determine the pressure within a flow path and thus potentially allow to check if the flow path is leaking and potentially even estimate the leak rate.

The system further may comprise at least one flow sensor, located at an internal flow path of the system.

The system may comprise at least one temperature sensor, configured to measure an ambient temperature of the system.

The system may comprise a barcode scanner, configured to scan a barcode and/or a QR code.

The waste may comprise a pressure sensor. Additionally or alternatively, the waste may comprise a level sensor configured to measure a filling level of the waste.

The system may comprise a user interface. For example, the system may comprise a display for displaying information to a user and an input device, e.g. a keyboard and/or a mouse. In some embodiments, the display may be a touch screen configured to also receive user input.

In a further embodiment, the present invention relates to a method for synthesising nucleic acids utilizing a synthesis system as described above. That is, very generally the method relates to utilizing a system comprising a fluid supply unit, a synthesis unit comprising a microfluidic chip, a valve assembly and a collection unit for synthesising nucleic acids. In some embodiments, nucleic acids synthesised may be oligonucleotides. That is, the nucleic acids synthesised by the method may be oligonucleotides or, in other words, the method may be a method for synthesising oligonucleotides.

The method may comprise synthesising nucleic acids on the microfluidic chip, selectively releasing synthesised nucleic acids from the microfluidic chip, guiding released nucleic acids to the collection unit, and collecting released nucleic acids in a well plate comprised by the collection unit.

Further, the step of synthesising nucleic acids may comprise providing a fluid through the fluid supply unit to the synthesis unit. For example, the fluid supply unit may supply a solution comprising any of the nucleobases, nucleotides, e.g. phosphoramidities, and/or solvents to the microfluidic chip. Preferably, the fluid supply may provide the fluid to the synthesis unit without it passing through the valve assembly prior to entering the synthesis unit.

The step of synthesising nucleic acids may comprise synthesising nucleic acids on a synthesis support, wherein each support is located in a synthesis spot of the microfluidic chip. In other words, the microfluidic chip may comprise a plurality of synthesis spots, e.g. wells, and at least a fraction of these synthesis spots may comprise a synthesis support, configured to support synthesis of a nucleic acid.

Additionally or alternatively, the step of synthesising nucleic acids may comprise controlling the environment of each individual synthesis spot to determine to which synthesis support a nucleotide can be attached. That is, the environment may be controlled such that it favours a nucleotide attaching to the respective synthesis support, e.g. bead, or not. Thus, controlling the environment may advantageously allow to deterministically attach selected nucleotides only to selected synthesis supports and thus to deterministically synthesize different nucleotides within one synthesis run. In some embodiments, controlling the environment of each individual synthesis spot may comprise applying a voltage and/or current to a respective electrode of the synthesis spot to change the pH of a fluid within the synthesis spot. That is, the pH of a fluid in a synthesis spot, e.g. well, may be individually altered through an applied voltage and/or current to a designated electrode comprised by the microfluidic chip. Changing the pH may advantageously result in removal of the acid-labile protective group from the nucleic acid (also generally referred to as “deblocking” step) attached to the synthesis support comprised in the respective synthesis spot and thus allow to controllably couple further nucleotides and assemble different series of nucleotides on different synthesis support structures by repeatedly altering the pH of different synthesis spots depending on the fluid (and for example comprised nucleotide) supplied to the microfluidic chip. Phosphoramidite nucleic acid synthesis steps, conditions and reagents using electrochemically generated acid to affect deblocking can be found in, for example, Maurer et al., “Electrochemically Generated Acid and Its Containment to 100 Micron Reaction Areas for the Production of DNA Microarrays, PloS ONE 1(1): e34. Doi:10.1371/journal.pone.0000034 (2006) and Egeland and Southern, Electrochemically directed synthesis of oligonucleotides for DNA microarray fabrication, Nucleic Acids Research, 33(14):e125 (2005).

In some embodiments the synthesis support may be a bead, wherein the bead may comprise a diameter of 5 μm to 50 μm, 10 μm to 200 μm, preferably 20 μm to 100 μm, more preferably 30 μm to 80 μm.

The step of synthesising nucleic acids may comprise synthesising nucleic acids comprising 10 to 500 bases, preferably 20 to 250 bases, more preferably 30 to 100 bases. In other words, the method may comprise synthesising oligonucleotides. Once successfully synthesised, such nucleic acids may for example be further processed through enzymatic synthesis of nucleic acid molecules, e.g. enzymatic gene assembly.

The step of selectively releasing synthesised nucleic acids may comprise selectively releasing synthesis supports carrying nucleic acids from the microfluidic chip. That is, the synthesis supports, e.g. beads, may be selectively released by the microfluidic chip. This may advantageously allow to collect a plurality of synthesis supports in a well of the well plate comprised by the collection unit. For example, all synthesis supports released simultaneously may carry identical nucleic acids or alternatively, they may carry a desired combination of nucleic acids for further processing. In some embodiments, selectively releasing synthesis supports may comprise applying a voltage and/or current to a respective electrode of the corresponding synthesis spot to lift the synthesis support in the synthesis spot. That is, by applying a voltage and/or current to a selected electrode, a synthesis support in a synthesis spot influenced by said electrode may be lifted, e.g. pushed out of the synthesis spot and for example picked up by a fluid stream running across the microfluidic chip. In particular, applying a voltage and/or current to the electrode may create air bubbles in a fluid comprised by the synthesis spot, which may advantageously lift the synthesis support. Further, the step of releasing synthesised nucleic acids may comprise the fluid supply providing a fluid to the synthesis unit. Thus, the lifted synthesis support may be picked up and carried away by the fluid running though the synthesis unit and particularly across the chip.

Generally, a fluid for lifting one or more synthesis supports (also referred to as bead lifting) may comprise water, a solvent, a salt as an electrolyte and methanol. In certain instances, a lifting fluid may comprise water, an ammonium salt, acetonitrile and methanol. Such fluids have a high conductivity required for electrochemical generation of gas bubbles while its surface tension allows for efficient bead lifting and removal of bubbles from wells. Using such fluids, bead lifting can be achieved at a potential of >4.5 V. In other instances, a lifting fluid may comprise an inorganic salt (e.g. a lithium salt), water and methanol. In an exemplary embodiment a lifting fluid comprises 0.05 M LiClO₄, 20% water and 80% methanol. Using this fluid, bead lifting can be achieved at a potential of 8.5 V and 6 mA current limit. In other instances, other salts may be used. For example, organic or inorganic salts may be added at a concentration of 0.01 M, 0.05 M, 0.1 M, 0.25 M, 0.4 M, 0.5 M, 0.7 M, 0.8 M, 0.9 M or 1.0 M. In certain instances a lifting fluid may comprise less than 50% water (such as e.g. up to 2%, up to 5%, up to 10%, up to 20%, up to 30% or up to 40% water) and more than 50% methanol (such as e.g. up to 95%, up to 90%, up to 80%, up to 70%, up to 60% methanol). In some instances, other organic solvents (such as, for example, acetonitrile) may be used instead of methanol.

Generally, potentials of >0 V and up to 10 V may be applied to allow bead lifting. In some instances, a higher potential may be used for optimal bead lifting. For example, 8.5 V may be used without limiting the current. In other instances, current on the chip may be limited during bead lifting. For example, current may be limited by only pulsing a portion of the chip's individually controllable electrodes simultaneously. For purposes of illustration only, bead lifting using a microfluidic chip with about 35,440 wells may be achieved by pulsing individually controllable electrodes in 400 wells simultaneously in subsequent steps such that not all individually controllable electrodes will be activated at the same time thereby limiting current on the chip.

The step of guiding released nucleic acids to the collection unit comprises the valve assembly assuming a configuration wherein a fluid from the synthesis unit is guided to a selected well of the well plate comprised by the collection unit. That is, the valve assembly may assume a configuration wherein it fluidly connects the synthesis unit to the collection unit and particularly to a single well of the well plate comprised by the collection unit. Further, the fluid from the synthesis unit may comprise at least one released nucleic acid. The released nucleic acid may preferably be attached to a synthesis support, e.g. bead. Thus, it may be contained in the respective well which may comprise a filter material chosen such that fluids may drain out of the well, while the synthesis supports (and attached nucleic acids) remain within the well. Further, the step of guiding released nucleic acids to the collection unit may comprise the fluid supply unit providing a fluid to the synthesis unit. Preferably, the fluid supply unit may provide the fluid to the synthesis unit without the fluid passing through the valve assembly prior to reaching the synthesis unit.

The step of collecting released nucleic acids may comprise guiding a fluid comprising at least one released nucleic acid to a well of the well plate.

The method may further comprise post-processing of the synthesized nucleic acids which may comprise cleaving nucleic acids off the respective synthesis support, removing protective groups from the nucleic acids, particularly protective groups that may interfere with downstream processing and cleaving linker molecules off the nucleic acids, wherein linker molecules may typically be used to attach nucleic acids to a synthesis support as described in more detail below. In other words, the method may comprise destroying the connection of the nucleic acid to the respective synthesis support. This may advantageously allow to separate the nucleic acids from the respective synthesis support and collect the nucleic acids for example for further processing. The step of post-processing of the synthesized nucleic acids, e.g. cleaving nucleic acids off the respective synthesis support and/or removing protective groups and/or linkers may be performed in the collection unit. For example, once the synthesis supports and attached nucleic acids are collected in a well of the well plate, they may be cleaved and deprotected.

Further, the step of cleaving nucleic acids off the respective synthesis support may generally comprise the fluid supply unit providing a fluid to the collection unit. Preferably, the fluid may be supplied to the collection unit without passing through the synthesis unit. This may be advantageous, as fluids utilized to cleave nucleic acids off the respective synthesis support may be detrimental to the synthesis process within the synthesis unit. Additionally or alternatively, the step of cleaving nucleic acids off the respective synthesis support may comprise the valve assembly assuming a configuration wherein a fluid from the fluid supply unit is guided to a selected well of the well plate comprised by the collection unit, without this fluid passing through the synthesis unit.

In some embodiments, the fluid provided by the fluid supply unit may comprise at least one amine. Further, the fluid may comprise an aqueous solution of methylamine and/or ammonium hydroxide. Such an aqueous solution may allow to cleave a nucleic acid off the respective synthesis support and elute the nucleic acid, e.g. through filter material of the well to collect the nucleic acids and/or to separate the nucleic acid from the synthesis support. Alternatively, the fluid may be a non-aqueous solution of methylamine and an organic solvent such as ethanol. A non-aqueous solution may advantageously allow to cleave the nucleic acid off the respective support structure, while preventing elution of the respective nucleic acid. That is, the molecular connection between the nucleic acid and the support structure may be destroyed but the nucleic acid may still stick to the support structure and/or the filter material. Thus, this may advantageously allow to separate cleavage and elution of the nucleic acids.

In some embodiments, the step of cleaving nucleic acids off respective synthesis supports may comprise a first step of applying a non-aqueous solution of methylamine and ethanol to cleave the nucleic acids off the synthesis support (and allow removal of protective groups and linkers) and a separate, second step of applying an aqueous solution to elute the nucleic acids. In particular, the two steps may advantageously be carried out separately and the well plate may for example be moved to a different unit or apparatus before applying the second step. Thus, the nucleic acids may be cleaved off their respective synthesis supports in the collection unit and subsequently the well plate comprising the synthesis supports and the cleaved nucleic acids may be moved to a different apparatus, wherein for example an aqueous solution may be applied to elute and collect the nucleic acids for further processing.

The method may further comprise drying synthesis supports and attached nucleic acids in the collection unit prior to cleaving nucleic acids off the respective synthesis supports. For example, a gas may be supplied by the fluid supply unit, and in particular the gas supply thereof, to the valve assembly which may guide the gas to the collection unit to dry the synthesis supports and attached nucleic acids. This may be advantageous to ensure that no water is left in the respective well comprising the synthesis supports and the nucleic acids. Alternatively or in addition, the method may further comprise heating the synthesis supports and attached nucleic acids in the collection unit prior to cleaving nucleic acids off the respective synthesis supports.

As mentioned above, the step of post-processing of the synthesized nucleic acids may comprise removing protective groups from the nucleic acids. For example, the nucleic acids, e.g. oligonucleotides, may be treated to remove the protective groups on the bases and/or the cyanoethyl protecting groups from the phosphate backbone. This process may generally be referred to as deprotection. The step of removing protective groups may be performed in the collection unit. Further, the step of removing protective groups may comprise the fluid supply unit providing a fluid to the collection unit Again, the fluid may preferably be supplied to the collection unit, e.g. via the valve assembly, without first passing through the synthesis unit. The step of removing protective groups may comprise the valve assembly assuming a configuration wherein a fluid from the fluid supply unit is guided to a selected well of the well plate comprised by the collection unit, without this fluid passing through the synthesis unit.

In some embodiments, the step of removing protective groups may be completed after the step of cleaving nucleic acids off the respective synthesis support. The step of cleaving nucleic acids off the respective synthesis support and the step of removing protective groups may be simultaneously carried out in the same well of the well plate comprised by the collection unit.

The method may further comprise guiding two independent streams of fluid through the valve assembly at the same time, wherein the two fluid streams do not get into contact with each other. This may for example advantageously allow to provide two separate fluid streams to two separate wells of the well plate comprised by the collection unit. Further, the method may comprise guiding a fluid from the synthesis unit to a well of the well plate of the collection unit and, at the same time, guiding a fluid from the fluid supply unit to another well of the well plate of the collection unit.

In some embodiments, the method may further comprise performing at least one of the steps of
synthesising nucleic acids,
selectively releasing nucleic acids,
guiding released nucleic acids to the collection unit, and
collecting released nucleic acids in the well plate, at the same time as at least one of the steps of
cleaving nucleic acids off the respective synthesis support, and
removing protective groups.

That is, the method may for example comprise releasing nucleic acids from the microfluidic chip and guiding them to the collection unit, where they may be collected in a well of the well plate, while, at the same time, e.g. in parallel, cleaving and/or deprotecting nucleic acids in another well of the well plate. This may speed up the overall synthesis process and advantageously allow for a higher throughput of the synthesis system.

The method may further comprise heating a content of wells of the well plate comprised by the collection unit. Heating a content of the wells may for example advantageously enable and/or speed up chemical processes, e.g. cleavage or deprotection. Generally a content of wells in the well plate may comprise a fluid and/or synthesis supports and attached nucleic acids. As mentioned above, the method may in some embodiments further comprise heating of the synthesis supports and attached nucleic acids in the wells of the well plate comprised by the collection unit prior to cleaving nucleic acids off the respective synthesis support.

The step of heating the content of wells of the well plate may comprise controlling the temperature based on at least one temperature signal of a temperature sensor comprised by the collection unit. In other words, the collection unit may comprise at least one temperature sensor configured to provide a temperature signal and the heating may be controlled based on the at least one temperature signal. Further, step of controlling the temperature may comprise limiting the temperature to a maximal temperature threshold. That is, the heating may be limited by a maximal temperature threshold, which may for example correspond to a temperature above which the well plate could be damaged due to the heat. Thus, the maximal temperature threshold may advantageously allow to prevent overheating the content and/or parts of the collection unit and thus prevent damages to the collection unit. Additionally or alternatively, the step of controlling the temperature may comprise controlling the temperature to a desired temperature. For example, a chemical process may comprise an optimal temperature, e.g. a processing temperature, and the temperature may advantageously be controlled to at least approximate the desired temperature.

The step of heating the content of wells of the well plate may comprise heating at least one element comprised by the collection unit. That is, the content may be indirectly heated through at least one element comprised by the collection unit. The at least one heated element may comprise an adapter plate comprised by the collection unit. Additionally or alternatively, the at least one heated element may comprise a support element comprised by the collection unit. Thus, for example, the well plate and/or contained content may be heated by at least one component of the collection unit that is preferably in direct contact with the well plate and/or the content comprised in its wells.

The method may further comprise the valve assembly assuming a configuration wherein at least one fluid stream is guided to a waste. For example, once a fluid has been guided through the synthesis unit, it may be no longer required and guided to waste by the valve assembly.

Further, the method further comprises flushing at least a portion of the system. That is, portions of the system may require flushing, also referred to as purging, in order to clean at least a portion of the fluidic paths in the system, e.g. from chemicals that may be detrimental to desired chemical processes, and/or that have been used previously in the system. Additionally or alternatively, the method may comprise backflushing at least a portion of the system. That is, at least a portion of the system may be flushed in a reversed direction, i.e. against the generally preferred flow direction Again, this may aid with removing residual fluids from portions of the fluidic system.

The method may further comprise the valve assembly assuming a configuration wherein a fluid is guided to the fluid supply unit. That is, a fluid may be guided to the fluid supply unit through the valve assembly. This may typically correspond to a reverse flow since generally fluids may flow from the fluid supply unit to the valve assembly. Thus, the valve assembly may for example be directly fluidly connected to a fluid container comprised by the fluid supply system. Additionally or alternatively, the method further comprises the valve assembly assuming a configuration wherein a fluid is guided to the synthesis unit. Again, a fluid may be guided to the synthesis unit after first flowing through the valve assembly. This may typically correspond to a reverse flow since generally fluids may flow from the synthesis unit to the valve assembly.

In embodiments, wherein the system comprises a purge valve in the fluidic connection between the fluid supply unit and the synthesis unit, the method may comprise the purge valve assuming a configuration wherein a fluid from the synthesis unit is guided to waste. This may for example advantageously allow to backflush (also referred to as backpurge) the synthesis unit. For example, a fluid may be supplied to the synthesis unit through the valve assembly, which may typically correspond to the reverse direction of the general flow through the synthesis unit. Thus, to avoid the fluid flowing all the way back to the fluid supply unit, the purge valve may advantageously allow to direct the fluid to waste.

The method may comprise establishing a pressure drop across the fluidic parts of the system configured to establish a flow of fluid in a desired direction. That is, the method may comprise establishing a pressure drop across the fluidic system, i.e. the fluidic portion of the synthesis system, such that the higher pressure is at the source of the fluids that are supposed to flow through the fluidic system, i.e. the upstream end, e.g. the fluid supply unit, and the lower pressure is at the end of the fluidic system, i.e. the downstream end, e.g. at the outlet of the collection unit. Thus, a fluid may flow from the upstream end to the downstream end without requiring further pumps, e.g. vacuum pumps at the outlet of the collection unit.

The method may further comprise collecting fluids passing through the well plate and/or the support element in a waste bin comprised by the collection unit and guiding the collected fluids to waste. Additionally, the method may comprise flushing the waste bin with a fluid. This may advantageously allow to prevent, reduce and or remove deposition and/or sedimentation of reagents (e.g. salt) within the waste bin.

The method may comprise checking tightness of the collection unit prior to each synthesis run by means of a pressure sensor. This may advantageously allow to ensure that no fluid is leaking and/or evaporating from the collection unit during a synthesis run, which may otherwise for example be harmful to the environment and/or a user.

The step of selectively releasing synthesis supports may comprise providing a lifting fluid to the synthesis unit. More particularly, the step of selectively releasing synthesis supports may comprise providing a lifting fluid to the microfluidic chip and the wells comprised thereby.

Selectively releasing synthesis supports may comprise applying an electric potential greater than 0 V, preferably greater than 2 V, more preferably greater than 4 V, most preferably greater than 8V across respective synthesis spots of the microfluidic chip. For example, the applied electric potential may be greater than 4.5 V or greater than 8.5 V. The applied electric potential may depend on the lifting fluid supplied to the synthesis unit or the microfluidic chip, respectively. For example, for a lifting fluid comprising 0.05 M LiClO₄, 20% water and 80% methanol an electric potential greater than 8.5 V may be applied, whereas for other lifting fluids, e.g. comprising an organic salt such as an ammonium salt, an electric potential greater than 4.5 V may suffice. Applying the electric potential may comprise applying a voltage and/or electric current to respective electrodes of the corresponding synthesis spots.

It will be understood, that selectively releasing synthesis supports may also include selectively releasing a single synthesis support, e.g. by applying a respective potential only to across an electrode corresponding to the synthesis spot comprising the synthesis support to be released. That is, the above is not meant to exclude releasing a single synthesis support.

A total electric current on the microfluidic chip may be limited to a maximum current. The total electric current on the microfluidic chip may be limited by simultaneously applying the electric potential only across a subset of synthesis spots, i.e. across a subset of respective electrodes. The maximum current is at most 50 mA, preferably at most 5 mA.

The method may further comprise a user replacing or inserting the microfluidic chip in the synthesis unit.

The method may further comprise determining a desired process to be run on the system. The desired process may be determined by a user. Further, the desired process may comprise one or more of synthesising nucleic acids, releasing synthesis supports from the microfluidic chip (e.g. bead lifting), post-processing of the synthesized nucleic acids (e.g. cleavage and deprotection) and or cleaning the system, more particularly fluid parts of the system, i.e. parts that guide or otherwise get into contact with fluids.

The method may further comprise checking system flow paths. System flow paths may denote tubes, fluidic conduits and other parts of the system that guide fluids or through which a fluid flows, respectively. Checking system flow paths may comprise checking system flow path for leaks, blockage and/or correct connectivity. Flow paths may be checked, e.g., by providing a forward flow and/or backward flow through at least a portion of the system to check whether the flow paths are free or blocked or whether there is any pressure loss due to leakage. For example, if a default pressure range is provided and the measured value is below or above the preset values, an alarm could be triggered or the system could be stopped. Equally it could be detected if the flow measured by the flow sensor is too slow. It will be understood that such a step may also be triggered by a processor, which may also be referred to as the processor carrying out the respective step. For example, a user may press a button on a user interface and the processor may then trigger and initiate the above step. It may also be possible that in the step of checking the flow paths, a reading of a flow sensor is provided to the user, and the user may then decide whether the reading of the flow sensor is satisfactory and proceed with further steps, or abort the respective procedure. For example, a flow path relating to the microfluidic chip in forward flush direction, a flow path relating to the microfluidic chip in backward flush direction, and/or a flow path relating to a valve manifold may be checked.

The method may comprise scanning a code on the chip holder, the microfluidic chip and/or the well plate to retrieve respective information thereon. The code may for example be a barcode or a QR-code. The respective information may comprise information as to the actual configuration of the scanned component, e.g. a part number or some other sort of identifier.

The method may further comprise automatically recalling relevant synthesis data for synthesising nucleic acids and/or lifting data for releasing synthesis supports from a data base based on the retrieved information and/or the desired process. The data may for example be recalled from a manufacturing execution system (IVIES) server. The synthesis data and/or lifting data may for example comprise protocols for synthesising nucleic acids and/or releasing synthesis supports from the microfluidic chip.

Additionally or alternatively, the method may comprise recalling relevant synthesis data for synthesising nucleic acids and/or lifting data for releasing synthesis supports from a data base based on a user input and/or the desired process.

The method may further comprise determining an expected reagent consumption for the reagents provided by the fluid supply system based on the synthesis data and/or lifting data. That is, the method may comprise calculating (or estimating) an expected consumption of reagent during synthesis, and or releasing of synthesis supports.

The method may comprise performing a pressure test for the tightness of the system. The pressure test may comprise pressurizing the system and monitoring the pressure over time to identify any unexpected pressure drop. Such a pressure drop may indicate a leak and potentially provide an indication of a leak rate. The pressure test may be performed separately for different portions of the system. This may advantageously allow to locate a leak within the system. The pressure test may comprise testing all internal flow paths for leaks. The pressure test may comprise testing the collection unit, the valve assembly, the distribution valve, the synthesis unit and/or the fluid supply system for leaks. The pressure test may be performed automatically by the system. That is, once started, the pressure test may be performed automatically by the system, e.g. by switching respective valves, pressurizing respective system parts and monitoring the pressure without additional interaction with a user.

The method may comprise providing system information during the steps of synthesising nucleic acids, releasing synthesis supports from the microfluidic chip and post-processing of the synthesized nucleic acids. Providing system information may comprise displaying system information. For example, system information may be displayed on a user interface of the system (or an external user interface) and thus advantageously enable a user (e.g. operator) to monitor the system during execution of the method or steps thereof.

The system information may comprise at least one runtime, wherein the at least one runtime comprises a runtime of system commands, a runtime of sub-cycles of a running process and/or an overall runtime System commands may for example be signals (e.g. instructions) sent from a controller to a system component. A running process may for example comprise one or more of synthesising nucleic acids, releasing synthesis supports from the microfluidic chip (e.g. bead lifting), post-processing of the synthesized nucleic acids (e.g. cleavage and deprotection) and or cleaning the system, more particularly fluid parts of the system, i.e. parts that guide or otherwise get into contact with fluids.

The system information may comprise a status of the microfluidic chip. A status of the microfluidic chip may for example comprise a voltage, current or charge applied to the microfluidic chip or information on whether the microfluidic chip is new or already used.

The system information may comprise information on wells of the microfluidic chip, which have been selected for a following step of synthesising nucleic acids or releasing synthesis supports.

The system information may comprise a status of the chip power supply connected to the microfluidic chip. The status of the chip power supply may comprise information on the current, voltage or charge, e.g. for an upcoming step of synthesising nucleic acids.

The system information may comprise sensor readings. For example readings of pressure sensors, temperature sensors and/or flow sensors, which may be comprised by the system and its various components.

The method may comprise checking a reagent consumption against the expected reagent consumption. That is, after performing a method (or process) step, such as synthesising nucleic acids, the actual reagent consumption may be compared to the expected reagent consumption. A deviation may for example provide an indication for problems during the nucleic acid synthesis.

The method may comprise generating a final report comprising information on performed method steps. The final report may for example be generated after synthesising, releasing, collecting and potentially post-processing nucleic acids. The final report may for example comprise information on warning events, error events, a protocol name, synthesis data and lifting data.

The method may comprise confirming sensor readings. Sensor readings may for example be confirmed by cross-checking different sensors of the system, e.g. by subjecting two pressure sensors to the same pressure, or by comparing sensor readings to historical sensor readings of the same process/protocol. For example, a sensor may measure the pressure in the system and if the measured value deviates from the preset range, this is indicated to the user who can then decide whether to proceed.

The method may comprise performing a supply system pressure test, wherein the supply system pressure test comprises checking each individual reagent strand of the fluid supply system for leaks. Each strand of the fluid supply system may be configured to provide a different reagent, i.e. each strand may be linked to and comprise a different fluid container.

Further, the method may comprise monitoring the pressure within the strand over time to identify any unexpected pressure drop. That is, the leak testing may be performed by monitoring a pressure in the tested strand for a pressure drop over time, which may indicate a leak and potentially a leak rate.

The method may comprise cleaning fluid parts of the system. For example, by flushing respective parts with a fluid. Fluid parts may be tubing and even fluid containers as well as other parts that are subjected to fluids during normal operation. In some embodiments, the method may comprise cleaning all fluid parts of the system.

The method may comprise changing a fluid container of the fluid supply system.

Changing a fluid container may comprise installing a new fluid container comprising an amidite or a nucleobase powder in the system, and the method may further comprise mixing the powder with acetonitrile after the new fluid container is installed in the fluidic system.

The method may comprise tracking events occurring during carrying out the method. Such events may for example comprise normal events like parameter changes or user logins. Further such events may comprise warning events, particularly relating to deviating/unexpected flow rates and chip power supply anomalies during synthesis and/or releasing of synthesis supports. Furthermore, such events may comprise error events for example relating to an over pressure in a part of the system, leaks or errors of the microfluidic chip.

The method may comprise automatically sending a message for specific predetermined events to a user or maintenance. For example, a message may be sent in case of an error event and/or a warning event. The message may be sent to a user (e.g. operator) designated for receiving the respective warning message. The message may for example be an email.

The method may comprise adjusting system parameters. System parameters may comprise controller parameters. Additionally or alternatively, system parameters may comprise at least one of parameters relating to the valve assembly, the chip power supply, the microfluidic chip, the fluid supply system, the collection unit, and/or the distribution valve.

The method may comprise managing user rights and information. User information may comprise a user password and user rights may comprise rights to start different processes and method steps or change system parameters.

The method may comprise saving and/or loading of parameter sets of the system. That is the method may comprise generating and utilizing a backup of the system or respectively the system parameters.

The method may comprise generating maintenance intervals for individual parts of the system. For example, usage of individual parts or respectively components may be monitored and based on that and/or the general durability of the respective part/component maintenance intervals may be generated.

The method may comprise monitoring controller in- and outputs. That is, controller in- and outputs may be monitored and for example displayed to the user. Similarly, the correct functioning of the controller may be monitored and displayed to the user.

The method may comprise transferring data between the system and an external data system. An external data system may for example be a USB-stick, an external hard drive or a network storage.

The method may comprise saving communication logs between the controller and system components, particularly the synthesis unit and/or the chip power supply.

The method may comprise generating statistical data on the instrument live time.

The method may comprise sampling sensor measurements or system parameters to generate traces. This may allow to plot graphs of different sensor measurements or system parameters. For example, the current, voltage and/or charge of the chip power supply may be sampled, an absorption of a spectrometer may be sampled, a temperature of the collection unit may be sampled, and/or a temperature of the safety housing and/or the instrument surrounding may be sampled.

Another embodiment of the present invention relates to a processing method comprising the steps of:
(i) providing one or more nucleic acids attached to a solid support wherein the solid support is part of or positioned in a first compartment,
(ii) adding a first solution comprising at least methylamine and an organic solvent to the first compartment to cleave the nucleic acids off the support, and
(iii) adding a second solution comprising at least water to the first compartment to elute the nucleic acids into a second compartment.

In some embodiments, the nucleic acids attached to the solid support may be oligonucleotides.

The solid support may comprise resin, controlled pore glass, beads, a membrane or a filter material. Further, the solid support may comprise beads, wherein the beads have a size of between about 5 μm and about 100 μm and optionally, wherein between about 100 and about 3,000 or between about 300 and about 1,000 beads are located in a first compartment.

The first and/or second compartment may comprise a well of a multiwell plate, a vessel, a column, a tube, or a spot on a microchip. Additionally or alternatively, the first and/or second compartment may comprise a volume of between about 100 and about 150 μl or between about 200 and about 400 μl.

In some embodiments, the first compartment may comprise a porous filter material configured to allow liquid in the first compartment to slowly pass through the pores of the filter material, optionally wherein the pores of the filter material may have a size from about 0.05 μm to about 200 μm, preferably from about 0.1 μm to about 20 μm, and optionally wherein the filter material may be formed of PEEK, PTFE, ethylene tetrafluoroethylene (ETFE), polypropylene (PP), polyethylene (PE) or glass fiber.

The first solution may comprise a mixture of methylamine and organic solvent, optionally wherein the amount of methylamine in said solution may be at least 15%, preferably at least 20%. Further, the organic solvent may be selected from the group consisting of ethanol, methanol, acetonitrile and acetone. The first solution may comprise a mixture of 33% methylamine in ethanol. In some embodiments, the first solution may not comprise water.

The second solution may comprise an aqueous buffer comprising at least 50% of water. Further, the second solution may comprise a Tris buffer.

In some embodiments the pH of the first solution may be within a range of 12 to 14. Additionally or alternatively, the pH of the second solution is between 6.0 and 7.5.

Step (i) of the processing method may further comprise providing two or more nucleic acids attached to a solid support, wherein the two or more nucleic acids have different sequences, and optionally wherein the two or more nucleic acids in the first compartment may have complementary sequence regions. Additionally or alternatively, step (i) may further comprise sealing the first compartment as to generate a closed atmosphere in the first compartment.

In some embodiments, step (ii) may further comprise heating the first compartment to a temperature of at least about 40° C., at least about 50° C., at least about 65° C. or at least about 75° C., optionally wherein the heating is performed for at least about 60 min to about 360 min, preferably about 120 min to about 240 min, more preferably about 150 min to about 180 min.

Step (iii) may further comprise drying the nucleic acids eluted into the second compartment.

In some embodiments, the processing method may further comprise after step (ii) and prior to step (iii):
(a) transferring the first compartment from a first area to a second area comprising the second compartment or
(b) transferring the second compartment from a second area to a first area comprising the first compartment as to position the first and second compartments to allow elution of the oligonucleotides from the first into the second compartment.

The nucleic acids may be between about 15 and about 200 bp in length. Additionally or alternatively, the nucleic acids may be derived from chemical, electrochemical, photochemical or enzymatic synthesis.

In some embodiments, the nucleic acids are attached to the solid support by a linker. Further, the linker may comprise a succinyl linker, optionally wherein the linker is a Unylinker.

In some embodiments, the processing method may comprise utilizing a synthesis system as described above.

Furthermore, the method for synthesizing nucleic acids may comprise the processing method as described above. That is, the method for synthesizing nucleic acids may include steps and features of the processing method.

Embodiments of the present invention also relate to a lifting fluid for releasing one or more synthesis supports, wherein the lifting fluid comprises water, at least one solvent and a salt.

The salt may have a concentration in the fluid in the range of 0.001 M to 5 M, preferably 0.005 M to 2 M. For example, the salt may have a concentration of 0.01 M, 0.05 M, 0.1 M, 0.25 M, 0.4 M, 0.5 M, 0.7 M, 0.8 M, 0.9 M or 1.0 M. The salt may be an organic salt and particularly an ammonium salt. Alternatively, the salt may be an inorganic salt and particularly a lithium salt, such as LiClO₄.

The at least one solvent may be an organic solvent. Further, the at least one solvent may comprise acetonitrile and/or methanol. That is, the lifting fluid may comprise acetonitrile, methanol or a combination thereof, e.g., a mixture of acetonitrile and methanol.

The lifting fluid may comprise more than 50% solvent, preferably at least 60% solvent, more preferably at least 70% solvent, such as at least 80%, at least 90% or at least 95% solvent Again, the solvent may be methanol, or alternatively another organic solvent (such as acetonitrile) or a combination thereof. Additionally or alternatively, the lifting fluid may comprise less than 50% water, preferably up to 40% water, more preferably up to 30% water, such as up to 20%, up to 10%, up to 5%, up to 2% water.

In some embodiments, the lifting fluid may comprise 0.05 M LiClO₄, 20% water and 80% methanol. Alternatively, the lifting fluid may for example comprise water, an ammonium salt, acetonitrile and methanol.

Furthermore, the lifting fluid in the method for synthesizing nucleic acids previously described may be a lifting fluid as described above.

Embodiments of the present invention also relate to a use of the synthesis system as discussed above for synthesis of nucleic acids, preferably oligonucleotides. Further embodiments also relate to a use of the synthesis system as discussed above for carrying out the method or the processing method as discussed above. Yet further, embodiments of the present invention also relate to a use of the lifting fluid as described above for lifting synthesis supports in the synthesis system and/or within the chip holder as discussed above.

In a further embodiment, the present invention relates to a computer program product comprising instructions which, when the program is executed by a processor comprised by the system as described before, cause the system to carry out steps of the method as discussed above. The processor may for example be the processor comprised by the controller of the system. In other words, the computer program product may be executed by the controller.

The computer program product may comprise instructions for a synthesis module for a user guided synthesis procedure for starting a nucleic acid synthesis, which, when the module is executed by a processor, cause the processor to carry out one or more of the following steps:
enable the user to choose a desired process,
check flow paths,
enable the user to scan a code on the chip holder, the microfluidic chip and/or the well plate to retrieve respective information thereon and automatically recalling relevant synthesis data for synthesising nucleic acids and/or lifting data for releasing synthesis supports from a data base based on the retrieved information and/or the desired process,
determining an expected reagent consumption,
performing a pressure test to the tightness of the system,
displaying system information to the user,
confirming sensor readings,
checking the reagent consumption, and
generating a final report.

Generally, when it is stated that the processor carries out any of the steps, it should be understood that this also encompasses the processor initializing, triggering, and/or controlling the respective step. For example, when it is stated that the processor carries out the step of “performing a pressure test to the tightness of the system”, it will be understood that the processor is operatively coupled to pressure sensors, and triggers pressure measurements of the sensors to perform the pressure test, and that this triggering and controlling of the pressure measurements is understood to be “the processor carrying out the pressure test to the tightness of the system”.

It will be understood, that a module may generally be executed directly with the program itself or, based on a user interaction with the program. Some modules may also be executed with the program and run in the background until the user actively accesses the modules functionality. Furthermore, it will be understood that steps of the modules may correspond to method steps as described above and/or that modules may additionally comprise some of the method steps as described above.

The computer program product may comprise instructions for a supply system pressure test module, which, when the program is executed by a processor, cause the processor to carry out the step of checking each individual reagent strand of the fluid supply system for leaks.

The computer program product may comprise instructions for a system pressure test module, which, when the module is executed by a processor, cause the processor to carry out the step of checking each internal flow path separately for leaks.

The computer program product may comprise instructions for a system clean module, which, when the module is executed by a processor, cause the processor to carry out the step of cleaning fluid parts of the system, preferably all fluid parts of the system.

The computer program product may comprise instructions for a fluid container change module, which, when the module is executed by a processor, cause the processor to carry out the step of supporting a user during a change of a fluid container, particularly a fluid container comprising amidites or nucleobases.

The step of supporting a user during a change of a fluid container comprising amidites or nucleobases may comprise providing acetonitrile to the fluid container after it is placed in the fluid supply system.

The computer program product may comprise instructions for an event handling module, which, when the module is executed by a processor, cause the processor to carry out the steps of:
tracking events, wherein events comprise normal events, warning events and error events, and
automatically sending messages to a user or maintenance for predetermined events.

The computer program product may comprise instructions for a user management module, which, when the module is executed by a processor, cause the processor to carry out the step of providing the user with an interface for adjusting user rights and/or information.

The computer program product may comprise instructions for a backup module, which, when the module is executed by a processor, cause the processor to carry out the step of enabling loading and saving of one or more parameter sets.

The computer program product may comprise instructions for a parameter module, which, when the module is executed by a processor, cause the processor to carry out the step of providing the user with an interface for adjusting system parameters.

The computer program product may comprise instructions for a non-automatic operation module, which, when the module is executed by a processor, cause the processor to carry out the step of providing the user with an interface for a non-automatic interaction with the system.

The non-automatic interaction with the system may comprise at least one of:
interaction with the microfluidic chip,
interaction with the chip power supply,
checking connection to HTTP or email systems, signal lights or relay outputs,
checking the fluid supply system,
switching valves,
accessing valves, pressure sensor and/or level sensor associated with the waste,
interacting with the barcode scanner, and
accessing heaters and temperature sensors of the collection unit.

The computer program product may comprise instructions for a log module, which, when the module is executed by a processor, cause the processor to carry out the step of providing an individual log system to generate maintenance for components of the system, preferably for all components of the system.

The computer program product may comprise instructions for a monitoring module, which, when the module is executed by a processor, cause the processor to carry out the step of providing the user with an interface for monitoring the controller and/or controller in- and outputs.

The computer program product may comprise instructions for a data module, which, when the module is executed by a processor, cause the processor to carry out the step of providing the user with an interface for transferring data between the system and an external data system.

The computer program product may comprise instructions for a report module, which, when the module is executed by a processor, cause the processor to carry out the step of creating a report at the end of a process.

The computer program product may comprise instructions for a diagnosis module, which, when the module is executed by a processor, cause the processor to carry out the steps of saving communications between the controller and the microfluidic chip, saving communications between the controller and the chip power supply, and enabling the user to view said communications.

The computer program product may comprise instructions for a diagnosis module, which, when the module is executed by a processor, cause the processor to carry out the steps of creating statistics data over the system lifetime.

The computer program product may comprise instructions for a statistics module, which, when the module is executed by a processor, cause the processor to carry out the steps of creating statistics data over the system lifetime.

The computer program product may comprise instructions for a sampling module, which, when the module is executed by a processor, causes the processor to carry out the steps of
sampling sensor measurements or system parameters, and
generating a trace of the sampled data.

Below, reference will be made to gas distribution unit embodiments. These embodiments are abbreviated by the letter “G” followed by a number. Whenever reference is herein made to “distribution unit embodiments”, these embodiments are meant.
G1. A gas distribution unit comprising
   an inlet configured to receive a gas;
   at least one outlet; and
   at least one valve;
   wherein the gas distribution unit is configured to supply the gas at the at least one outlet at a predetermined pressure.
G2. The gas distribution unit according to the preceding distribution unit embodiment, wherein the gas distribution unit further comprises a vent.
G3. The gas distribution unit according to the preceding distribution unit embodiment, wherein the at least one valve comprises
   a valve inlet;
   a valve outlet; and
   a ventilation outlet, wherein the ventilation outlet is fluidly connected to the vent.
G4. The gas distribution unit according to any of the preceding distribution unit embodiments, wherein the at least one valve is a proportional valve.
G5. The gas distribution unit according to the preceding distribution unit embodiment, wherein the proportional valve further comprises a proportioning mechanism configured to control the extent to which the valve outlet is fluidly connected to the valve inlet in a continuous fashion.
G6. The gas distribution unit according to the preceding distribution unit embodiment, wherein the proportioning mechanism comprises a piezoelectric element.
G7. The gas distribution unit according to the penultimate distribution unit embodiment, wherein the proportioning mechanism comprises an electromagnetic coil.
G8. The gas distribution unit according to any of the 3 preceding distribution unit embodiments, wherein the proportioning mechanism comprises mechanical means.
G9. The gas distribution unit according to any of the 6 preceding distribution unit embodiments, wherein the at least one valve is configured to assume a ventilation configuration wherein the valve outlet is fluidly connected to the ventilation outlet.
G10. The gas distribution unit according to any of the preceding distribution unit embodiments, wherein the gas distribution unit further comprises a pressure sensor for each of the at least one outlet, respectively, and wherein each pressure sensor is configured to determine a pressure at the respective outlet and to provide a corresponding pressure signal.
G11. The gas distribution unit according to any of the preceding distribution unit embodiments, wherein the at least one valve further comprises an interface configured for receiving a signal comprising at least one setpoint value for the predetermined pressure or at least one control signal for regulating an extent to which the valve outlet is fluidly connected to the valve inlet.
G12. The gas distribution unit according to the preceding distribution unit embodiment and with the features of embodiment G10, wherein the interface is further configured to provide the pressure signal of at least one pressure sensor.
G13. The gas distribution unit according to any of the 2 preceding distribution unit embodiments, wherein the interface is further configured for receiving a signal comprising at least one pressure determined by an external pressure sensor.
G14. The gas distribution unit according to any of the preceding distribution unit embodiments, wherein the gas distribution unit is configured to provide the gas at each of the at least one outlet at an individual predetermined pressure.
G15. The gas distribution unit according to any of the preceding distribution unit embodiments and with the features of embodiment G2, wherein the gas distribution unit comprises a safety valve for each of the at least one outlet, wherein each safety valve comprises
   a safety valve inlet;
   a safety valve outlet; and
   a safety valve ventilation outlet, wherein the safety valve ventilation outlet is fluidly connected to the vent.
G16. The gas distribution unit according to the preceding distribution unit embodiment, wherein the safety valve is configured to assume a safety configuration whenever the safety valve is not supplied with power, wherein in the safety configuration the safety valve outlet is fluidly connected to the safety valve ventilation outlet.
G17. The gas distribution unit according to any of the 2 preceding distribution unit embodiments and with the features of embodiment G3, wherein the safety valve inlet is fluidly connected to a valve outlet and wherein the safety valve outlet is fluidly connected to one of the at least one outlets of the gas distribution unit.
G18. The gas distribution unit according to any of the preceding distribution unit embodiments, wherein the gas distribution unit is configured to assume a default mode when not supplied with electric power, wherein the at least one outlet is at atmospheric pressure in the default mode.
G19. The gas distribution unit according to any of the preceding distribution unit embodiments, wherein the gas distribution unit is configured to supply gas at the at least one outlet at pressures in the range of 0 bar to 3 bar, preferably 0.1 bar to 2 bar, more preferably 0.2 bar to 1 bar.

Below, reference will be made to fluid supply unit embodiments. These embodiments are abbreviated by the letter “F” followed by a number. Whenever reference is herein made to “supply embodiments”, these embodiments are meant.
F1. A fluid supply unit comprising
   a plurality of fluid containers each configured to store a fluid;
   a gas supply, configured to provide a gas at a controlled pressure through at least one outlet; and
   at least one valve manifold comprising a plurality of inlets and an outlet, wherein each of the at least one valve manifold is configured to selectively fluidly connect at least one inlet to the outlet.
F2. The fluid supply unit according to the preceding supply embodiment, wherein the plurality of fluid containers each contain a liquid.
F3. The fluid supply unit according to any of the preceding supply embodiments, wherein each of the plurality of fluid containers is fluidly connected to an outlet of the gas supply by means of a gas conduit.
F4. The fluid supply unit according to the preceding supply embodiment, wherein a subset of fluid containers are fluidly connected to the same output of the gas supply via a gas supply branch.
F5. The fluid supply unit according to any of the 2 preceding supply embodiments, wherein the gas conduits are formed of a polymer.

That is, the gas-tight tubing may be a polymer tubing, which may advantageously be flexible.
F6. The fluid supply unit according to any of the supply embodiments F3 and F4, wherein the gas conduits are formed of stainless steel.
F7. The fluid supply unit according to any of the 4 preceding supply embodiments and comprising the features of embodiment F2, wherein a connection between a gas conduit and the respective fluid container is configured such that the gas conduit is not directly fluidly connected to the liquid contained by the fluid container.
F8. The fluid supply unit according to any of the 5 preceding supply embodiments, wherein each gas conduit is configured for pressures of at least 0.5 bar, preferably at least 1 bar, more preferably at least 2 bar.
F9. The fluid supply unit according to any of the preceding supply embodiments, wherein each fluid container is fluidly connected to an inlet of at least one of the at least one valve manifold by means of a fluid conduit.
F10. The fluid supply unit according to the preceding supply embodiment, wherein each inlet of the at least one valve manifold is fluidly connected to at most one fluid container.
F11. The fluid supply unit according to any of the 2 preceding embodiments and with the features of embodiment F2, wherein a connection between a fluid conduit and the respective fluid container is configured such that the fluid conduit is directly connected to the liquid contained by the fluid container.

That is, the fluid conduit may be connected to the fluid container such that there is a direct connection to the liquid stored in the fluid container, e.g. it may be inserted into the fluid container such that it extends below the surface of the contained liquid.
F12. The fluid supply unit according to any of the 3 preceding supply embodiments, wherein each fluid conduit is configured for pressures of at least 0.5 bar, preferably at least 1 bar, more preferably at least 2 bar.
F13. The fluid supply unit according to any of the preceding supply embodiments, wherein at least one of the at least one valve manifold comprises a multiport coupling valve, wherein the multiport coupling valve is configured to fluidly connect at any time at most one of the plurality of inlets of the valve manifold to the outlet of the respective valve manifold.
F14. The fluid supply unit according to any of the preceding supply embodiments, wherein at least one of the at least one valve manifold comprises a respective coupling valve for each of the plurality of inlets.
F15. The fluid supply unit according to the preceding supply embodiment, wherein each of the coupling valves is configured to selectively fluidly connect or disconnect the corresponding inlet of the at least one valve manifold to the outlet of the respective valve manifold.
F16. The fluid supply unit according to any of the preceding supply embodiments, wherein at least one of the at least one valve manifold is configured to fluidly connect at any time at most one of the plurality of inlets of the valve manifold to the outlet of the respective valve manifold.
F17. The fluid supply unit according to any of the preceding supply embodiments, wherein at least one of the at least one valve manifold is configured to enable a fluid flow from the outlet of the manifold to any of the plurality of inlets of the respective valve manifold.
F18. The fluid supply unit according to any of the preceding supply embodiments, wherein an inlet of at least one of the at least one valve manifold is directly fluidly connected to the gas supply.
F19. The fluid supply unit according to any of the preceding supply embodiments, wherein the fluid supply unit comprises two valve manifolds.
F20. The fluid supply unit according to the preceding supply embodiment, wherein at least one of the plurality of fluid containers is fluidly connected to both valve manifolds.
F21. The fluid supply unit according to any of the preceding supply embodiments, wherein the at least one valve manifold is configured to allow for mixing of fluids supplied at the plurality of inlets of the at least one valve manifold by alternately connecting the respective inlets to the outlet of the corresponding valve manifold.
F22. The fluid supply unit according to any of the preceding supply embodiments, wherein the gas supply comprises a gas reservoir configured to provide a gas and a gas distribution unit.
F23. The fluid supply unit according to the preceding supply embodiment, wherein the gas distribution unit comprises an inlet and at least one outlet, and wherein the gas distribution unit is configured to receive gas from the gas reservoir at the inlet and to provide the gas at the at least one outlet at a predetermined pressure.
F24. The fluid supply unit according to the preceding supply embodiment, wherein the gas distribution unit is configured to provide the gas at each of the at least one outlet at an individual predetermined pressure.
F25. The fluid supply unit according to any of the 3 preceding supply embodiments, wherein the gas distribution unit is a gas distribution unit according to any of the preceding distribution unit embodiments.
F26. The fluid supply unit according to any of the preceding supply embodiments, wherein the gas supply is configured to provide gas at a pressure in the range of 0 bar to 3 bar, preferably 0.1 bar to 2 bar, more preferably 0.2 bar to 1 bar.
F27. The fluid supply unit according to any of the preceding supply embodiments with the features of embodiment F22, wherein the gas reservoir provides argon or N₂.
F28. The fluid supply unit according to any of the preceding supply embodiments, wherein the fluid supply unit is configured to pressurize each of the plurality of fluid containers with gas provided by the gas supply.
F29. The fluid supply unit according to the preceding supply embodiment, wherein each of the plurality of fluid containers comprises an internal volume and wherein the internal volume of each of the plurality of fluid containers is pressurized to a pressure in the range of 0.1 bar to 2 bar, preferably 0.2 bar to 1 bar, more preferably 0.3 bar to 0.8 bar.
F30. The fluid supply unit according to any of the preceding supply embodiments, wherein the fluid supply system further comprises at least one pressure sensor, configured to determine a pressure of a fluid and provide a corresponding pressure signal.
F31. The fluid supply unit according to any of the preceding supply embodiments, wherein the fluid supply system further comprises at least one flow sensor, configured to determine a flow rate of a fluid and provide a corresponding flow signal.
F32. The fluid supply unit according to any of the preceding supply embodiments, wherein the fluid supply unit is configured to supply a fluid at the outlet of the at least one valve manifold at a pressure in the range of 0 bar to 3 bar, preferably 0.1 bar to 2 bar, more preferably 0.2 bar to 1 bar.
F33. The fluid supply unit according to any of the preceding supply embodiments, wherein the fluid supply unit is configured to supply a fluid at the outlet of the at least one valve manifold at a flow rate in the range of 0.1 ml/min to 50 ml/min, more preferably 0.5 ml/min to 20 ml/min.
F34. The fluid supply unit according to any of the preceding supply embodiments, wherein a subset of the plurality of fluid containers are surrounded by a safety housing.
F35. The fluid supply unit according to the preceding supply embodiment, wherein the safety housing comprises a tray, configured to contain any liquid leaking out of a fluid container.
F36. The fluid supply unit according to any of the 2 preceding supply embodiments, wherein the safety housing is configured to be fluid tight.
F37. The fluid supply unit according to any of the 3 preceding supply embodiments, wherein the safety housing comprises a ventilation.
F38. The fluid supply unit according to any of the 4 preceding supply embodiments, wherein the safety housing is explosion-resistant.
F39. The fluid supply unit according to any of the 5 preceding supply embodiments, wherein the safety housing comprises a control mechanism configured to indicate if a fluid container within the safety housing is pressurized.
F40. The fluid supply unit according to any of the 6 preceding supply embodiments, wherein the safety housing is configured to be locked as long as any fluid container within the safety housing is pressurized.
F41. The fluid supply unit according to any of the 7 preceding supply embodiments, wherein the safety housing comprises a temperature sensor configured to measure a temperature within the safety housing.

Below, reference will be made to chip holder embodiments. These embodiments are abbreviated by the letter “C” followed by a number. Whenever reference is herein made to “chip holder embodiments”, these embodiments are meant.
C1. A chip holder comprising a body;
   a cover plate;
   a chip cover;
   a chip receiving section, configured to accommodate a microfluidic chip;
   a sealing mechanism configured to maintain a leak-tight connection between the microfluidic chip and the chip cover; and
   a connecting mechanism configured to establish an electrical connection between a plurality of electrical contacts comprised by the microfluidic chip and corresponding electrical contacts comprised by the chip holder.
C2. The chip holder according to the preceding chip holder embodiment, wherein the chip holder further comprises a drawer, configured to be moved in and out of the body, and wherein the drawer comprises the chip receiving section.
C3. The chip holder according to the preceding chip holder embodiment, wherein the chip holder is configured to assume
an open configuration, wherein at least 60% of the drawer is located outside of the body, and
a closed configuration, wherein at least 90% of the drawer is located inside the body.
C4. The chip holder according to any of the 2 preceding chip holder embodiments, wherein the drawer comprises at least one gliding element and the body comprises at least one guiding element, wherein the gliding element is received by the guiding element.
C5. The chip holder according to the preceding chip holder embodiment, wherein the at least one gliding element comprises a runner and the at least one guiding element comprises a complementary track configured to receive and guide the runner.
C6. The chip holder according to the penultimate chip holder embodiment, wherein the at least one gliding element comprises a freely rotating rod and the at least one guiding element comprises a notch or a slot configured to receive the freely rotating rod and to guide the rod and limit its range of movement.
C7. The chip holder according to chip holder embodiment C1, wherein the chip holder comprises a slot-loading mechanism, configured to receive the microfluidic chip.
C8. The chip holder according to the preceding chip holder embodiment, wherein the slot-loading mechanism comprises a slit in the body of the chip holder and at least one motorized roller configured to draw the microfluidic chip into the chip receiving section.
C9. The chip holder according to any of the preceding chip holder embodiments, wherein the chip holder comprises at least one alignment aid, configured to aid with the correct alignment of the microfluidic chip within the chip holder.
C10. The chip holder according to the preceding chip holder embodiment, wherein the chip receiving section comprises at least one of the at least one alignment aid.
C11. The chip holder according to the preceding chip holder embodiment, wherein the chip receiving section comprises a recess configured to receive the microfluidic chip, wherein the recess constitutes one of the at least one alignment aids.
C12. The chip holder according to any of the 3 preceding chip holder embodiments, wherein at least one of the at least one alignment aid is further configured to aid with the correct alignment of the chip cover with respect to the microfluidic chip.
C13. The chip holder according to any of the preceding chip holder embodiments and with the features of embodiment C9, wherein the microfluidic chip comprises at least one alignment orifice, configured for receiving an alignment aid.
C14. The chip holder according to any of the preceding chip holder embodiments, wherein the chip receiving section comprises at least one shoulder, configured to restrain movement of the microfluidic chip in a direction orthogonal to a plane defined by the chip receiving section and/or aid with the insertion of the microfluidic chip into the chip receiving section.
C15. The chip holder according to any of the preceding chip holder embodiments, wherein the chip holder further comprises a sealing element configured to enable a leak-tight connection between the microfluidic chip and the chip cover.
C16. The chip holder according to the preceding chip holder embodiment, wherein the sealing element is fixedly mounted to the cover plate.
C17. The chip holder according to any of the 2 preceding chip holder embodiments, wherein the sealing element comprises an elastomer.
C18. The chip holder according to any of the preceding chip holder embodiments, wherein the chip cover is attached to the cover plate.
C19. The chip holder according to any of the preceding chip holder embodiments, wherein the chip holder further comprises a cover mount, configured to receive the chip cover and aid with alignment and/or fixation of the chip cover within the chip holder.
C20. The chip holder according to the preceding chip holder embodiment, wherein the cover mount is configured to be attached to the cover plate.
C21. The chip holder according to any of the 2 preceding chip holder embodiments, wherein the cover mount comprises an elastomer.
C22. The chip holder according to any of the 3 preceding chip holder embodiments, wherein the cover mount comprises a rigid material, such as polyimide (PA), acrylonitrile butadiene styrene (ABS) or polyether ether ketone (PEEK).
C23. The chip holder according to the preceding chip holder embodiment, wherein the cover mount comprises at least one structurally elastic portion.
C24. The chip holder according to any of the preceding chip holder embodiments, wherein the chip holder is configured to assume a configuration wherein at least a portion of the cover plate is located above a portion of the chip receiving section.
C25. The chip holder according to the preceding chip holder embodiment and with the features of embodiment C15, wherein the chip holder is configured to assume a configuration wherein the microfluidic chip, the chip cover, the sealing element and the cover plate are aligned with respect to each other, such that by applying a force to the cover plate, that is directed towards the chip receiving section, the chip holder may be brought into a sealing position wherein a leak-tight connection is established between the chip cover and the microfluidic chip.
C26. The chip holder according to the preceding chip holder embodiment, wherein the sealing mechanism is configured to provide a sealing force to the cover plate in the sealing position.
C27. The chip holder according to the preceding chip holder embodiment, wherein the sealing mechanism comprises at least one magnet configured to provide the sealing force.
C28. The chip holder according to any of the 2 preceding embodiments, wherein the sealing mechanism comprises at least one biasing element configured to provide the sealing force to hold the cover plate in the sealing position.
C29. The chip holder according to the preceding chip holder embodiment, wherein the sealing force provided by the biasing element is configured to further bring the cover plate into the sealing position.
C30. The chip holder according to any of the 2 preceding chip holder embodiments, wherein the at least one biasing element is a spring.
C31. The chip holder according to any of the preceding chip holder embodiments and with the features of embodiment C26, wherein the sealing force is in the range of about 20 N to about 300 N, preferably in the range of about 60 N to about 150 N.
C32. The chip holder according to any of the preceding chip holder embodiments and with the features of embodiment C25, wherein the leak-tight connection established between the chip cover and the microfluidic chip in the sealing position is pressure resistant up to at least 0.3 bar, preferably at least 0.8 bar.
C33. The chip holder according to any of the preceding chip holder embodiments, wherein the chip holder further comprises a locking mechanism comprising at least one locking device configured to lock the cover plate in an elevated position, wherein in the elevated position no leak-tight connection between the chip cover and the microfluidic chip is provided.
C34. The chip holder according to the preceding chip holder embodiment and with the features of embodiment C2, wherein in the elevated position the cover plate and any components attached thereto do not interfere with any portion of the drawer or the microfluidic chip when the drawer is moved in and out of the body.
C35. The chip holder according to any of the 2 preceding chip holder embodiments, wherein the locking device is configured to transmit a force to the cover plate such that the force acts to push the cover plate away from the chip receiving section.
C36. The chip holder according to any of the preceding chip holder embodiments and with the features of embodiment C33, wherein the at least one locking device comprises a biasing element.
C37. The chip holder according to the preceding chip holder embodiment, wherein the biasing element is configured to exert a force onto the cover plate that is configured to push the cover plate into the elevated position and further to lock the cover plate in the elevated position.
C38. The chip holder according to any of the preceding chip holder embodiments and with the features of embodiment C25, wherein the chip holder is further configured to provide a fluid connection to a volume between the chip surface and the chip cover when the cover plate is in the sealing position.
C39. The chip holder according to the preceding chip holder embodiment, wherein the chip cover comprises a plurality of fluid ports and the cover plate comprises a plurality of fluid connectors; and wherein in the sealing position the fluid connectors establish a fluid connection between fluid ports of the chip cover and external fluid conduits.
C40. The chip holder according to the penultimate chip holder embodiment, wherein the chip cover comprises a plurality of fluid connectors, configured to provide the fluid connection to the volume between the chip surface and the chip cover.
C41. The chip holder according to the preceding chip holder embodiment and with the features of embodiment C18, wherein the chip cover is attached to the cover plate by means of the fluid connectors.
C42. The chip holder according to any of the 4 preceding chip holder embodiments, wherein the fluid connection is configured for a flow rate in the range of 0.1 ml/min to 10 ml/min, preferably preferably 0.8 ml/min to 5 ml/min.
C43. The chip holder according to any of the preceding chip holder embodiments, wherein the connecting mechanism is independent of the sealing mechanism.
C44. The chip holder according to any of the preceding chip holder embodiments, wherein the electrical contacts comprised by the chip holder are spring-loaded electrical contacts.
C45. The chip holder according to any of the preceding chip holder embodiments, wherein the electrical contacts comprised by the chip holder are located within the chip receiving section.
C46. The chip holder according to any of the preceding chip holder embodiments, wherein the connecting mechanism is configured to provide a connection force to establish the electrical connection.
C47. The chip holder according to the preceding chip holder embodiment and with the features of embodiment C3, wherein the connecting mechanism comprises at least one tappet comprised by the drawer and an eccentric element mounted to the body; wherein the tappet is configured to interact with the eccentric element when the drawer is moved between the open and closed configuration and wherein the eccentric element is configured to exert the connection force when the drawer is in the closed configuration.
C48. The chip holder according to any of the preceding chip holder embodiments, wherein the connecting mechanism comprises an oblique area configured to reduce the free space above the chip receiving section when the drawer is moved from an open to a closed configuration.
C49. The chip holder according to the any of the 3 preceding chip holder embodiments, wherein the connection force is in the range between 1 N and 100 N, preferably between 2 N and 60 N, such as between 3 N and 50 N.
C50. The chip holder according to any of the preceding chip holder embodiments, wherein the electrical connection established by the connecting mechanism is configured for voltages in the range of about 3 V to about 20 V, preferably about 5 V to about 10 V.
C51. The chip holder according to any of the preceding chip holder embodiments, wherein the electrical connection established by the connecting mechanism is configured for currents in the range of about 2 mA to about 500 mA, preferably from about 3 mA to about 300 mA.
C52. The chip holder according to any of the preceding chip holder embodiments, wherein the electrical contacts comprised by the microfluidic chip are located at an underside of the chip.
C53. The chip holder according to any of the preceding chip holder embodiments, wherein the chip cover comprises at least one cover electrode.
C54. The chip holder according to the preceding chip holder embodiment and with the features of embodiment C25, wherein the chip receiving section comprises at least one contact pin, and wherein the contact pin is configured to establish an electrical connection to the at least one cover electrode.
C55. The chip holder according to the preceding chip holder embodiment, wherein the at least one contact pin is a spring-loaded electrical contact pin.
C56. The chip holder according to any of the 2 preceding chip holder embodiments and with the features of embodiment C9, wherein the contact pin further serves as alignment aid.
C57. The chip holder according to any of the 3 preceding chip holder embodiments, wherein the microfluidic chip comprises a pin orifice, configured for guiding the at least one contact pin through the respective pin orifice when placing the microfluidic chip in the chip receiving section.
C58. The chip holder according to the preceding chip holder embodiment and with the features of embodiment C13, wherein the pin orifice further serves as alignment orifice.

Below, reference will be made to rotary valve embodiments. These embodiments are abbreviated by the letter “R” followed by a number. Whenever reference is herein made to “valve embodiments”, these embodiments are meant.
R1. A rotary valve comprising
   a stator comprising a plurality of channels; and
   a rotor comprising at least one groove;
   a plurality of tubes, wherein each tube extends into a channel, respectively.
R2. The rotary valve according to the preceding embodiment, wherein the rotary valve is configured such that the at least one groove can fluidly connect the channels.
R3. The rotary valve according to any of the preceding valve embodiments, wherein each of the channels comprises a portion having a first inner channel diameter.
R4. The rotary valve according to any of the preceding embodiments, wherein the tubes have an uncompressed outer tube diameter in an uncompressed state.
R5. The rotary valve according to any of the preceding valve embodiments with the features of embodiments R3 and R4, wherein the first inner channel diameter is smaller than the uncompressed outer tube diameter.
R6. The rotary valve according to any of the preceding valve embodiments, wherein the stator is formed from a plastic material or is formed from stainless steel.
R7. The rotary valve according to any of the preceding valve embodiments, wherein the rotor is formed from a plastic material or is formed from stainless steel.
R8. The rotary valve according to any of the 2 preceding valve embodiments, wherein at most one of the stator and the rotor is formed of stainless steel.
R9. The rotary valve according to any of the preceding valve embodiments, wherein an outer surface of the tubes and an inner surface of the respective channels form a sealing interface, when in contact with each other.
R10. The rotary valve according to the preceding valve embodiment, wherein the sealing interface is substantially leak tight for pressures of at least 0.3 bar, preferably at least 0.6 bar, more preferably at least 1 bar.
R11. The rotary valve according to any of the preceding valve embodiments, wherein the channels define a first direction of the stator, and wherein the channels have a channel length along the first direction.
R12. The rotary valve according to any of the preceding valve embodiments, wherein the tubes extend for at least 1 mm, preferably at least 2 mm into the respective channels.
R13. The rotary valve according to any of the preceding valve embodiments, wherein the stator comprises a connection face and a gliding face, wherein at least a portion of the gliding face is configured to contact the rotor in use.
R14. The rotary valve according to the preceding embodiment, wherein the stator comprises a single block between the connection face and the gliding face.
R15. The rotary valve according to the preceding embodiment and with the feature of embodiment R11, wherein the tubes extend for at least 80%, preferably at least 90% of the channel length into the channels.
R16. The rotary valve according to any of the 2 preceding embodiments, wherein the tubes extend from the connection face to the gliding face.
R17. The rotary valve according to any of the preceding embodiments with the features of embodiment R13 and not dependent on embodiment R14, wherein the stator comprises a first block and a second block between the connection face and the gliding face.
R18. The rotary valve according to the preceding embodiment, wherein each of the channels extends through both blocks, and wherein each channel has a first channel portion extending through the first block and a second channel portion extending through the second block.
R19. The rotary valve according to the preceding embodiment and with the features of embodiment R3, wherein the first channel portion comprises the first inner channel diameter.
R20. The rotary valve according to the preceding embodiment, wherein the second channel portion comprises a first channel section with a first section channel diameter and a second channel section with a second section channel diameter.
R21. The rotary valve according to the preceding embodiment, wherein the first section channel diameter is greater than the second section channel diameter.
R22. The rotary valve according to any of the 2 preceding embodiments and with the features of embodiment R4, wherein the first section channel diameter is greater than or equal to the uncompressed outer tube diameter.
R23. The rotary valve according to any of the 3 preceding embodiments and with the features of embodiment R4, wherein the second section channel diameter is smaller than the uncompressed outer tube diameter.
R24. The rotary valve according to any of the 4 preceding embodiments and with the features of embodiment R11, and wherein the respective tube extends over the entire first channel section along the first direction.
R25. The rotary valve according to any of the preceding valve embodiments, wherein the plurality of tubes comprises at least 5 tubes, preferably at least 10 tubes, further preferably at least 25 tubes.
R26. The rotary valve according to any of the preceding valve embodiments, wherein each of the tubes in the channels has a central axis, and wherein the central axes of two tubes are distanced by not more than 8 mm, preferable not more than 5, more preferable not more than 3.5 mm.
R27. The rotary valve according to any of the preceding valve embodiments, wherein the rotor comprises a rotor gliding face and a back face, wherein the rotor gliding face is configured to contact the stator in use.
R28. The rotary valve according to the preceding valve embodiment, wherein the gliding face comprises the at least one groove.
R29. The rotary valve according to any of the 2 preceding valve embodiments, wherein the rotary valve further comprises a biasing element connected to the back face of the rotor and configured to bias the rotor gliding face against the stator.
R30. The rotary valve according to the preceding valve embodiment, wherein the rotary valve further comprises a ball bearing, and wherein the biasing element is connected to the back face via the ball bearing.
R31. The rotary valve according to any of the preceding valve embodiments and with the features of embodiment R28, wherein the rotor further comprises a sealing lip,
   wherein the sealing lip is located on the rotor gliding face and surrounds the at least one groove; and
   wherein the sealing lip is configured to seal the channels of the stator that are not fluidly connected to the groove of the rotor.
R32. The rotary valve according to the preceding valve embodiment, wherein the sealing lip is formed integrally with the rotor.
R33. The rotary valve according to the penultimate valve embodiment, wherein the sealing lip is formed of an elastomer.

Below, reference will be made to collection unit embodiments. These embodiments are abbreviated by the letter “A” followed by a number. Whenever reference is herein made to “unit embodiments”, these embodiments are meant.
A1. A collection unit configured to collect nucleic acids comprising
   an adapter plate, configured to be connected with a plurality of fluid tubes; and
   a well plate, comprising a plurality of wells;
   wherein the collection unit is configured to maintain a connection between the adapter plate and the well plate.
A2. The collection unit according to the preceding unit embodiment, wherein the connection between the adapter plate and the well plate is leak tight.
A3. The collection unit according to any of the preceding unit embodiments and further comprising
   a connection mechanism, wherein the connection mechanism is configured to connect the adapter plate and the well plate such that the connection therebetween is maintained.
A4. The collection unit according to any of the preceding unit embodiments, wherein each well comprises a filter material.
A5. The collection unit according to the preceding unit embodiment, wherein each well comprises an individual portion of the filter material.
A6. The collection unit according to the penultimate unit embodiment, wherein a mat of filter material is attached to the bottom of the wells, and wherein the mat of filter material is attached such that each well is fluidly separated from the other wells.
A7. The collection unit according to the preceding unit embodiment, wherein the mat of filter material is glued to the bottom of the wells or fused to the bottom of the wells utilizing heat.
A8. The collection unit according to any of the 4 preceding unit embodiments, wherein the filter material is formed of polyether ether ketone (PEEK), polytetrafluorethylene (PTFE), ethylene tetrafluoroethylene (ETFE), polypropylene (PP), polyethylene (PE) or glass fibre.
A9. The collection unit according to any of the 5 preceding unit embodiments, wherein the filter material comprises a pore size and wherein the pore size is in the range of 0.05 μm to 200 μm, preferably in the range of 0.1 μm to 20 μm.
A10. The collection unit according to any of the preceding unit embodiment, wherein the well plate is formed of a polymer, preferably a thermoplastic.
A11. The collection unit according to the preceding unit embodiment, wherein the well plate is formed of polyether ether ketone (PEEK), polypropylene (PP), polyethylene (PE) or polyphenylene sulphide (PPS).
A12. The collection unit according to any of the preceding unit embodiments, wherein the collection unit further comprises at least one sealing member.
A13. The collection unit according to any of the preceding unit embodiments, wherein the adapter plate comprises a plurality of channels for guiding a fluid through the adapter plate, wherein the fluid is guided in the direction of the well plate.
A14. The collection unit according to the preceding unit embodiment, wherein the adapter plate comprises a fluid connector for each channel, wherein the fluid connector is fluidly connected to an upstream end of the channel.
A15. The collection unit according to the preceding unit embodiment, wherein each channel is configured to guide a fluid introduced at a fluid connector through the respective channel and into a respective well.
A16. The collection unit according to any of the preceding unit embodiments, wherein the adapter plate comprises at least one extension, wherein each of the at least one extension extends into a respective well.
A17. The collection unit according to the preceding unit embodiment and with the features of embodiment A13, wherein the adapter plate comprises an extension for each of the plurality of channels, and wherein each channel runs through a respective extension into the respective well.
A18. The collection unit according to any of the preceding unit embodiments with the features of embodiment A12, wherein the at least one sealing member comprises a sealing mat contacting the adapter plate and the well plate.
A19. The collection unit according to the preceding unit embodiment and with the features of embodiment A13, wherein the sealing mat comprises an orifice for each channel for guiding a fluid or tube through the adapter plate.
A20. The collection unit according to any of the 2 preceding unit embodiments and with the features of embodiment A16, wherein each of the at least one extension extends through a respective orifice in the sealing mat.
A21. The collection unit according to any of the 3 preceding unit embodiments, wherein the sealing mat is configured to seal the adapter plate against the well plate, and wherein each well in contact with the sealing mat is fluidly separated from the other wells of the well plate.
A22. The collection unit according to any of the preceding unit embodiments and with the features of embodiment A12, wherein the sealing member is formed of an elastic material.
A23. The collection unit according to any of the preceding unit embodiments and with the features of embodiment A12, wherein the sealing member is formed of silicone, preferably foamed silicone, or a plastic material, such as an elastomer, and preferably a perfluoroelastomer.
A24. The collection unit according to any of the preceding unit embodiments with the features of embodiment A3, wherein the connection mechanism comprises at least one fastening member connected to the adapter plate and at least one locking member to lock a location of the at least one fastening member and thus the adapter plate with respect to the well plate.
A25. The collection unit according to the preceding unit embodiment, wherein the at least one fastening member is formed integrally with the adapter plate.
A26. The collection unit according to any of the 2 preceding unit embodiments, wherein the at least one fastening member comprises a plurality of fastening members, and wherein the adapter plate is located between the fastening members.
A27. The collection unit according to any of the preceding unit embodiments, wherein the collection unit is further configured to heat fluid contained in the wells.
A28. The collection unit according to any of the preceding unit embodiments, wherein the collection unit comprises at least one heating element configured to heat at least a portion of the collection unit.
A29. The collection unit according to the preceding unit embodiment, wherein the heating element is an electrical heating element.
A30. The collection unit according to any of the 2 preceding unit embodiments, wherein the adapter plate comprises at least one of the at least one heating element.
A31. The collection unit according to the preceding unit, wherein the adapter plate is formed of a material with a thermal conductivity greater than 10 W/(m×K), preferably greater than 100 W/(m×K), further preferably greater than 200 W (m×K).
A32. The collection unit according to any of the preceding unit embodiments, wherein the collection unit further comprises a support element configured to support the well plate.
A33. The collection unit according to the preceding unit embodiment, wherein the support element comprises a plurality of recesses, wherein each recess receives a section of a well, respectively.
A34. The collection unit according to any of the 2 preceding unit embodiments, wherein the support element comprises a channel for each well.
A35. The collection unit according to any of the 3 preceding unit embodiments and with the features of embodiment A28, wherein support element comprises at least one of the at least one heating element.
A36. The collection unit according to the preceding unit, wherein the support element is formed of a material with a thermal conductivity greater than 10 W/(m×K), preferably greater than 100 W/(m×K), further preferably greater than 200 W (m×K).
A37. The collection unit according to any of the 2 preceding unit embodiments, wherein the support element is formed of metal.
A38. The collection unit according to any of the preceding unit embodiments, wherein the collection unit further comprises at least one temperature sensor.
A39. The collection unit according to the preceding unit embodiment, wherein the adapter plate comprises at least one temperature sensor.
A40. The collection unit according to the preceding unit embodiment and with the features of embodiment A16, wherein at least one of the at least one temperature sensor is comprised by an extension of the adapter plate.
A41. The collection unit according to any of the 3 preceding unit embodiments and with the features of embodiment A32, wherein the support element comprises a temperature sensor.
A42. The collection unit according to any of the preceding unit embodiments with the features of embodiment A12, wherein the at least one sealing member is a plurality of sealing members, and wherein each sealing member comprises a sealing extension, wherein each sealing extension is configured to extend into a respective well and to seal against the respective well.
A43. The collection unit according to the preceding unit embodiment, wherein each sealing member comprises a biasing element biasing the respective sealing extension towards the respective well.
A44. The collection unit according to the preceding unit embodiment, wherein the biasing elements are springs.
A46. The collection unit according to any of the preceding unit embodiments and with the features of embodiments A13 and A42, wherein each sealing extension is located downstream of the respective channel.
A47. The collection unit according to any of the preceding unit embodiments with the features of embodiment A42, wherein the sealing extensions have a conical shape.
A48. The collection unit according to any of the preceding unit embodiments, wherein the wells have a conical shape.
A49. The collection unit according to any of the preceding unit embodiments with the features of embodiments A13 or A42, wherein each of the plurality of fluid tubes are received in a respective channel of the adapter plate and/or in a respective channel of the sealing extension.
A50. The collection unit according to the preceding unit embodiment, wherein at least a portion of the respective channel of the adapter plate and/or the sealing extension comprises an inner diameter that is smaller than an outer diameter of the respective uncompressed tube.
A51. The collection unit according to any of the preceding unit embodiment and with the features of embodiment A42, wherein the sealing extensions are formed of silicone, polytetrafluorethylene (PTFE), polyether ether ketone (PEEK), polyurethane (PUN) or perfluoroalkoxy alkanes (PFA).
A52. The collection unit according to any of the preceding unit embodiments with the features of embodiment A27, wherein the adapter plate is configured to heat the fluid contained in the wells.
A53. The collection unit according to any of the preceding unit embodiments with the features of embodiments A12 and A27, wherein the sealing member is configured to heat the fluid contained in the wells.
A54. The collection unit according to any of the preceding unit embodiments, wherein the collection unit is configured to maintain an elevated pressure in the wells.
A55. The collection unit according to any of the preceding unit embodiments, wherein the nucleic acids the collection unit is configured to collect are oligonucleotides.
A56. The collection unit according to any of the preceding unit embodiments, wherein the nucleic acids the collection unit is configured to collect are attached to a support.
A57. The collection unit according to any of the preceding unit embodiments and with the features of unit embodiment A3, wherein the connection mechanism is further configured for providing a plate sealing force that establishes the connection between the adapter plate and the well plate.
A58. The collection unit according to the preceding unit embodiment, wherein the connection mechanism comprises at least one lever arm configured for applying the plate sealing force to establish the connection between the adapter plate and the well plate.
A59. The collection unit according to the preceding unit embodiment, wherein at least one of the at least one lever arm is connected to the adapter plate.
A60. The collection unit according any of the 2 preceding unit embodiments, wherein the at least one lever arm is configured to transform a rotational movement into a substantially linear movement when establishing the connection between the adapter plate and the well plate.
A61. The collection unit according to any of the 3 preceding unit embodiments, wherein the connection mechanism comprises a freewheel bearing connecting two lever arms, wherein said connected lever arms are configured to assume at least two different configurations corresponding to two different relative positions of the adapter plate and the well plate.
A62. The collection unit according to the preceding unit embodiment,
   wherein a first position of the at least two different relative positions corresponds to a position wherein the connection between the adapter plate and the well plate is established, and
   wherein a second position of the at least two different relative positions corresponds to a position wherein the connection between the adapter plate and the well plate is not established.
A63. The collection unit according to any of the 6 preceding unit embodiments, wherein the connection mechanism comprises an electric or pneumatic actor, such as a motor, a linear actuator or a pneumatic cylinder, configured to apply the plate sealing force configured to establish the connection between the adapter plate and the well plate.
A64. The collection unit according to the preceding unit embodiment and with the features of unit embodiment A61, wherein the electric or pneumatic actor is configured to change the configuration assumed by the connected lever arms.
A65. The collection unit according to the preceding unit embodiment, wherein the electric or pneumatic actor is configured to change the configuration assumed by the connected lever arms by changing direction of the force provided by the electric or pneumatic actor.
A66. The collection unit according to any of the preceding unit embodiments and with the features of unit embodiment A12, wherein at least one of the at least one sealing member is part of the connection between the adapter plate and the well plate.
A67. The collection unit according to any of the preceding unit embodiments and with the features of A32, wherein the support element further comprises a well plate sealing element configured to provide a seal for a connection between the well plate and the support element.
A68. The collection unit according to the preceding unit embodiment, wherein the well plate sealing element is configured to seal against nozzles of the well plate.
A69. The collection unit according to any of the 2 preceding unit embodiments, wherein the well plate sealing element is configured to seal flat against a downstream side of the well plate.
A70. The collection unit according to any of the 3 preceding unit embodiments, wherein the well plate sealing element is located at an upstream side of the support element.
A71. The collection unit according to any of the 4 preceding unit embodiment, wherein the well plate sealing element is made of one of silicone, preferably foamed silicone, or a plastic material, such as an elastomer.
A72. The collection unit according to any of the 5 preceding unit embodiments, wherein the well plate sealing element is made of one of ethylene propylene diene (EPDM), polytetrafluorethylene (PTFE), perfluoroelastomer (FFKM), polyurethane (PUN) or perfluoroalkoxy alkanes (PFA)

A73. The collection unit according to any of the 6 preceding unit embodiments, wherein the collection unit further comprises a sheet, configured to hold the well plate sealing element in place.
A74. The collection unit according to the preceding unit embodiment, wherein the sheet is made of metal.
A75. The collection unit according to any of the preceding unit embodiments, wherein the collection unit further comprises a waste bin.
A76. The collection unit according to the preceding unit embodiment and with the features of A32, wherein the waste bin is located downstream of the support element.
A77. The collection unit according to any of the 2 preceding unit embodiments, wherein the waste bin is configured to collect and dispose of any fluid passing through the well plate and/or the support element.
A78. The collection unit according to any of the 3 preceding unit embodiments, wherein the waste bin comprises at least one waste bin chamber configured to collect fluids passing though the well plate and/or the support element.
A79. The collection unit according to the preceding unit embodiment, wherein each of the at least one waste bin chamber is fluidly connected to a waste bin outlet configured to guide fluids from the respective waste bin chamber to waste.
A80. The collection unit according to any of the 5 preceding unit embodiments, wherein the waste bin is made of material that is resistant to the applied chemicals.
A81. The collection unit according to any of the 6 preceding unit embodiments, wherein the waste bin is made of material that is configured to insulate against heat of the well plate and/or the support element.
A82. The collection unit according to any of the 7 preceding unit embodiments, wherein the waste bin is made of PEEK.
A83. The collection unit according to any of the 8 preceding unit embodiments and with the features of A78, wherein the waste bin further comprises at least one flushing element configured for flushing the at least one waste bin chamber with a fluid.
A84. The collection unit according to the preceding unit embodiment, wherein the waste bin further comprises at least one flushing inlet, configured to receive a fluid for flushing and to guide the received fluid to at least one of the at least one flushing element.
A85. The collection unit according to any of the 2 preceding unit embodiments, wherein the flushing element is configured to guide the fluid to an inner surface of the circumferential wall of the at least one waste bin chamber.
A86. The collection unit according to the preceding unit embodiment, wherein the flushing element is configured to equally distribute the fluid on the inner surface.
A87. The collection unit according to any of the 4 preceding unit embodiments, wherein the flushing element is a frame-like structure.
A88. The collection unit according to the preceding unit embodiment, wherein an outer circumference of the frame-like structure matches an inner circumference of the respective at least one waste bin chamber.
A89. The collection unit according to any of the 6 preceding unit embodiments, wherein the flushing element comprises channels for guiding the fluid within the flushing element and at least one flushing element outlet for releasing the fluid into the waste bin chamber.
A90. The collection unit according to the preceding unit embodiment and with the features of A85, wherein the at least one flushing element outlet of the flushing element is located such that the fluid is released in the direction of the circumferential wall of the at least one waste bin chamber.
A91. The collection unit according to any of the 2 preceding unit embodiments, wherein the channels are provided by drilling holes comprised by the flushing element.
A92. The collection unit according to any of the preceding unit embodiments and with the features of A78 and A83, wherein the number of flushing elements comprised by the waste bin matches the number of waste bin chambers comprised by the waste bin.
A93. The collection unit according to any of the preceding unit embodiments and with the features of A78 and A84, wherein the number of flushing inlets comprised by the waste bin matches the number of waste bin chambers comprised by the waste bin.
A94. The collection unit according to any of the preceding unit embodiments and with the features of A83 and A84, wherein the number of flushing inlets comprised by the waste bin matches the number of flushing elements comprised by the waste bin.
A95. The collection unit according to any of the preceding unit embodiments and with the features of A76, wherein the collection unit further comprises a waste bin sealing element configured to seal a connection between the support element and the waste bin.
A96. The collection unit according to the preceding unit embodiment, wherein the waste bin sealing element is made of one of silicone, preferably foamed silicone, or a plastic material, such as an elastomer.
A97. The collection unit according to any of the 2 preceding unit embodiments, wherein the waste bin sealing element is made of one of ethylene propylene diene (EPDM), polytetrafluorethylene (PTFE), perfluoroelastomer (FFKM), polyurethane (PUN) or perfluoroalkoxy alkanes (PFA).
A98. The collection unit according to any of the 3 preceding unit embodiments and with the features of A75 and/or A32, wherein the collection unit further comprises a positioning element configured to aid with the positioning of the waste bin sealing element relative to the waste bin and/or the support element.
A99. The collection unit according to the preceding unit embodiment, wherein the positioning element is further configured to predetermine a compression of the waste bin sealing element when the collection unit is in an assembled state.
A100. The collection unit according to any of the 2 preceding unit embodiments and with the features of A75 and A32, wherein the positioning element is further configured for insulating the waste bin from the support element.
A101. The collection unit according to any of the 3 preceding unit embodiments, wherein the positioning element is made of a polyamide material.
A102. The collection unit according to any of the preceding unit embodiments and with the features of A67, wherein the collection unit further comprises a support element sealing component configured to provide a seal for leakage from the well plate sealing element.
A103. The collection unit according to the preceding unit embodiment, wherein the support element sealing component comprises an aperture at least the size of the well plate sealing element and/or the sheet.
A104. The collection unit according to any of the 2 preceding unit embodiments, wherein the support element sealing component is configured to provide a seal for an interface between the support element and the well plate, preferably an outer rim of the well plate.
A105. The collection unit according to any of the preceding unit embodiments, wherein the collection unit comprises at least one pressure sensor configured to determine a pressure within the collection unit.

Below, reference will be made to system embodiments. These embodiments are abbreviated by the letter “S” followed by a number. Whenever reference is herein made to “system embodiments”, these embodiments are meant.
S1. A system comprising
   a fluid supply unit;
   a synthesis unit comprising a microfluidic chip, configured for the synthesis of nucleic acids;
   a valve assembly, comprising at least one multiport valve; and
   a collection unit configured to collect nucleic acids.
S2. The system according to the preceding system embodiment, wherein the valve assembly is configured to direct fluid between
   the synthesis unit and the collection unit,
   the fluid supply unit and the synthesis unit, and
   the fluid supply unit and the collection unit.
S3. The system according to any of the preceding system embodiments, wherein the valve assembly is configured to establish two fluid streams between fluid connections of the valve assembly without the two fluid streams coming into contact.
S4. The system according to any of the preceding system embodiments, wherein the valve assembly is configured to guide fluid to a waste.
S5. The system according to any of the preceding system embodiments, wherein the valve assembly comprises at least one distribution valve comprising a plurality of valve connections, wherein the distribution valve is configured to establish a maximum of one direct fluidic connection between two valve connections.
S6. The system according to any of the preceding system embodiments, wherein the distribution valve comprises at least 10 valve connections or at least 15 valve connections, preferably at least 20 or at least 24 valve connections, more preferably at least 28 or at least 30 valve connection.
S7. The system according to any of the 2 preceding system embodiments, wherein at least one of the valve connections of at least one of the at least one distribution valve is fluidly connected to the fluid supply unit, without the synthesis unit being part of said fluid connection.
S8. The system according to any of the 3 preceding system embodiments, wherein at least one of the valve connections of at least one of the at least one distribution valve is fluidly connected to the waste.
S9. The system according to any of the 4 preceding system embodiments, wherein one of the plurality of valve connections of each of the at least one distribution valve is a distribution valve connection and wherein each distribution valve is configured to establish a direct fluidic connection between the distribution valve connection and any other valve connection of the distribution valve.
S10. The system according the preceding system embodiment, wherein the valve assembly further comprises a selection valve, and wherein the selection valve is fluidly connected to the distribution valve connection of each of the at least one distribution valve.
S11. The system according to the preceding system embodiment, wherein the selection valve is fluidly connected to the synthesis unit.
S12. The system according to any of the 2 preceding system embodiments, wherein the selection valve is fluidly connected to a valve manifold comprised by the fluid supply unit, without the synthesis unit being part of the fluid connection.
S13. The system according to any of the preceding system embodiments with the features of embodiments S5 and S10, wherein the valve assembly comprises two distribution valves and one selection valve.
S14. The system according to any of the preceding system embodiments, wherein the system comprises a gas distribution unit according to any of the preceding gas distribution unit embodiments.
S15. The system according to any of the preceding system embodiments, wherein the fluid supply unit is the fluid supply unit according to any of the preceding supply embodiments.
S16. The system according to any of the preceding system embodiments, wherein the system further comprises the chip holder according to any of the preceding chip holder embodiments.
S17. The system according to any of the preceding system embodiments, wherein the at least one multiport valve comprises a rotary valve according to any of the preceding rotary valve embodiments.
S18. The system according to any of the preceding system embodiments, wherein the collection unit is a collection unit according to any of the preceding unit embodiments.
S19. The system according to any of the preceding system embodiments, wherein the synthesis unit is fluidly connected to the fluid supply unit, without the valve assembly being part of the fluid connection.
S20. The system according to the preceding system embodiment, wherein the system further comprises a purge valve, and wherein the purge valve is a multiport valve and located in the fluid connection between the fluid supply unit and the synthesis unit.
S21. The system according to the preceding system embodiment, wherein the purge valve is configured to assume
   a first configuration, wherein the fluid supply unit is fluidly connected to the synthesis unit, and
   a second configuration, wherein the fluid supply unit and/or the synthesis unit are fluidly connected to a waste.
S22. The system according to any of the 2 preceding system embodiments, wherein the purge valve is a rotary valve according to any of the preceding rotary valve embodiments.
S23. The system according to any of the preceding system embodiments and with the features of S4 and/or S21, wherein the system comprises a single waste.
S24. The system according to any of the preceding system embodiments and with the features of S4 and/or S21, wherein the waste comprises a bellows container.
S25. The system according to any of the preceding system embodiments, wherein the nucleic acids the microfluidic chip is configured to synthesize are oligonucleotides.
S26. The system according to any of the preceding system embodiments, wherein the nucleic acids the collection unit is configured to collect are oligonucleotides.
S27. The system according to any of the preceding system embodiments, wherein the system comprises a controller configured to control and/or operate the system.
S28. The system according to the preceding system embodiment, wherein the controller is operatively connected to the fluid supply unit, the synthesis unit and the valve assembly.
S29. The system according to any of the 2 preceding system embodiments, wherein the controller is operatively connected to the collection unit.
S30. The system according to any of the 3 preceding system embodiments and with the features of S20, wherein the controller is operatively connected to the purge valve.
S31. The system according to any of the 4 preceding system embodiments, wherein the controller comprises a data processing unit and/or a central processing unit.
S32. The system according to any of the 5 preceding system embodiments, wherein the controller comprises a microprocessor.
S33. The system according to any of the 6 preceding system embodiments, wherein the controller comprises a memory.
S34. The system according to any of the 7 preceding system embodiments, wherein the controller is a programmable logic controller.
S35. The system according to any of the preceding system embodiments, wherein the system further comprises a chip power supply configured to supply the synthesis unit and particularly the comprised microfluidic chip with a voltage, electric current and/or charge.
S36. The system according to any of the preceding system embodiments, wherein the system further comprises at least one pressure sensor, located at an internal flow path of the system.
S37. The system according to any of the preceding system embodiments, wherein the system further comprises at least one flow sensor, located at an internal flow path of the system.
S38. The system according to any of the preceding system embodiments, wherein the system comprises at least one temperature sensor, configured to measure an ambient temperature of the system.
S39. The system according to any of the preceding system embodiments, wherein the system comprises a barcode scanner, configured to scan a bar code and/or a QR code.
S40. The system according to any of the preceding system embodiments and with the features of embodiments S23 of S24, wherein the waste comprises a pressure sensor.
S41. The system according to any of the preceding system embodiments and with the features of embodiments S23 of S24, wherein the waste comprises a level sensor configured to measure a filling level of the waste.
S42. The system according to any of the preceding system embodiments, wherein the system comprises a user interface.

Below, reference will be made to method embodiments. These embodiments are abbreviated by the letter “M” followed by a number. Whenever reference is herein made to “method embodiments”, these embodiments are meant.
M1. A method for synthesising nucleic acids utilizing a synthesis system according to any of the preceding system embodiments.
M2. The method according to the preceding method embodiment, wherein the method comprises
   synthesising nucleic acids on the microfluidic chip;
   selectively releasing synthesised nucleic acids from the microfluidic chip;
   guiding released nucleic acids to the collection unit; and
   collecting released nucleic acids in a well plate comprised by the collection unit.
M3. The method according to the preceding method embodiment, wherein the step of synthesising nucleic acids comprises providing a fluid through the fluid supply unit to the synthesis unit.
M4. The method according to any of the 2 preceding method embodiments, wherein the step of synthesising nucleic acids comprises synthesising nucleic acids on a synthesis support, wherein each support is located in a synthesis spot of the microfluidic chip.
M5. The method according to the preceding method embodiment, wherein the step of synthesising nucleic acids comprises controlling the environment of each individual synthesis spot to determine to which synthesis support a nucleotide can be attached.
M6. The method according to the preceding method embodiment, wherein controlling the environment of each individual synthesis spot comprises applying a voltage and/or current to a respective electrode of the synthesis spot to change the pH of a fluid within the synthesis spot.
M7. The method according to any of the 3 preceding method embodiments, wherein the synthesis support is a bead, and wherein the bead comprises a diameter of 5 μm to 50 μm, 10 μm to 200 μm, preferably 20 μm to 100 μm, more preferably 30 μm to 80 μm.
M8. The method according to any of the preceding method embodiments and with the features of embodiment M2, wherein the step of synthesising nucleic acids comprises synthesising nucleic acids comprising 10 to 500 bases, preferably 20 to 250 bases, more preferably 30 to 100 bases.
M9. The method according to any of the preceding method embodiments and with the features of embodiment M4, wherein the step of selectively releasing synthesised nucleic acids comprises selectively releasing synthesis supports carrying nucleic acids from the microfluidic chip.
M10. The method according to the preceding method embodiment, wherein selectively releasing synthesis supports comprises applying a voltage and/or current to a respective electrode of the corresponding synthesis spot to lift the synthesis support in the synthesis spot.
M11. The method according to any of the preceding method embodiments and with the features of embodiment M2, wherein the step of releasing synthesised nucleic acids comprises the fluid supply providing a fluid to the synthesis unit.
M12. The method according to any of the preceding method embodiments and with the features of embodiment M2, wherein the step of guiding released nucleic acids to the collection unit comprises the valve assembly assuming a configuration wherein a fluid from the synthesis unit is guided to a selected well of the well plate comprised by the collection unit.
M13. The method according to the preceding method embodiment, wherein the fluid from the synthesis unit comprises at least one released nucleic acid.
M14. The method according to any of the 2 preceding method embodiments, wherein the step of guiding released nucleic acids to the collection unit comprises the fluid supply unit providing a fluid to the synthesis unit.
M15. The method according to any of the preceding method embodiments and with the features of embodiment M2, wherein the step of collecting released nucleic acids comprises guiding a fluid comprising at least one released nucleic acid to a well of the well plate comprised by the collection unit.
M16. The method according to any of the preceding method embodiments, wherein the method further comprises post-processing of the synthesized nucleic acids.
M17. The method according to the preceding method embodiment, wherein the step of post-processing synthesized nucleic acids is performed in the collection unit.
M18. The method according to any of the 2 preceding method embodiments and with the features of embodiment M4, wherein the step of post-processing synthesized nucleic acids comprises cleaving nucleic acids off the respective synthesis support.
M19. The method according to the preceding method embodiment, wherein the step of cleaving nucleic acids off the respective synthesis support comprises the fluid supply unit providing a fluid to the collection unit.
M20. The method according to any of the 2 preceding method embodiments, wherein the step of cleaving nucleic acids off the respective synthesis support comprises the valve assembly assuming a configuration wherein a fluid from the fluid supply unit is guided to a selected well of the well plate comprised by the collection unit, without this fluid passing through the synthesis unit.
M21. The method according to any of the 2 preceding method embodiments, wherein the fluid provided by the fluid supply unit comprises at least one amine.
M22. The method according to the preceding method embodiment, wherein the fluid comprises an aqueous solution of methylamine and/or ammonium hydroxide.
M23. The method according to the penultimate method embodiment, wherein the fluid comprises a non-aqueous solution of methylamine and an organic solvent.
M24. The method according to the preceding method embodiment, wherein the organic solvent is ethanol.
M25. The method according to any of the preceding method embodiments and with the features of M18, wherein the step of cleaving nucleic acids off respective synthesis supports comprises a first step of applying a non-aqueous solution of methylamine and ethanol to cleave the nucleic acids off the synthesis support and a separate, second step of applying an aqueous solution to elute the nucleic acids.
M26. The method according to any of the preceding method embodiments and with the features of M18, wherein the method further comprises drying synthesis supports and attached nucleic acids in the collection unit prior to cleaving nucleic acids off the respective synthesis supports.
M27. The method according to any of the preceding method embodiments and with the features of M16, wherein the step of post-processing of the synthesized nucleic acids comprises removing protective groups from the nucleic acids.
M28. The method according to the preceding method embodiment, wherein the step of removing protective groups comprises the fluid supply unit providing a fluid to the collection unit.
M29. The method according to any of the 3 preceding method embodiments, wherein the step of removing protective groups comprises the valve assembly assuming a configuration wherein a fluid from the fluid supply unit is guided to a selected well of the well plate comprised by the collection unit, without this fluid passing through the synthesis unit.
M30. The method according to any of the preceding method embodiments and with the features of embodiments M18 and M27, wherein the step of removing protective groups is completed after the step of cleaving nucleic acids off the respective synthesis support.
M31. The method according to any of the preceding method embodiments and with the features of embodiments M18 and M27, wherein the step of cleaving nucleic acids off the respective synthesis support and the step of removing protective groups are simultaneously carried out in the same well of the well plate comprised by the collection unit.
M32. The method according to any of the preceding method embodiments, wherein the method comprises guiding two independent streams of fluid through the valve assembly at the same time, wherein the two fluid streams do not get into contact with each other.
M33. The method according to the preceding method embodiment, wherein the method comprises guiding a fluid from the synthesis unit to a well of the well plate of the collection unit and, at the same time, guiding a fluid from the fluid supply unit to another well of the well plate of the collection unit.
M34. The method according to any of the 2 preceding method embodiment and with the features of embodiments M2, M18 and M27, wherein the method further comprises performing at least one of the steps of
synthesising nucleic acids,
selectively releasing nucleic acids,
guiding released nucleic acids to the collection unit, and
collecting released nucleic acids in the well plate,
at the same time as at least one of the steps of
   cleaving nucleic acids off the respective synthesis support, and
   removing protective groups.
M35. The method according to any of the preceding method embodiments, wherein the method further comprises heating a content of wells of the well plate comprised by the collection unit.
M36. The method according to the preceding method embodiments, wherein the content of wells in the well plate comprises a fluid.
M37. The method according to any of the 2 preceding method embodiments, wherein the content of wells in the well plate comprises synthesis supports and attached nucleic acids.
M38. The method according to the preceding method embodiment and with the features of M18, the method further comprises heating of the synthesis supports and attached nucleic acids in the wells of the well plate comprised by the collection unit prior to cleaving nucleic acids off the respective synthesis support.
M39. The method according to any of the 4 preceding method embodiments, wherein the step of heating the content of wells of the well plate comprises controlling the temperature based on at least one temperature signal of a temperature sensor comprised by the collection unit.
M40. The method according to the preceding method embodiment, wherein the step of controlling the temperature comprises limiting the temperature to a maximum temperature threshold.
M41. The method according to any of the 2 preceding method embodiments, wherein the step of controlling the temperature comprises controlling the temperature to a desired temperature.
M42. The method according to any of the 7 preceding method embodiments, wherein the step of heating the content of in wells of the well plate comprises heating at least one element comprised by the collection unit.
M43. The method according to the preceding method embodiment, wherein the at least one heated element comprises an adapter plate comprised by the collection unit.
M44. The method according to any of the 2 preceding method embodiments, wherein the at least one heated element comprises a support element comprised by the collection unit.
M45. The method according to any of the preceding method embodiments, wherein the method further comprises the valve assembly assuming a configuration wherein at least one fluid stream is guided to a waste.
M46. The method according to any of the preceding method embodiments, wherein the method further comprises flushing at least a portion of the system.
M47. The method according to any of the preceding method embodiments, wherein the method further comprises backflushing at least a portion of the system.
M48. The method according to any of the preceding method embodiments, wherein the method further comprises the valve assembly assuming a configuration wherein a fluid is guided to the fluid supply unit.
M49. The method according to any of the preceding method embodiments, wherein the method further comprises the valve assembly assuming a configuration wherein a fluid is guided to the synthesis unit.
M50. The method according to the preceding method embodiment, wherein the synthesis system comprises the features of system embodiment S20, wherein the method comprises the purge valve assuming a configuration wherein a fluid from the synthesis unit is guided to waste.
M51. The method according to any of the preceding method embodiments, wherein the method comprises establishing a pressure drop across the fluidic parts of the system configured to establish a flow of fluid in a desired direction.
M52. The method according to any of the preceding method embodiments, wherein the nucleic acids synthesised are oligonucleotides.
M53. The method according to any of the preceding method embodiments and with the features of M16, wherein the step of post-processing of the synthesized nucleic acids comprises cleaving linker molecules off the nucleic acids.
M54. The method according to any of the preceding method embodiments and with the features of M2, wherein the method further comprises collecting fluids passing through the well plate and/or the support element in a waste bin comprised by the collection unit and guiding the collected fluids to waste.
M55. The method according to the preceding method embodiment, wherein the method comprises flushing the waste bin with a fluid.
M56. The method according to any of the preceding method embodiments, wherein the method comprises checking tightness of the collection unit prior to each synthesis run by means of a pressure sensor.
M57. The method according to any of the preceding method embodiments and with the features of M9, wherein the step of selectively releasing synthesis supports comprises providing a lifting fluid to the synthesis unit.
M58. The method according to the preceding method embodiment, wherein selectively releasing synthesis supports comprises applying an electric potential greater than 0 V, preferably greater than 2 V, more preferably greater than 4 V, most preferably greater than 8V across respective synthesis spots of the microfluidic chip.
M59. The method according to the preceding method embodiment, wherein applying the electric potential comprises applying a voltage and/or electric current to respective electrodes of the corresponding synthesis spots.
M60. The method according to any of the 2 preceding method embodiments, wherein a total electric current on the microfluidic chip is limited to a maximum current.
M61. The method according to the preceding method embodiment, wherein the total electric current on the microfluidic chip is limited by simultaneously applying the electric potential only across a subset of synthesis spots.
M62. The method according to any of the 2 preceding method embodiments, wherein the maximum current is at most 50 mA, preferably at most 5 mA.
M63. The method according to any of the preceding method embodiments, wherein the method further comprises a user replacing or inserting the microfluidic chip in the synthesis unit.
M64. The method according to any of the preceding method embodiments, wherein the method further comprises determining a desired process to be run on the system.
M65. The method according to the preceding method embodiment, wherein the desired process is determined by a user.
M66. The method according to any of the 2 preceding method embodiments, wherein the desired process comprises one or more of synthesising nucleic acids, releasing synthesis supports from the microfluidic chip, post-processing of the synthesized nucleic acids and cleaning the system.
M67. The method according to any of the preceding method embodiments, wherein the method further comprises checking system flow paths.
M68. The method according to any of the preceding method embodiments, wherein the method comprises scanning a code on the chip holder, the microfluidic chip and/or the well plate to retrieve respective information thereon.
M69. The method according to the preceding method embodiment, wherein the method further comprises automatically recalling relevant synthesis data for synthesising nucleic acids and/or lifting data for releasing synthesis supports from a data base based on the retrieved information and/or the desired process.
M70. The method according to any of the preceding method embodiments, wherein the method further comprises recalling relevant synthesis data for synthesising nucleic acids and/or lifting data for releasing synthesis supports from a data base based on a user input and/or the desired process.
M71. The method according to any of the 2 preceding method embodiments, wherein the method further comprises determining an expected reagent consumption for the reagents provided by the fluid supply system based on the synthesis data and/or lifting data.
M72. The method according to any of the preceding method embodiments, wherein the method comprises performing a pressure test for the tightness of the system.
M73. The method according to the preceding method embodiment, wherein the pressure test comprises pressurizing the system and monitoring the pressure over time to identify any unexpected pressure drop.
M74. The method according to any of the 2 preceding method embodiments, wherein the pressure test is performed separately for different portions of the system.
M75. The method according to any of the 3 preceding method embodiments, wherein the pressure test comprises testing all internal flow paths for leaks.
M76. The method according to any of the 4 preceding method embodiments, wherein the pressure test comprises testing the collection unit, the valve assembly, the distribution valve, the synthesis unit and/or the fluid supply system for leaks.
M77. The method according to any of the 5 preceding method embodiments, wherein the pressure test is performed automatically by the system.
M78. The method according to any of the preceding method embodiments, wherein the method comprises providing system information during the steps of synthesising nucleic acids, releasing synthesis supports from the microfluidic chip and post-processing of the synthesized nucleic acids.
M79. The method according to the preceding method embodiment, wherein providing system information comprises displaying system information.
M80. The method according to any of the 2 preceding method embodiments, wherein the system information comprises at least one runtime, wherein the at least one runtime comprises a runtime of system commands, a runtime of sub-cycles of a running process and/or an overall runtime.
M81. The method according to any of the 3 preceding method embodiments, wherein the system information comprises a status of the microfluidic chip.
M82. The method according to any of the 4 the preceding method embodiments, wherein the system information comprises information on wells of the microfluidic chip, which have been selected for a following step of synthesising nucleic acids od releasing synthesis supports.
M83. The method according to any of the 5 preceding method embodiments, wherein the system information comprises a status of the chip power supply connected to the microfluidic chip.
M84. The method according to any of the 6 preceding method embodiments, wherein the system information comprises sensor readings.
M85. The method according to any of the preceding method embodiments and with the features of embodiment M71, wherein the method comprises checking the reagent consumption against the expected reagent consumption.
M86. The method according to any of the preceding method embodiments, wherein the method comprises generating a final report comprising information on performed method steps.
M87. The method according to any of the preceding method embodiments, wherein the method comprises confirming sensor readings.
M88. The method according to any of the preceding method embodiments, wherein the method comprises performing a supply system pressure test, wherein the supply system pressure test comprises checking each individual reagent strand of the fluid supply system for leaks.
M89. The method according to the preceding method embodiment, wherein the method comprises monitoring the pressure within the strand over time to identify any unexpected pressure drop.
M90. The method according to any of the preceding method embodiments, wherein the method comprises cleaning fluid parts of the system.
M91. The method according to any of the preceding method embodiments, wherein the method comprises changing a fluid container of the fluid supply system.
M92. The method according to the preceding method embodiment, wherein changing a fluid container comprises installing a new fluid container comprising an amidite or a nucleobase powder in the system, and wherein the method further comprises mixing the powder with acetonitrile after the new fluid container in installed in the fluidic system.
M93. The method according to any of the preceding method embodiments, wherein the method comprises tracking events occurring during carrying out the method.
M94. The method according to any of the preceding method embodiments, wherein the method comprises automatically sending a message for specific predetermined events to a user or maintenance.
M95. The method according to any of the preceding method embodiments, wherein the method comprises adjusting one or more system parameters.
M96. The method according to the preceding method embodiment, wherein system parameters comprise controller parameters.
M97. The method according to any of the 2 preceding method embodiments, wherein system parameters comprise at least one of parameters relating to the valve assembly, the chip power supply, the microfluidic chip, the fluid supply system, the collection unit, and/or the distribution valve.
M98. The method according to any of the preceding method embodiments, wherein the method comprises managing user rights and information.
M99. The method according to the preceding method embodiment, wherein user information comprises a user password and user rights comprise rights to start different processes and method steps or change system parameters.
M100. The method according to any of the preceding method embodiments, wherein the method comprises saving and/or loading of parameter sets of the system.
M101. The method according to any of the preceding method embodiments, wherein the method comprises generating maintenance intervals for individual parts of the system.
M102. The method according to any of the preceding method embodiments, wherein the method comprises monitoring controller in- and outputs.
M103. The method according to any of the preceding method embodiments, wherein the method comprises transferring data between the system and an external data system.
M104. The method according to any of the preceding method embodiments, wherein the method comprises saving communication logs between the controller and system components, particularly the synthesis unit and/or the chip power supply.
M105. The method according to any of the preceding method embodiments, wherein the method comprises generating statistical data on the instrument live time.
M106. The method according to any of the receding method embodiments, wherein the method comprises sampling sensor measurements or system parameters to generate traces.
S43. The system according to any of the preceding system embodiments and with the features of system embodiment S27, wherein the controller is configured to control and/or perform at least one of the method steps according to the preceding method embodiments.

Below, reference will be made to processing method embodiments. These embodiments are abbreviated by the letter “P” followed by a number. Whenever reference is herein made to “process embodiments”, these embodiments are meant.
P1. A method comprising:
   (i) providing one or more nucleic acids attached to a solid support wherein the solid support is part of or positioned in a first compartment,
   (ii) adding a first solution comprising at least methylamine and an organic solvent to the first compartment to cleave the nucleic acids off the support, and
   (iii) adding a second solution comprising at least water to the first compartment to elute the nucleic acids into a second compartment.
P2. The method according to the preceding process embodiment, wherein the nucleic acids attached to the solid support are oligonucleotides.
P3. The method according to any of the preceding process embodiments, wherein the solid support comprises resin, controlled pore glass, beads, a membrane or a filter material.
P4. The method according to any of the preceding process embodiments, wherein the solid support comprises beads, wherein the beads have a size of between about 5 μm and about 100 μm and optionally, wherein between about 100 and about 3,000 or between about 300 and about 1,000 beads are located in a first compartment.
P5. The method according to any of the preceding process embodiments, wherein the first and/or second compartment comprises a well of a multiwell plate, a vessel, a column, a tube, or a spot on a microchip.
P6. The method according to any of the preceding process embodiments, wherein the first and/or second compartment comprises a volume of between about 100 and about 150 μl or between about 200 and about 400 μl.
P7. The method according to any of the preceding process embodiments, wherein the first compartment comprises a porous filter material configured to allow liquid in the first compartment to slowly pass through the pores of the filter material, optionally wherein the pores of the filter material have a size from about 0.05 μm to about 200 μm, preferably from about 0.1 μm to about 20 μm, and optionally wherein the filter material is formed of PEEK, PTFE, ethylene tetrafluoroethylene (ETFE), polypropylene (PP), polyethylene (PE) or glass fiber.
P8. The method according to any of the preceding process embodiments, wherein the first solution comprises a mixture of methylamine and organic solvent, optionally wherein the amount of methylamine in said solution is at least 15%, preferably at least 20%.
P9. The method according to any of the preceding process embodiments, wherein the organic solvent is selected from the group consisting of ethanol, methanol, acetonitrile and acetone.
P10. The method according to any of the preceding process embodiments, wherein the first solution comprises a mixture of 33% methylamine in ethanol.
P11. The method according to any of the preceding process embodiments, wherein the first solution does not comprise water.
P12. The method according to any of the preceding process embodiments, wherein the second solution comprises an aqueous buffer comprising at least 50% of water.
P13. The method according to any of the preceding process embodiments, wherein the second solution comprises a Tris buffer.
P14. The method according to any of the preceding process embodiments, wherein the pH of the first solution is within a range of 12 to 14.
P15. The method according to any of the preceding process embodiments, wherein the pH of the second solution is between 6.0 and 7.5.
P16. The method according to any of the preceding process embodiments, wherein step (i) further comprises providing two or more nucleic acids attached to a solid support, wherein the two or more nucleic acids have different sequences, and optionally wherein the two or more nucleic acids in the first compartment have complementary sequence regions.
P17. The method according to any of the preceding process embodiments, wherein step (i) further comprises sealing the first compartment as to generate a closed atmosphere in the first compartment.
P18. The method according to any of the preceding process embodiments, wherein step (ii) further comprises heating the first compartment to a temperature of at least about 40° C., at least about 50° C., at least about 65° C. or at least about 75° C., optionally wherein the heating is performed for at least about 60 min to about 360 min, preferably about 120 min to about 240 min, more preferably about 150 min to about 180 min.
P19. The method according to any of the preceding process embodiments, wherein step (iii) further comprises drying the nucleic acids eluted into the second compartment.
P20. The method according to any of the preceding process embodiments, wherein the method further comprises after step (ii) and prior to step (iii):
   (a) transferring the first compartment from a first area to a second area comprising the second compartment or
   (b) transferring the second compartment from a second area to a first area comprising the first compartment as to position the first and second compartments to allow elution of the oligonucleotides from the first into the second compartment.
P21. The method according to any of the preceding process embodiments, wherein the nucleic acids are between about 15 and about 200 bp in length.
P22. The method according to any of the preceding process embodiments, wherein the nucleic acids are derived from chemical, electrochemical, photochemical or enzymatic synthesis.
P23. The method according to any of the preceding process embodiments, wherein the nucleic acids are attached to the solid support by a linker.
P24. The method according to the preceding process embodiment, wherein the linker comprises a succinyl linker, optionally wherein the linker is a Unylinker.
P25. The method according to any of the preceding process embodiments, wherein the method comprises utilizing a synthesis system according to any of the preceding system embodiments.
M107. The method according to any of the preceding method embodiments, wherein the method comprises the processing method according to any of the preceding process embodiments.

Below, reference will be made to lifting fluid embodiments. These embodiments are abbreviated by the letter “L” followed by a number. Whenever reference is herein made to “fluid embodiments”, these embodiments are meant.
L1. Lifting fluid for releasing one or more synthesis supports, wherein the lifting fluid comprises water, at least one solvent and a salt.
L2. Lifting fluid according to the preceding fluid embodiment, wherein the salt has a concentration in the fluid in the range of 0.001 M to 5 M, preferably 0.005 M to 2 M. of 0.01 M, 0.05 M, 0.1 M, 0.25 M, 0.4 M, 0.5 M, 0.7 M, 0.8 M, 0.9 M or 1.0 M.
L3. Lifting fluid according to any of the 2 preceding fluid embodiments, wherein the salt is an organic salt.
L4. Lifting fluid according to the preceding fluid embodiment, wherein the salt is an ammonium salt.
L5. Lifting fluid according to any of fluid embodiments L1 and L2, wherein the salt is an inorganic salt.
L6. Lifting fluid according to the preceding fluid embodiment, wherein the salt is a lithium salt, such as LiClO₄.
L7. Lifting fluid according to any of the preceding fluid embodiments, wherein the at least one solvent is an organic solvent.
L8. Lifting fluid according to any of the preceding fluid embodiments, wherein the at least one solvent comprises acetonitrile and/or methanol.
L9. Lifting fluid according to any of the preceding fluid embodiments, wherein the at least one solvent comprises a mixture of acetonitrile and methanol.
L10. Lifting fluid according to any of the preceding fluid embodiments, wherein the lifting fluid comprises more than 50% solvent, preferably at least 60% solvent, more preferably at least 70% solvent, such as at least 80%, at least 90% or at least 95% solvent.
L11. Lifting fluid according to any of the preceding fluid embodiments, wherein the lifting fluid comprises less than 50% water, preferably up to 40% water, more preferably up to 30% water, such as up to 20%, up to 10%, up to 5%, up to 2% water.
L12. Lifting fluid according to any of the preceding fluid embodiments, wherein the lifting fluid comprises 0.05 M LiClO₄, 20% water and 80% methanol.
L13. Lifting fluid according to any of the preceding fluid embodiments and excluding the preceding fluid embodiment, wherein the lifting fluid comprises water, an ammonium salt, acetonitrile and methanol.
M108. The method according to any of the preceding method embodiments and with the features of M57, wherein the lifting fluid is a lifting fluid according to any of the preceding fluid embodiments.

Below, reference will be made to use embodiments. These embodiments are abbreviated by the letter “U” followed by a number. Whenever reference is herein made to “use embodiments”, these embodiments are meant.
U1. Use of the synthesis system according to any of the preceding system embodiments for synthesis of nucleic acids.
U2. Use according to the preceding use embodiment, wherein the use comprises use of the synthesis system for synthesis of oligonucleotides.
U3. Use of the synthesis system according to any of the preceding system embodiments for carrying out the method according to any of the preceding method embodiments or the processing method according to any of the preceding process embodiments.
U4. Use of the lifting fluid according to any of the preceding fluid embodiments for lifting synthesis supports in the synthesis system according to any of the preceding system embodiments and/or within the chip holder according to any of the preceding chip holder embodiments.

Below, reference will be made to computer program product embodiments. These embodiments are abbreviated by the letter “B” followed by a number. Whenever reference is herein made to “program embodiments”, these embodiments are meant.
B1. Computer program product comprising instructions which, when the program is executed by a processor comprised by the system according to any of the preceding system embodiments, cause the system to carry out the method according to any of the preceding method embodiments.
B2. Computer program product according to the preceding embodiment, wherein the computer program product comprises instructions for a synthesis module for a user guided synthesis procedure for starting a nucleic acid synthesis, which, when the module is executed by a processor, cause the processor to carry out one or more of the following steps:
   enable the user to choose a desired process,
   check flow paths,
   enable the user to scan a code on the chip holder, the microfluidic chip and/or the well plate to retrieve respective information thereon and automatically recalling relevant synthesis data for synthesising nucleic acids and/or lifting data for releasing synthesis supports from a data base based on the retrieved information and/or the desired process,
   determining an expected reagent consumption,
   performing a pressure test to the tightness of the system,
   displaying system information to the user,
   confirming sensor readings,
   checking the reagent consumption, and
   generating a final report.
B3. Computer program product according to any of the preceding program embodiments, wherein the computer program product comprises instructions for a supply system pressure test module, which, when the module is executed by a processor, cause the processor to carry out the step of checking each individual reagent strand of the fluid supply system for leaks.
B4. Computer program product according to any of the preceding embodiments, wherein the computer program product comprises instructions for a system pressure test module, which, when the module is executed by a processor, cause the processor to carry out the step of checking each internal flow path separately for leaks.
B5. Computer program product according to any of the preceding program embodiments, wherein the computer program product comprises instructions for a system clean module, which, when the module is executed by a processor, cause the processor to carry out the step of cleaning fluid parts of the system, preferably all fluid parts of the system.
B6. Computer program product according to any of the preceding program embodiments, wherein the computer program product comprises instructions for a fluid container change module, which, when the module is executed by a processor, cause the processor to carry out the step of supporting a user during a change of a fluid container, particularly a fluid container comprising amidites or nucleobases.
B7. Computer program product according to the preceding program embodiments, wherein the step of supporting a user during a change of a fluid container comprising amidites or nucleobases comprises providing acetonitrile to the fluid container after it is placed in the fluid supply system.
B8. Computer program product according to any of the preceding program embodiments, wherein the computer program product comprises instructions for an event handling module, which, when the module is executed by a processor, cause the processor to carry out the steps of:
   tracking events, wherein events comprise normal events, warning events and error events, and
   automatically sending messages to a user or maintenance for predetermined events.
B9. Computer program product according to any of the preceding program embodiments, wherein the computer program product comprises instructions for a user management module, which, when the module is executed by a processor, cause the processor to carry out the step of providing the user with an interface for adjusting user rights and/or information.
B10. Computer program product according to any of the preceding program embodiments, wherein the computer program product comprises instructions for a backup module, which, when the module is executed by a processor, cause the processor to carry out the step of enabling loading and saving of one or more parameter sets.
B11. Computer program product according to any of the preceding program embodiments, wherein the computer program product comprises instructions for a parameter module, which, when the module is executed by a processor, cause the processor to carry out the step of providing the user with an interface for adjusting system parameters.
B12. Computer program product according to any of the preceding program embodiments, wherein the computer program product comprises instructions for a non-automatic operation module, which, when the module is executed by a processor, cause the processor to carry out the step of providing the user with an interface for a non-automatic interaction with the system.
B13. Computer program product according to the preceding program embodiments, wherein the non-automatic interaction with the system comprises at least one of:
   interaction with the microfluidic chip,
   interaction with the chip power supply,
   checking connection to HTTP or email systems, signal lights or relay outputs,
   checking the fluid supply system,
   switching valves,
   accessing valves, pressure sensor and/or level sensor associated with the waste,
   interacting with the barcode scanner, and
   accessing heaters and temperature sensors of the collection unit.
B14. Computer program product according to any of the preceding program embodiments, wherein the computer program product comprises instructions for a log module, which, when the module is executed by a processor, cause the processor to carry out the step of providing an individual log system to generate maintenance for components of the system, preferably for all components of the system.
B15. Computer program product according to any of the preceding program embodiments, wherein the computer program product comprises instructions for a monitoring module, which, when the module is executed by a processor, cause the processor to carry out the step of providing the user with an interface for monitoring the controller and/or controller in- and outputs.
B16. Computer program product according to any of the preceding program embodiments, wherein the computer program product comprises instructions for a data module, which, when the module is executed by a processor, cause the processor to carry out the step of providing the user with an interface for transferring data between the system and an external data system.
B17. Computer program product according to any of the preceding program embodiments, wherein the computer program product comprises instructions for a report module, which, when the module is executed by a processor, cause the processor to carry out the step of creating a report at the end of a process.
B18. Computer program product according to any of the preceding embodiments, wherein the computer program product comprises instructions for a diagnosis module, which, when the module is executed by a processor, cause the processor to carry out the steps of
   saving communications between the controller and the microfluidic chip,
   saving communications between the controller and the chip power supply, and
   enabling the user to view said communications.
B19. Computer program product according to any of the preceding program embodiments, wherein the computer program product comprises instructions for a diagnosis module, which, when the module is executed by a processor, cause the processor to carry out the steps of creating statistics data over the system life time.
B20. Computer program product according to any of the preceding program embodiments, wherein the computer program product comprises instructions for a statistics module, which, when the module is executed by a processor, cause the processor to carry out the steps of creating statistics data over the system life time.
B21. Computer program product according to any of the preceding program embodiments, wherein the computer program product comprises instructions for a sampling module, which, when the module is executed by a processor, causes the processor to carry out the steps of
   sampling sensor measurements or system parameters, and
   generating a trace of the sampled data.

Embodiments of the present invention will now be described with reference to the accompanying drawings. These embodiments should only exemplify, but not limit, the present invention.

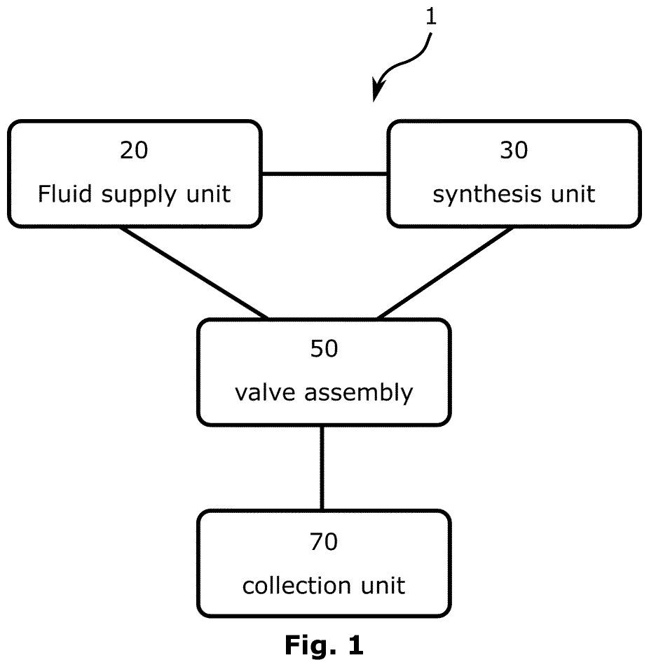

FIG. 1 schematically depicts a synthesiser system for providing a collection of designated oligonucleotides; depicts an exemplary embodiment of a fluid supply unit;

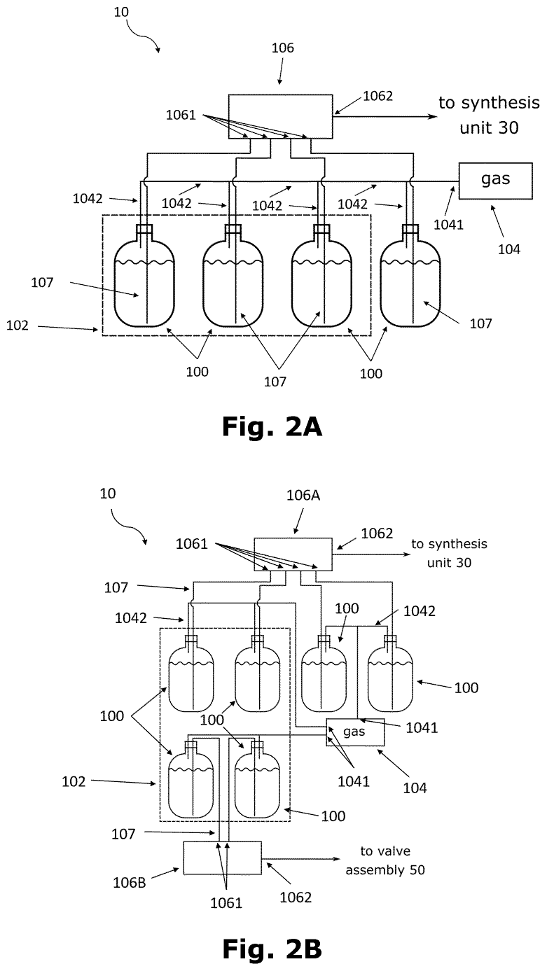

FIG. 2A depicts a further exemplary embodiment of the fluid supply unit;

FIG. 2B depicts an exemplary embodiment of a chip holder in an open configuration;

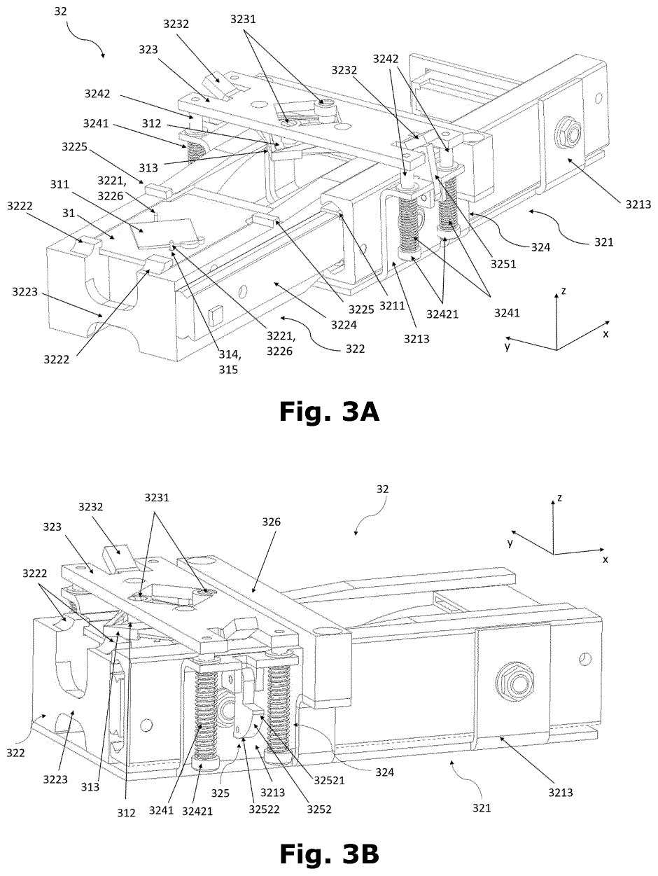

FIG. 3A depicts an exemplary embodiment of a chip holder in a closed configuration;

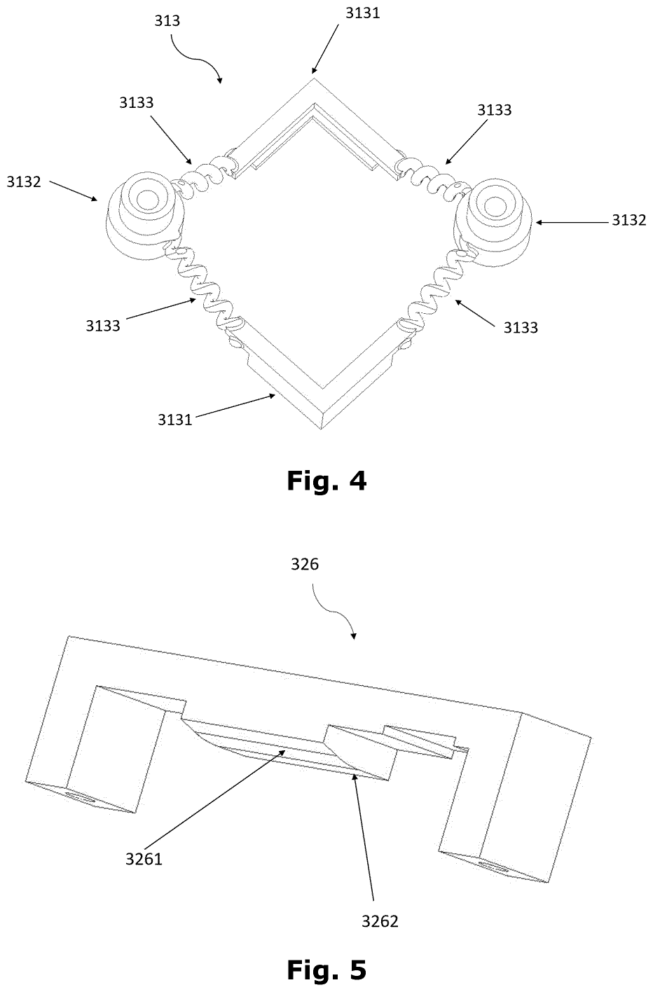

FIG. 4 depicts an exemplary embodiment of a cover mount;

FIG. 5 depicts an exemplary embodiment of a restriction element;

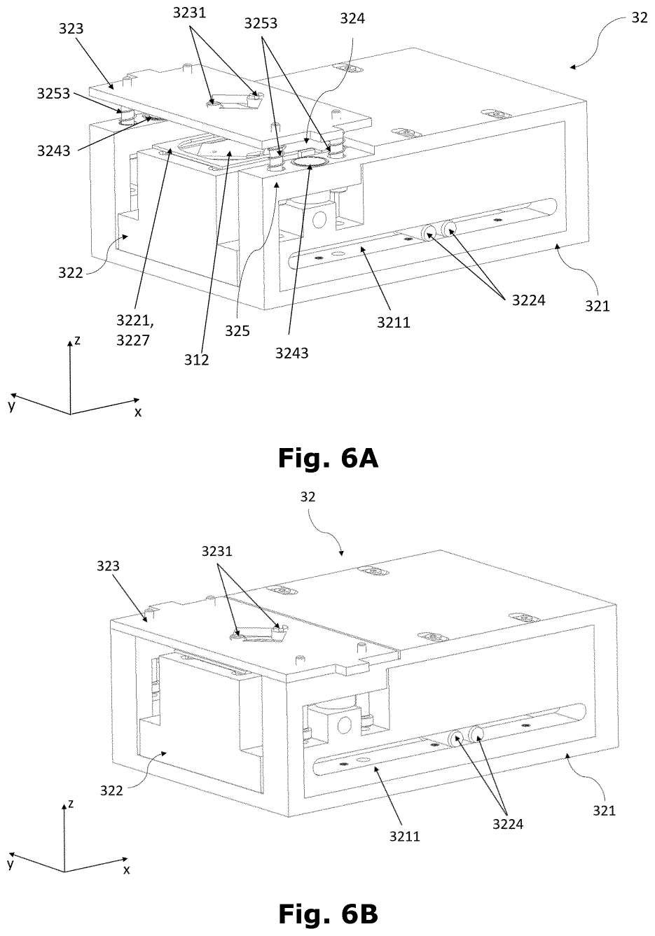

FIG. 6A depicts a further exemplary embodiment of a chip holder with a sealing mechanism in a non-engaged state;

FIG. 6B depicts a further exemplary embodiment of a chip holder with the sealing mechanism in an engaged state;

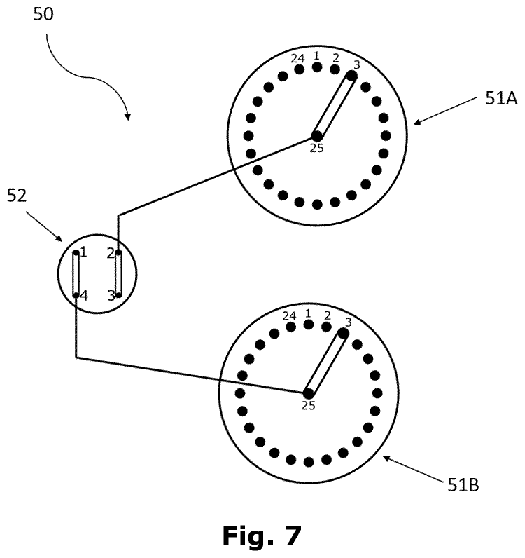

FIG. 7 schematically depicts an exemplary embodiment of a valve assembly;

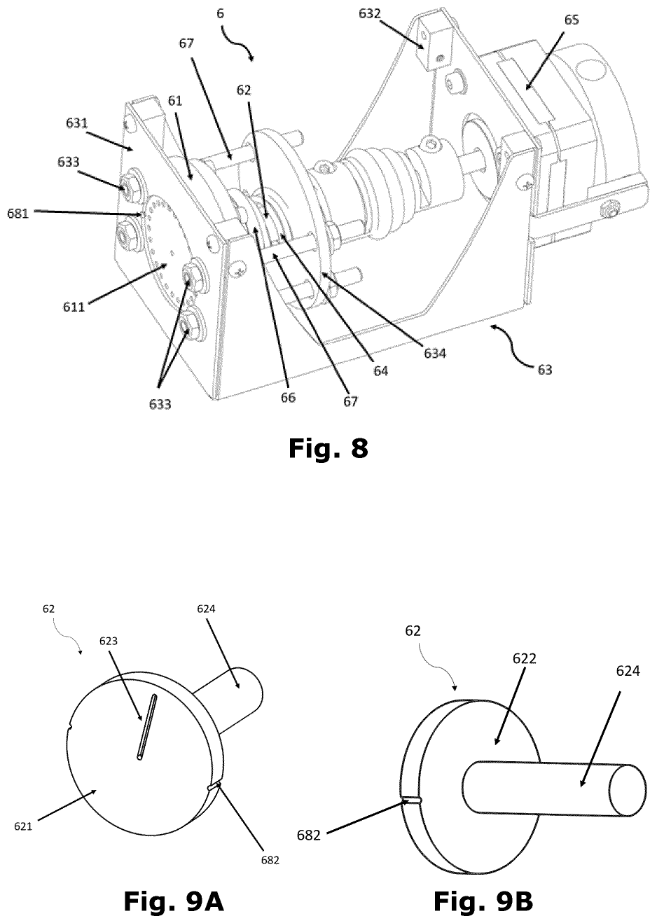

FIG. 8 depicts an exemplary embodiment of a rotary valve;

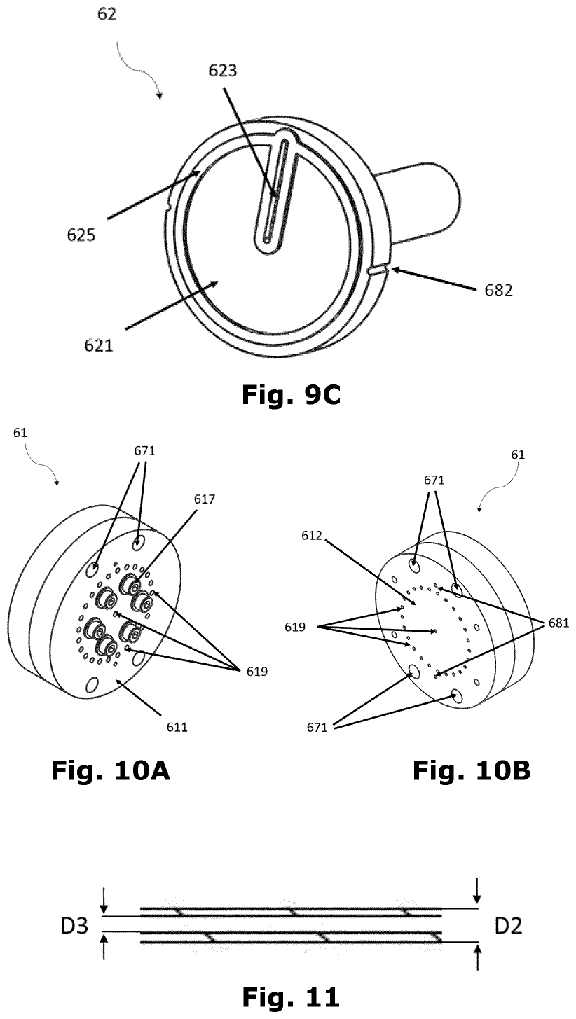

FIG. 9A depicts an exemplary embodiment of a rotor from a first perspective;

FIG. 9B depicts the exemplary embodiment of the rotor from a second perspective;

FIG. 9C depicts an exemplary embodiment of a rotor comprising a sealing lip;

FIG. 10A depicts a first exemplary embodiment of a stator from a first perspective;

FIG. 10B depicts the first exemplary embodiment of the stator from a second perspective;

FIG. 11 depicts a section of a tube along its axis;

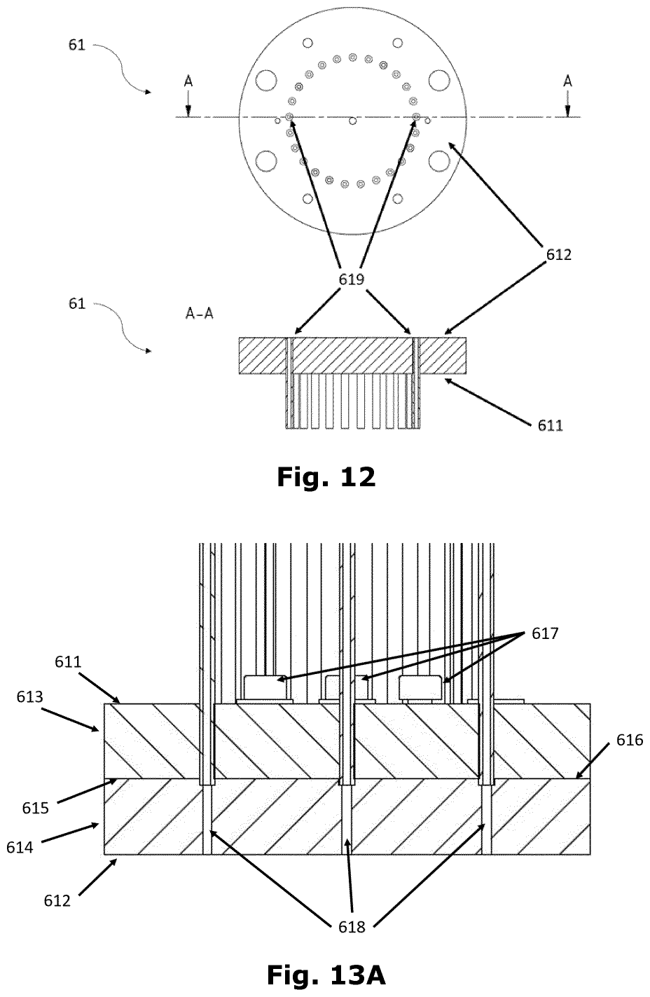

FIG. 12 depicts a second exemplary embodiment of a stator including a cross-sectional view;

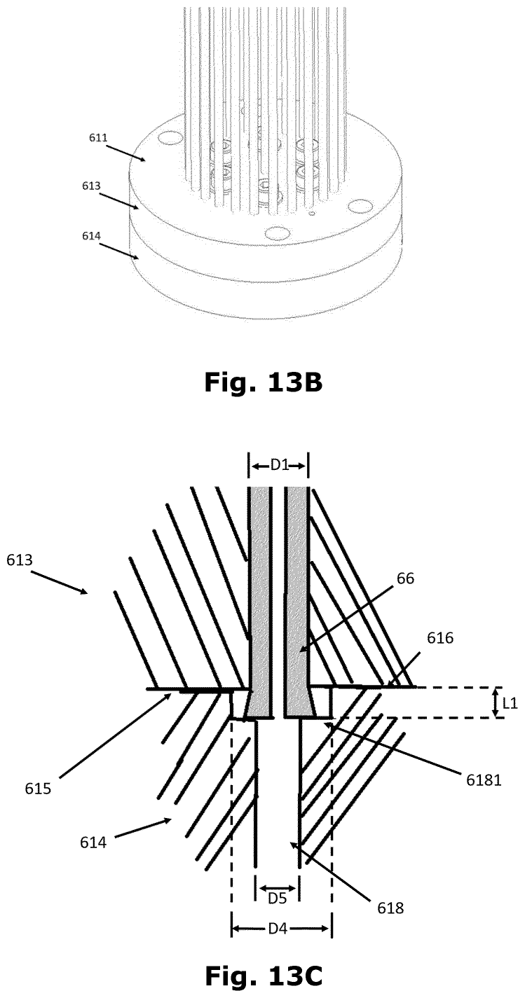

FIG. 13A depicts a cross-sectional view of the first exemplary embodiment of a stator;

FIG. 13B depicts the first exemplary embodiment of a stator with fitted tubes;

FIG. 13C depicts a detailed cross-sectional view of the first exemplary embodiment of a stator;

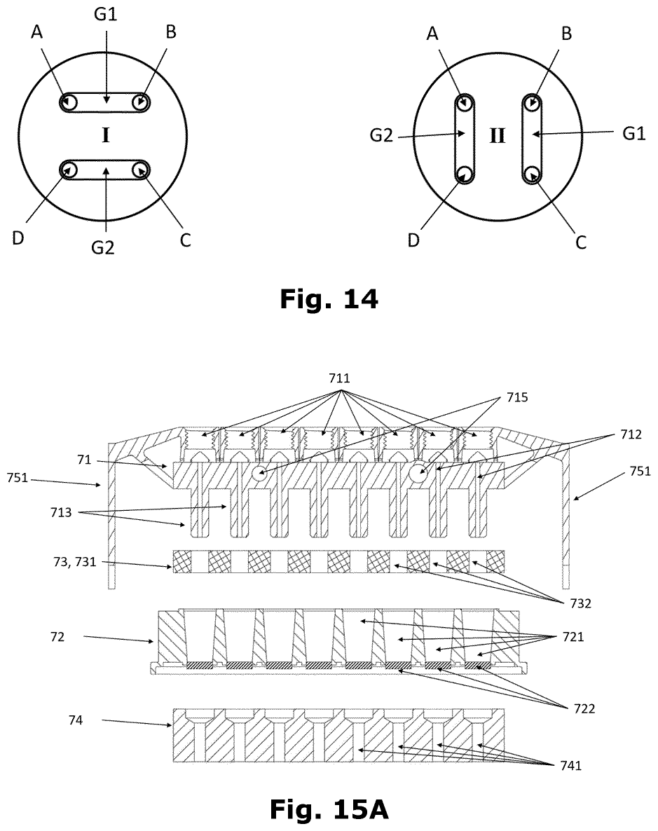

FIG. 14 depicts an exemplary arrangement of valve connections and grooves of a rotary valve;

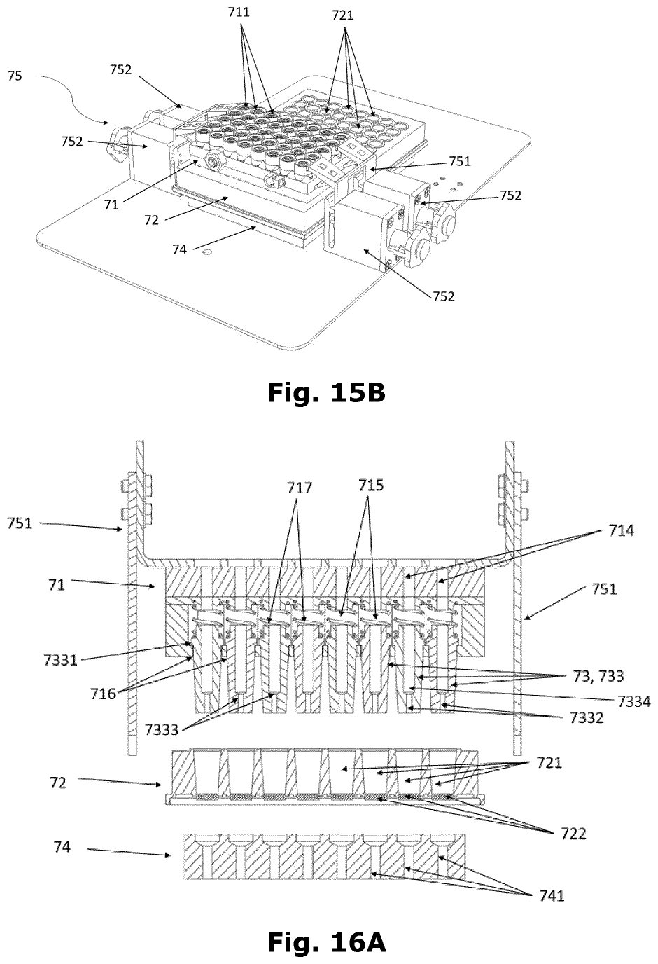

FIG. 15A depicts a cross-sectional view of a first exemplary embodiment of a collection unit in an exploded view;

FIG. 15B depicts the first exemplary embodiment of a collection unit in an assembled state;

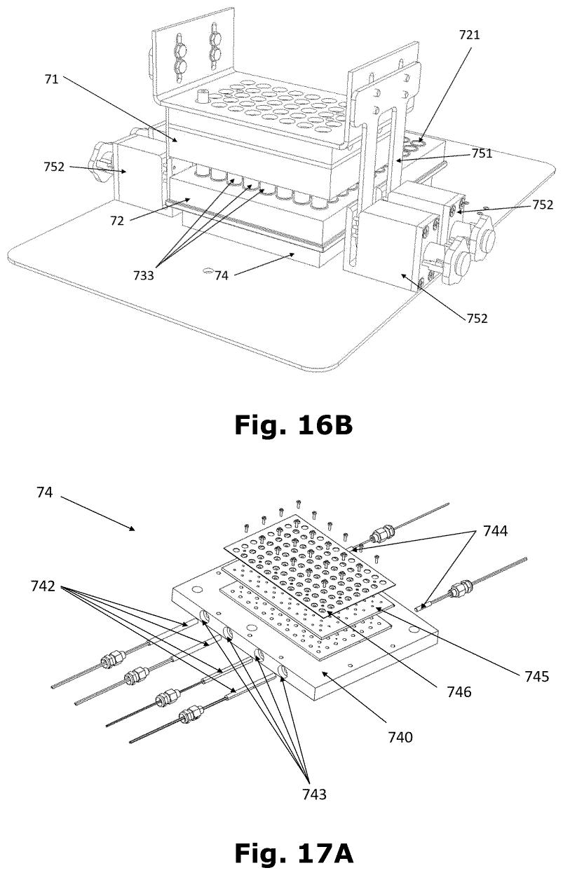

FIG. 16A depicts a cross-sectional view of a second exemplary embodiment of a collection unit in an exploded view;

FIG. 16B depicts the second exemplary embodiment of a collection unit in an assembled state;

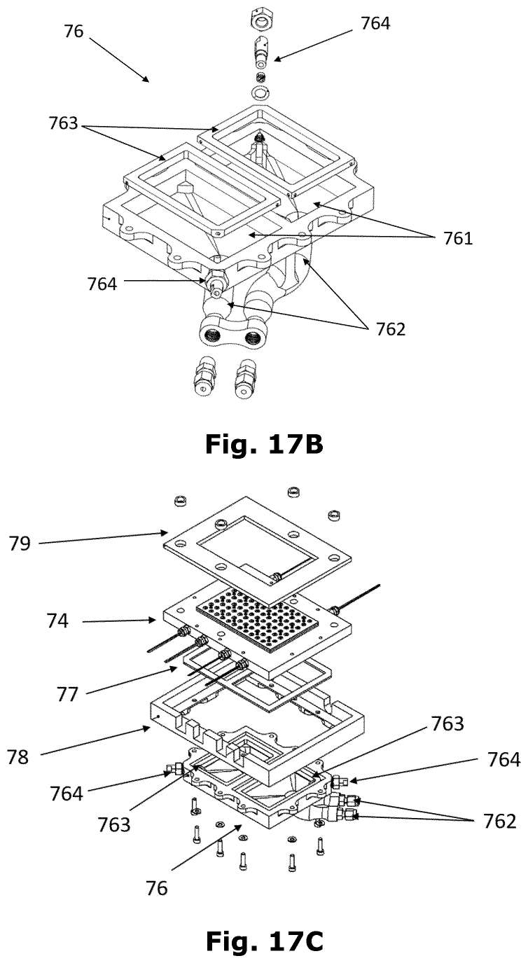

FIG. 17A depicts an exemplary embodiment of a collection unit;

FIG. 17C depicts an exemplary embodiment of a waste bin;

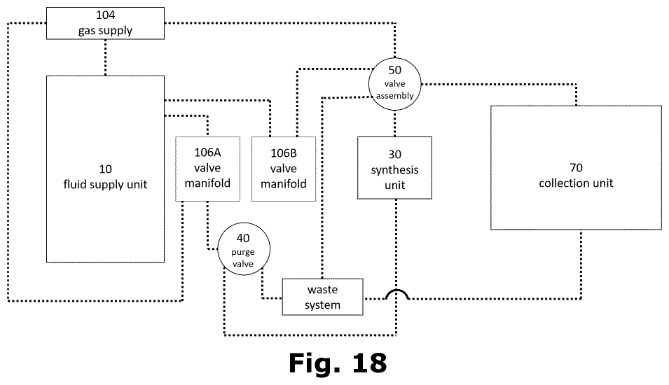

FIG. 18 depicts an exemplary embodiment of a collection unit and a waste bin; and depicts an exemplary schematic of a synthesiser system.

It is noted that not all the drawings carry all the reference signs. Instead, in some of the drawings, some of the reference signs have been omitted for the sake of brevity and simplicity of the illustration. Embodiments of the present invention will now be described with reference to the accompanying drawings.

FIG. 1 schematically depicts a synthesiser system 1, also referred to as system 1, for providing a collection of designated oligonucleotides, wherein the system 1 comprises a fluid supply unit 10, a synthesis unit 30, a valve assembly 50 and a collection unit 70.

Very generally, the fluid supply unit 10 may supply fluids to the synthesis unit 30 and/or the valve assembly 50. For example, the fluid supply unit 10 may comprise fluids (e.g. reagents) required for one or more of synthesizing oligonucleotides, pooling oligonucleotides, washing synthesis products or intermediates, post processing steps etc. Particularly, it may, amongst other fluids, provide the nucleobases cytosine, guanine, adenine, thymine, and/or uracil. In addition, it may provide reagents for processing and/or washing oligonucleotides such as acetonitrile, activator, oxidizer and capping solutions etc.

It will be understood, that throughout this application a fluid may denote a gas or a liquid. That is, whenever the term fluid is used it may refer to a liquid, e.g. water or acetonitrile, or a gas, e.g. argon.

The synthesis unit 30 may generally be configured to selectively synthesise and/or release oligonucleotides (optionally coupled to beads). That is, the synthesis unit 30 may be configured to selectively synthesise a plurality of different oligonucleotides, wherein the different oligonucleotides may be spatially separated. Furthermore, the synthesis unit 30 may be configured to deterministically release oligonucleotides, e.g. the synthesised and spatially separated oligonucleotides may be individually and selectively released by the synthesis unit 30, for example, by selective release of individual beads to which the oligonucleotides are attached.

The valve assembly 50 may comprise at least one or a plurality of valves, e.g. multiport valves such as rotary valves, for directing a fluid to a plurality of connected fluid conduits, such as capillaries or tubes. In particular, the valve assembly 50 may be configured to direct a fluid from the fluid supply unit 10 to the synthesis unit 30 and from synthesis unit 30 to any of a plurality of fluidic connections of the collection unit 70. In addition, the valve assembly 50 may be configured to direct a fluid from the fluid supply unit 10 directly to the collection unit 70 or to waste (not shown) or may be configured to direct a fluid from the fluid supply unit 10 to the synthesis unit 30 and from synthesis unit 30 to waste (not shown). In some aspects, the fluid may contain one or more beads.

During operation, the synthesis unit 30 may be utilized to synthesise a plurality of different oligonucleotides, which may include providing fluids through the fluid supply unit 10 to the synthesis unit 30. Subsequently, desired oligonucleotides may be released by the synthesis unit 30 and flushed to the valve assembly 50 from where they may be directed to the collection unit 70. In the collection unit 70 a predetermined accumulation of oligonucleotides may for example be collected and provided for further use, e.g. to synthesise a larger nucleic acid such as a gene by combining the oligonucleotides, for example through enzymatic assembly.

Furthermore, chemical treatment of the oligonucleotides may be performed within the collection unit 70 to prepare the oligonucleotides for further use. For example, within the synthesis unit 30, the oligonucleotides may typically be synthesised on a solid support, such as the surface of a bead, i.e. the oligonucleotides may be attached to beads. In the collection unit 70 collected beads carrying oligonucleotides may be washed and optionally dried to remove water. Furthermore, connections between oligonucleotides and beads may be destroyed, i.e. the connection between the oligonucleotides and the respective bead may be cleaved. Further, any protection groups attached to the oligonucleotides may be removed, i.e. the oligonucleotides may be deprotected, which may be advantageous for further processing, e.g. combining a plurality of oligonucleotides to form a larger structure, e.g. a gene. In some instances, cleaved oligonucleotides may be eluted into collection vessels or multiwell plates and optionally dried (e.g. lyophilized).

With reference to FIG. 2A an exemplary embodiment of a fluid supply unit 10 is described. A fluid supply unit 10 may comprise a plurality of fluids, each stored in a separate fluid container 100, e.g. a glass bottle 100. Each fluid container 100 may be sealed in a fluid-tight manner, i.e. no (or only a negligible amount of) fluid and in particular no gas may leak out of the fluid container 100 other than through designated fluid conduits.

Each fluid container 100 may further be connected to a gas supply 104, wherein the connection may be established via a fluidic connection connecting each fluid container 100 to a gas outlet 1041 of the gas supply 104. The fluidic connection may be referred to as gas conduit 1042 and may for example be a gas tight tubing, such as a polymer tubing. Typically, within the fluid container 100 the gas conduit 1042 connecting the fluid container 100 to the gas supply 104 may end within the upper third of the interior volume of the fluid container 100, e.g. within the bottleneck in case the fluid container 100 comprises the shape of a bottle. In particular, if the fluid container 100 comprises a liquid, the gas conduit 1042 may typically end above the level of the fluid such that the fluid connection to the gas supply 104 may not get into contact with the liquid comprised by (e.g. contained in) the fluid container 100. This may advantageously prevent contamination of the gas carrying fluidic system, which may for example be connected to a plurality of different fluid containers 100 comprising different fluids, e.g. liquids. Further, if the gas would stream directly into a liquid, i.e. if the gas conduit 1042 establishing the fluidic connection between the gas supply 104 and the fluid container 100 may reach into a liquid comprised by the fluid container 100, it may create bubbles which may disturb the liquid.

Furthermore, each fluid container 100 may be fluidly connected to a valve manifold 106 (also referred to as manifold 106) and/or to the valve assembly 50 (see FIG. 1), wherein each fluid container 100 may be connected to a separate inlet 1061 of the valve manifold 106. The valve manifold 106 may selectively couple any of the inlets 1061 to an outlet 1062. For example, the valve manifold 106 may comprise a coupling valve for each inlet 1061 and the outlet of each coupling valve may be fluidly combined into a single outlet 1062. In some instances connectors such as T- or Y-pieces may be utilized to fluidly combine the coupling valves into a single outlet. In other instances a recessed block comprising respective flow paths may be utilized. In yet other instances, a block comprising respective flow paths may be manufactured using 3D printing technology. Alternatively, the valve manifold 106 may for example also be realised utilizing a rotary valve which selectively connects one of the inlets 1061 to the outlet 1062. Thus, in some embodiments the valve manifold 106 may be configured to selectively couple only a single inlet 1061 to the outlet 1062, while in other embodiments the valve manifold 106 may be configured such that it can further couple a plurality of inlets 1061 to the outlet 1062 at the same time. Preferably, the outlet 1062 may be fluidly connected to the synthesis unit 30.

It will be understood that while throughout the description the terms “inlet” and “outlet” are used to denote valve ports, e.g. ports of the coupling valves and the valve manifold, also a reverse flow through these valves can be realised. That is, the terms “inlet” and “outlet” may not limit the direction of flow through a valve to a flow from the inlet to the outlet, but may merely indicate a preferred flow direction (e.g., during standard operation of the system), while still allowing for a reversed flow. Reversing the flow may for example be advantageous for purging parts of the system. For example, while the standard (or “preferred”) flow direction for a fluid may be from the respective fluid container 100 to an inlet 1061 of the valve manifold 106 and subsequently from the outlet 1062 of the valve manifold 106 to the synthesis unit 30 or the valve assembly 50, it may also be possible to purge the valve manifold 106 and connected fluid conduits by establishing a reverse flow, i.e. a flow into the outlet 1062 of the valve manifold 106 and out of an inlet 1061.

The fluidic connection that connects the fluid container 100 to the valve manifold 106 may be referred to as fluid conduit 107 and may typically be configured to end close to or at the bottom, i.e. the lowest point, of the fluid container 100. For example, if the fluid in the fluid container 100 is a liquid, the fluid conduit 107 may reach significantly below the level of the fluid within the fluid container 100.

This way, the fluid container 100 may be pressurized by a gas (e.g. argon or N₂), supplied by the gas supply 104, such that a fluid may flow to the valve manifold 106 provided the respective inlet 1061 is connected to the outlet 1062. Generally, the flow of a fluid through the fluid connection to the valve manifold 106 (i.e. the fluid conduit 107) and beyond, i.e. further downstream, may be realized by means of a pressure difference across the system 1.

In particular, the gas supply 104 may be configured to keep the pressure in each fluid container 100 at a substantially constant level of pressure, for example at a value in the range of 0 bar to 3 bar above atmospheric pressure, preferably in the range of 0.1 bar to 2 bar above atmospheric pressure, more preferably in the range of 0.2 to 1 bar, such as 0.35 bar above atmospheric pressure. Generally, pressure values throughout this application are given relative to atmospheric pressure, i.e. the atmospheric pressure surrounding the synthesiser system and/or described components thereof. The typical atmospheric pressure may be at approximately 1 bar, however, it may significantly deviate, e.g. depending on altitude and/or surrounding environment, e.g. a pressurized working environment. Here the term “substantially” serves to include small deviations which may for example occur due to technical limitations, e.g. uncertainty of pressure sensors, and/or small sudden changes of the pressure, e.g. when a fluid container 100 is fluidly connected to the outlet of the valve manifold 106, which may lead to small, short-time pressure fluctuations within the fluid container 100.

Thus, if the pressure experiences a pressure drop across the fluidic system, i.e. the fluidic part of the synthesis system 1, a flow of fluid may be established. In particular, if a fluid container 100 comprising a liquid is pressurized with a gas (e.g. argon or N₂), and if the fluid conduit 107 reaches below the surface of the liquid in the fluid container 100, the liquid may be pressed into the fluid conduit 107 and a flow may be established once the valve manifold 106 establishes a fluidic connection between the corresponding inlet 1061 and the outlet 1062 and a pressure drop across the fluidic system is present.

A pressure drop across the fluidic system may for example be established if an outlet of the system is at atmospheric pressure, e.g. a fluid conduit leading in a vented waste container. Alternatively, an outlet may be fluidly connected to a waste, e.g. a waste container, comprising an interior volume that may extend to equalise the pressure within the waste to the surrounding pressure, e.g. atmospheric pressure. For example, the pressure of a fluid entering a waste container may inflate the waste container, which may for example be a bellows container. This may be advantageous as the waste would not be required to be vented and thus gases forming in the waste, e.g. due to evaporating liquids, may be contained. That is, such a waste container, e.g. a bellows container, may allow to establish a pressure drop across the fluidic system while providing a sealed waste, which may advantageously contain any fluids and in particular gases.

Thus, the fluid supply unit 10 may comprise a plurality of fluid containers 100, wherein each fluid container may comprise two fluidic connections established via fluid conduits such as tubes, capillaries or pipes. One of said fluidic connections may connect each fluid container 100 to a gas supply 104, i.e. a gas conduit 1042, and the other fluidic connection may connect each fluid container 100 to a separate inlet 1061 of the valve manifold 106, i.e. a fluid conduit 107. The valve manifold 106 may selectively couple one, or a plurality of inlets 1061 to the outlet 1062, e.g. to provide a respective fluid or mixture of fluids or reagents to the synthesis unit 30. Thus, by pressurizing the fluid containers 100 with a gas (e.g. argon or N₂), provided through the gas conduit 1042 by the gas supply 104, a flow of the fluid comprised by a fluid container 100 may be established once the respective fluid conduit 107 experiences a pressure drop across the fluid conduit 107, i.e. between the end within the fluid container 100 and the end connected to the valve manifold 106.

Utilizing argon as the gas to pressurize the fluid containers 100 may be advantageous as it is a noble gas and thus chemically inert. Furthermore, it is non-toxic and naturally occurring, which may be advantageous e.g. in case of a leak of a gas conduit 1042. Alternatively, other inert gases such as N₂ can be used.

In some embodiments at least one or a plurality of fluid containers 100 may be placed inside a safety housing 102. That is, the safety housing 102 may surround, e.g. encase, at least a subset of the fluid containers 100. As discussed, the fluid containers 100 may be pressurized with gas to a pressure above atmospheric pressure. In other words, a pressure difference may be established between the inside of a fluid container 100 and the surrounding, i.e. the outside. That is, the pressure inside a fluid container 100 may at least during operation of the synthesis system 1 be above atmospheric pressure, which may typically surround the fluid containers.

In case a fluid container 100 is damaged or breaks during operation, which may typically happen suddenly and unexpectedly, the safety housing 102 may advantageously limit the damage due to a breaking fluid container 100. For example, it may prevent any spillage of a fluid beyond the safety housing 102. In other words, it may contain a spillage and prevent it from leaking out into a potentially uncontrolled environment. The safety housing 102 may for example comprise a tray in which the fluid containers may be placed and which may be configured to contain any liquid leaking out of a fluid container 100. In some embodiments, the safety housing 102 may generally be fluid tight, that is, it may particularly also contain any fluid leaking out of a fluid container 100. The safety housing may further be fitted with a ventilation, e.g. a ventilation guiding excessive gas safely to a corresponding exhaust. This may particularly be advantageous to prevent the built up of an excess pressure within a fluid tight safety housing. However, ventilation may also simply be realised through at least one opening in the safety housing, which may allow any excessive gas to leak out into the surrounding atmosphere and thus prevent any built up of excessive pressure. That is, in some embodiments, the safety housing 102 may not be fluid tight, instead it may be configured to allow gas to leak out of the safety housing into the surrounding atmosphere. Generally, any ventilation may preferably be located in an upper part of the safety housing 102 to prevent any liquid leaking through respective ventilation openings. In other words, it may for example be designed to contain spilled liquids without containing gases, such that no excess pressure may built up inside the safety housing 102. Thus, the safety housing 102 may protect the surrounding environment and in particular human workers, from getting into contact with a liquid and/or gas leaking out of a fluid container 100.

Moreover, due to the pressure difference a broken fluid container 100 may burst and fragments of the fluid container 100 may for example be accelerated and fly in an arbitrary direction due to the energy released by the bursting fluid container 100. The safety housing 102 may thus for example also be configured to prevent any fragments from damaging surrounding equipment and/or humans by ensuring that the fragments are contained within the safety housing 102. That is, the safety housing 102 may for example be configured to withstand the impact of fragments of a bursting or exploding fluid container 100. Furthermore, the safety housing 102 may be configured to withstand the pressure surge due to an exploding and/or bursting fluid container 100.

Safety housing 102 may be formed of any suitable material such as for example, polycarbonate (PC), poly(methyl methacrylate) (PMMA; also known as acrylic, acrylic glass, or plexiglass), polyvinyl chloride (PVC) or glass. In some instances, safety housing 102 may be formed of transparent material.

In some embodiments the safety housing 102 may comprise a control mechanism to ensure that it may only be opened when the fluid containers 100 have been depressurized, i.e., when there is no pressure difference between the inside and the outside of the fluid containers 100. This may for example be realized by stopping a flow of gas through the respective gas conduit 1042 and venting the respective gas conduit 1042 to the surrounding atmosphere, e.g. by means of a valve. That is, the safety housing 102 may be fitted with a control mechanism that indicates if any fluid container 100 is pressurized or if all fluid containers 100 are at atmospheric pressure. For example, the control mechanism may have access to pressure readings of respective pressure sensors, which may for example be comprised by the gas supply 104 or placed within the at least one gas supply branch. In some embodiments, the control mechanism may ensure that the safety housing 102 can only be opened, when all fluid containers are depressurized, i.e. when all fluid containers 100 are at atmospheric pressure. The control mechanism may for example comprise a locking mechanism for the safety housing, which may only unlock once the fluid containers 100 within the safety housing 102 are depressurized. Alternatively, the control mechanism may for example comprise an indicator, which may indicate if the fluid containers are depressurized and/or pressurized. For example, the indicator may be a light that is on when at least one fluid container 100 within the safety housing 102 is pressurized, or a light that is on when all fluid containers 100 in the safety housing 102 are successfully depressurized. Similarly, the indicator may comprise two lamps to indicate both of the aforementioned states or for example a single lamp which may change colour depending on the pressurization state of the fluid containers 100 of the safety housing 102.

Furthermore, with reference to FIG. 2B, the gas supply 104 may comprise a plurality of gas outlets 1041 such that a plurality of gas supply branches may be realized, wherein each gas supply branch may be connected to a subset of the fluid containers 100 via corresponding gas conduits 1042. That is, each gas supply branch may provide a subset of the fluid containers 100 with gas from a respective outlet 1041 of the gas supply 104. This may be advantageous, as it may allow to apply different gas pressures to different subsets of fluid containers 100 and/or to only depressurize a subset of the fluid containers 100, e.g. by only venting one gas supply branch, e.g. to the surrounding atmosphere. Thus, for example, different pressure differences may be achieved, which may in turn result in different flow rates of the fluids comprised in the fluid containers 100. Furthermore, a plurality of gas supply branches may also be advantageous for exchanging a fluid container 100, which requires to depressurize said fluid container 100. That is, due to the plurality of gas supply branches, only the supply branch fluidly connected to the fluid container 100 to be exchanged requires depressurization, which may protect fluid containers 100 connected to other gas supply branches as well as the contained fluids from exposure to air. Depending on the number of gas supply branches and the size of the subset of fluid containers 100, it may be possible to only depressurize the fluid container 100 to be exchanged, while keeping all other fluid containers 100 pressurized. Yet further, depressurizing at least one fluid container 100, while keeping at least one other fluid container 100 pressurized may allow to guide a fluid from the pressurized fluid container 100 to the depressurized fluid container 100, e.g. through the valve manifold 106. This process may be referred to as backpurge or backflush.

Different gas supply branches may further provide the advantage of preventing any cross contamination between fluids in fluid containers 100 which are connected to separate gas supply branches. This may for example be relevant for the purity of fluids and/or to prevent any mixtures of fluids which may be hazardous, e.g. explosive.

It will be understood, that a subset may generally also only comprise one element, or, for example, all elements. That is, a subset of fluid containers 100 may only comprise a single fluid container 100. However, it may also include any other number of fluid containers 100 up to and including the total number of fluid containers present in the fluid supply unit 10.

In some embodiments, the fluid supply unit 10 may comprise a second valve manifold 106. That is, the fluid supply unit 10 may comprise a first valve manifold 106A and a second valve manifold 106B, wherein each of these valve manifolds 106 comprises a plurality of inlets 1061 and an outlet 1062, which may be fluidly connected to the synthesis unit 30 or the valve assembly 50. Preferably, if two valve manifolds 106A, 106B are present, one may be fluidly connected to the synthesis unit 30 and one may be fluidly connected to the valve assembly 50, without first guiding the fluid through the synthesis unit 30.

That is, a subset of the fluid containers 100 may be fluidly connected via the fluid conduits 107 to the first valve manifold 106A and a second subset of the fluid containers 100, e.g. the remaining fluid containers 100, may be fluidly connected to the second valve manifold 106B. The outlet 1062 of each valve manifold 160 may for example be fluidly connected to a different portion of the synthesis system 1. This may be advantageous as it may allow the fluid supply unit 10 to provide different fluids for different functionalities of the synthesis system 1 in parallel, i.e. at the same time, and/or independent of each other.

In some embodiments, a fluid container 100 may be connected to two fluid conduits 107, wherein one fluid conduit is connected to the first manifold 106A and the second fluid conduit 107 is connected to the second manifold 106B.

Thus, a fluid comprised by such a fluid container 100 may be provided to both valve manifolds 106A, 106B. It will be understood that the fluid conduit may also simply be split into two fluid conduits, e.g. by means of a T- or Y-piece.

In some embodiments, an output 1041 of the gas supply 104 may be fluidly connected to the valve assembly 50. Additionally or alternatively, an output of the gas supply 104 may also be fluidly connected to at least one valve manifold 106. Thus, gas from the gas supply 104 may also be supplied to elements of the synthesis system 1 other than the fluid containers 100. For example, gas may be supplied to the collection unit 70.

Similarly, a fluid connection of one or a plurality of fluid containers 100 may further be directly fluidly connected to the valve assembly 50. That is, in addition (or alternatively) to the fluidic connection of a fluid container 100 to a valve manifold 106, the fluid container may also be configured to provide a fluid directly to the valve assembly 50. Again, this may for example be realized through an additional fluid conduit 107 from the fluid container 100 to the valve assembly 50 or by splitting the fluid conduit 107 from the fluid container 100 to the valve manifold 106, e.g. utilizing a T- or Y-piece.

Providing a fluid (including gas from the gas supply 104) directly to the valve assembly 50 may for example enable to back lush any fluid conduit between the fluid containers 100 and the valve assembly 50. That is, the fluid supplied to the valve assembly 50 may be guided to the fluid conduits for example leading from the valve manifold 106 to the valve assembly 50 or from the synthesis unit 30 to the valve assembly 50 and therefore flow through said fluid conduits in reverse direction, that is from the valve assembly 50 upstream in the direction of the fluid supply unit 10. This may for example be advantageous for purging the fluidic connections and or cleaning portions of the synthesis system 1.

The gas from the gas supply 104 may for example be utilized to mix a fluid in a fluid container 100 by guiding it through the corresponding fluid conduit 106 in reverse direction, i.e. into the fluid container 100. The gas may create bubbles within the fluid container 100, which may in turn create turbulences within the fluid that may lead to a mixing of components or for example accelerate dissolving a solid component in a fluid.

The gas supply 104 may very generally be configured to provide a gas (e.g. argon or N₂), from a gas reservoir at at least one or a plurality of outputs 1041, wherein the gas supply may be configured to control the pressure at each output individually and to further selectively open and close each output 1041.

In a first embodiment, the gas supply 104 may comprise a valve for each output 1041, for example an electronically controlled valve. Further, downstream of each valve, that is further in the direction of the direction of flow of the gas may be a pressure regulator, for adjusting the pressure in each gas supply branch. The pressure regulator may for example be operated manually. Furthermore, the gas supply 104 may comprise a pressure sensor for each gas supply branch to provide data on the pressure in each gas supply branch. The sensor data may be utilized to adjust the pressure regulator for each gas supply branch according to the desired pressure values. Alternatively, the pressure sensor may be comprised by the gas supply branch instead of being part of the gas supply 104.

The valve may be, for example, a 3-port-2-way valve, which may selectively connect the corresponding output 1041, and thus the corresponding gas supply branch, to the gas supply 104 or to atmospheric pressure, e.g. a vent to surrounding atmosphere. That is, the valve may either supply gas to the output 1041 or vent the corresponding gas supply branch to atmospheric pressure, e.g. to the surrounding atmosphere, in order to depressurize the connected fluid containers 100. This may be advantageous as it may provide a safety measure. Further, the valves may be configured to assume a configuration wherein the corresponding output 1041 is connected to atmospheric pressure if no voltage and/or current is applied. This may be advantageous for example in case of a power outage as it may ensure that all fluid containers 100 are depressurized as a safety measure, e.g. to reduce the risk of any fluid leaking out of the system. Similarly, it may advantageously ensure that there is no energy stored in the system 1 when it is turned off, e.g. shut down and disconnected from mains, which may also contribute to a safe operation of the system.

Alternatively, the system may comprise a separate venting valve downstream of the first valve, i.e. the valve which may control the fluidic connection to the gas reservoir. That is, a separate valve may be utilized for connecting the corresponding outlet 1041 to atmospheric pressure.

However, such an embodiment may be relatively complex, requiring a plurality of components. Particularly, pressure regulators may typically be operated manually, which reduces the flexibility of the system as it may not allow for direct feedback due to pressure sensor readings. That is, each adjustment of a pressure in a gas supply branch may require manual adjustment through a human operator.

Thus, in another embodiment a proportional valve, such as a proportional pressure regulator, may be utilized to control the pressure. That is, the valve may generally be configured to regulate the pressure at its output proportional to a control signal, e.g. a pressure setpoint. Thus, the valve may continuously change the valve position, such that the valve may assume any position between a fully open and a closed position. The proportional valve may be configured to measure and adjust the pressure supplied at the outlet of the valve, e g utilizing a pressure sensor at its output. The proportional valve may for example be configured to control the pressure through restricting the flow from the gas reservoir, which may typically be kept at a pressure above the desired pressure. Typically, the proportional valve may comprise a pressure sensor to determine the pressure at the output. The pressure sensor may further be configured to provide corresponding pressure data, e.g. at an interface. This may advantageously allow further components to gain access to the measured pressure values. The proportional valve may be configured to regulate the pressure at the output based on the pressure sensor data, e.g. based on a feedback loop. Alternatively (or additionally), the proportional valve may be configured to receive sensor data from an external pressure sensor. Generally, the control of the valve may be comprised by the valve, that is, the valve may receive pressure data, e.g. from an internal pressure sensor, and control the flow of the gas accordingly. However, in some embodiments, the control unit may also be external such that the valve is merely provided with a control signal for regulating the gas flow, which may be based on pressure sensor data.

In some embodiments, the proportional valve may be piezoelectrically controlled. That is, the valve may comprise at least one piezoelectric element which may be stressed, e.g. contracted, by applying an electric field. Such a proportional valve may typically be combined with a further safety valve, e.g. a 3-port-2-way valve, upstream of the proportional valve and configured to vent the respective gas supply branch, e.g. to the surrounding atmosphere, in case of a power outage. That is, in case of a power outage the piezoelectric element of the proportional valve would remain in its current position, which may keep the system pressurized, thus a safety valve may be added to ensure that the gas supply branches and the connected fluid containers 100 are always depressurized when the power is cut Again, this may be particularly advantageous in case of a power outage.

Alternatively, a magnetic proportional valve may be used, e g utilizing electromagnetic coils to alter the valve position. Such a magnetic proportional valve may be configured to automatically assume a configuration wherein the output is fluidly connected to the surrounding atmosphere, e.g. through a vent, whenever no power is supplied to the magnetic proportional valve. However, a piezoelectric proportional valve may advantageously provide a more accurate pressure regulation and may further require significantly less power. That is, a magnetic proportional valve may constantly require power when assuming a position wherein gas is provided to the output, while a piezoelectric proportional valve only requires power for changing the valve position, i.e. applying an electric field to the piezoelectric element. Thus, a piezoelectrically controlled valve may have the benefit of not heating up significantly, as it does not require the constant power during operation.

In some embodiments, the fluid supply unit 10 may further include at least one flow sensor, configured to measure a flow rate of a fluid. This may for example be advantageous for determining an amount of fluid supplied for a chemical process. Additionally, or alternatively the fluid supply unit 10 may also comprise at least one pressure sensor configured to determine the pressure of a fluid. Determining the pressure for example in a fluid conduit of the fluid supply unit may be advantageous for detecting a leak or adjusting the pressure of the gas supply.

Very generally the outlet of at least one of the at least one valve manifold 106 may be fluidly connected to the synthesis unit 30, wherein the connection may comprise a multiport valve, e.g. a 4/2-way valve configured to either directly fluidly connect the outlet of at least one of the at least one valve manifold 106 to the synthesis unit 30 or to fluidly connect the outlet and/or the synthesis unit 30 to waste, for example for cleaning/purging the fluid conduits.

The synthesis unit 30 may very generally be configured for the synthesis of oligonucleotides. In particular, it may be configured for synthesis of a plurality of different oligonucleotides which may subsequently be selectively released. That is, for example, a desired combination of oligonucleotides may be released by the synthesis unit 30 after being individually and deterministically synthesised.

In one embodiment, the synthesis unit 30 may comprise a microfluidic chip 31 (see, e.g., FIG. 3A), e.g. an oligonucleotide synthesis microchip 31. Such a chip 31 may comprise a plurality of synthesis spots such as well structures, for example 10,000 to 100,000 wells, preferably 20,000 to 60,000 wells, such as 30,000 to 40,000 wells. The synthesis spots may be formed on the surface of the microfluidic chip 31 and the surface area comprising the synthesis spots (e.g. CMOS layer underneath wells of the microfluidic chip) may be referred to as active surface 311. It will be understood, that throughout this application the microfluidic chip 31 may also be referred to as microchip 31 or simply chip 31.

Synthesis spots, e.g. wells, of such a microfluidic chip 31 may for example comprise a diameter of 10 μm to 100 μm, preferably 20 μm to 80 μm, more preferably 30 μm to 60 μm and a depth of 20 μm to 100 μm, preferably 40 μm to 80 μm, such as 45 μm to 60 μm.

In some embodiments, the microfluidic chip 31 may at least partially be a complementary metal-oxide-semiconductor (CMOS) chip.

Very generally, the synthesis unit 30 may comprise a chip cover 312, e.g. a lid, for the microchip 31, which may comprise an integrated sealing element (not shown). The sealing element may for example be an elastomer ring fixedly mounted to the chip cover 312, e.g. similar to an O-ring. In particular, the sealing element may resemble an O-ring which is cut in half, such that it still resembles a circular, “O-like” shape, wherein the cross-section is shaped like a half circle instead of a full circle. In other words, the sealing element may comprise a flat contact surface which may advantageously aid with fixedly mounting the sealing element to the chip cover, e.g. by gluing it to the chip cover.

Furthermore, the chip cover 312 may be mounted in a cover mount 313, configured to aid with alignment and/or fixation of the chip cover 312 in a respective chip holder 32. Thus, a leak-tight connection may be established between the chip 31 and the chip cover 312, when the chip cover 312 and the corresponding, e.g. comprised, sealing element are pressed against the chip surface. More specifically, the chip cover 312 and the respective sealing element may be configured to provide a sealed volume on at least a portion of the surface of the chip 31, wherein the active surface 311 of the chip 31 may lie within the sealed volume.

Moreover, the sealed volume may be connected to a plurality of fluid ports, e.g. 2 fluid ports, which may for example be comprised by the chip cover 312. That is, the fluid ports may be part of the chip cover 312. The two fluid ports may enable the in- and outflow of a fluid to the sealed volume and thus the active chip surface 311 and in particular the synthesis spots, e.g. wells. For example, a fluid port may be an orifice to which fluid connectors may be connected. That is, the fluid connectors may for example be pressed upon the respective orifices such that a leak-tight connection may be established, e g utilizing a corresponding sealing element such as a gasket, ferrule or a conical sealing element. Alternatively, the chip cover 312 may comprise the fluid connectors, which may be fixedly mounted to the chip cover 312.

Furthermore, the chip 31 may comprise microfluidic structures, such as microfluidic channels, which may for example be configured to evenly and/or efficiently distribute a fluid across the active surface 311. For example, a plurality of fluidic channels may be formed on the chip surface, which may form flow paths for a fluid from one of the fluid ports to the other fluid port. Additionally or alternatively, the chip cover 312 may comprise microfluidic structures, which may again be configured to evenly and/or efficiently distribute any fluid across the active surface 311, similarly to the microfluidic structures discussed above.

The microchip 31 may comprise electrode structures that may enable individual application of electric fields to each (or a subset) of the plurality of synthesis spots (e.g. wells) on the active chip surface 311, for example by applying a respective voltage or current to selected electrode structures. That is, during operation an electric field may be applied selectively to any of the plurality of synthesis spots (e.g. wells) on the microchip 31. The chip 31 may further comprise electrical contacts outside of the active chip surface which may be in contact with said electrodes, wherein the electrical contacts may be configured to aid with establishing an electric contact between the electrode and external conductors, e.g. cables. Preferably, the electrical contacts may be located at the underside of the chip 31, i.e. at the side opposite to the side comprising the active chip area.

A microchip 31 as described above is for example known from and described in more detail in WO 2016094512 A1.

The synthesis unit 30 may typically comprise a chip holder 32, configured to accommodate the microfluidic chip 31 and to provide a sealing mechanism 324, e.g. means to establish a force for pressing the chip cover 312 and the corresponding sealing element onto the chip surface for establishing a leak-tight connection thereof. An exemplary chip holder 32 is depicted in FIG. 3A. Furthermore, the chip holder 32 may provide a fluidic connection of the microchip 31 to external fluid conduits, e.g. tubing or capillaries, and/or electrical connection for the electrode structures of the microchip 31.

That is, very generally, the chip holder 32 may be configured to receive a microfluidic chip 31 and establish a sealed, i.e. leak-tight, connection between at least a portion of the chip 31 and the respective chip cover 312 in combination with the corresponding sealing element. The connection may typically be established by applying a force to press chip 31 and chip cover 312 against each other with the corresponding sealing element in between the chip 31 and the chip cover 312, e.g. press the chip cover onto the chip 31. Therefore, the chip holder 32 may aid with providing the sealed volume comprising the active chip surface 311 and fluidic connections thereto.

Thus, the chip holder 32 may very generally provide means to place the chip 31, the chip cover 312 and/or the sealing element in a predetermined position, preferably such that the elements are aligned with respect to each other, and for example with respect to further elements such as fluidic and/or electrical connections. Further it may provide a force to establish and/or maintain the leak-tight connection between the chip 31 and the chip cover 312.

Therefore, the chip holder 32 may provide means to install and/or exchange a microfluidic chip 31 in the synthesiser system 1. Further, it may advantageously provide an easy (e.g. non-complex), reliable and reproducible way to establish a secure and leak-tight connection of the microchip 31 in the synthesiser system 1. In particular, it may provide a pressure resistant and leak-tight connection of the active surface 311 of the chip 31 to other fluidic components of the system 1, e.g. the fluid supply unit 10 and/or the valve assembly 50. Preferably, the installation and/or exchange may be carried out by a user of the system.

With reference to FIGS. 3A and 3B an exemplary embodiment of a chip holder 32 is discussed. Very generally, the chip holder 32 may comprise a body 321 and a drawer 322, wherein the chip holder 32 may assume an open configuration (FIG. 3A), wherein at least a portion (e.g. 60% or 80%) of the drawer 322 is pulled out of the body 321, and a closed configuration (FIG. 3B), wherein the drawer 322 is inserted into the body 321, such that at least the main portion (e.g. 90% or 100%) of the drawer is located within the outer limits of the body 321, preferably such that no portion of the drawer 322 extends beyond the outer limits of the body 321. Restricting the outer limits of the body 321 may advantageously allow to fit chip holder 32 into other instruments or devices such as e.g. a centrifuge to sediment beads into synthesis spots, e.g. wells, of the chip 31. The open configuration may also be referred to as loading position, whereas the closed configuration may also be referred to as processing position. In the following, reference may be made to a coordinate system. For the chip holder 32 the direction in which the drawer 322 may be moved with respect to the body 321 may correspond to the X-direction, this direction may typically correspond to the direction of the largest extend of the chip holder, which may also be referred to as the length of the chip holder 32. The Y-direction may accordingly correspond to the width of the chip holder 32 and the Z-direction may correspond to the height of the chip holder 32. That is the Z-direction may generally run in the direction from the bottom of the chip holder 32 to the top of the chip holder 32.

The drawer 322 may comprise a chip receiving section configured to hold the chip 31 in a designated position. That is, the position of the chip within the drawer 322 of the chip holder 32 may be predetermined by the chip receiving section. That is, the position may for example be predetermined by the dimensions of the chip receiving section and/or by means of alignment aids 3221, which may be configured to ensure correct (i.e. desired) horizontal positioning of the chip 31 with respect to the drawer 322. That is, alignment aids 3221 may enable exact positioning of the chip 31 in a plane parallel to the bottom surface of the chip receiving section. The plane may be parallel to the X-Y plane, that is, the chip may be parallel to the X-Y plane. However, in some embodiments, the chip receiving section and consequently the chip 31 may be at an angle with respect to the X-Y plane.

Alignment aids 3221 may generally comprise structures of any shape, that may provide reference points for the alignment of the chip 31. In some embodiments, the alignment aids 3221 may further obstruct any movement of the chip 31 once placed in the chip receiving section. An alignment aid 3221 may for example be a pin, configured to restrain a rim of the chip 31 and/or to be received by, e.g. guided through, an alignment orifice 314 of the chip 31. That is, generally, the chip 31 may comprise at least one alignment orifice 314 or a receiving section in a predetermined position, which may be configured to accept an alignment aid 3221.

In some embodiments, the chip holder 32 may comprise portions which may comprise multiple functionalities, e.g. portions may provide an alignment aid 3221 and at the same time another functionality, e.g. they may further provide an electrical contact. For example, the chip holder 32 may comprise at least one contact pin 3226, which may also serve as alignment aid 3221. Such a contact pin 3226 may for example be located within the chip receiving section and be guided through a respective pin orifice 315, and provide an electrical contact to e.g. the chip cover 312 when pressed onto the chip 31 and the contact pin 3226. Therefore, the contact pin 3226 may also constitute an alignment aid 3221 and the respective pin orifice 315 may similarly constitute an alignment orifice 314.

The chip receiving section may for example comprise a recess, configured to receive the chip and to restrain the position of the chip 31 with respect to the chip holder 32. That is, the chip 31 may be placed in the recess, which may be configured to hold the chip in a designated position. Therefore, the recess may also aid with the alignment of the chip 31 with respect to the chip holder 32.

It will be understood that a chip holder 32 may also be realized without a drawer 322. That is, the chip receiving section may for example be comprised by the body.

Chip holder 32 may be formed of any suitable material such as e.g. steel, polyamide (PA), acrylonitrile butadien styrene (ABS), polyether ether ketone (PEEK), polyoxymethylene (POM) or aluminum etc.

Additionally or alternatively, the chip 31 may be further secured through at least one shoulder 3222, which may restrain movement of the chip in a direction vertical to the chip receiving section and/or aid with the insertion of the microfluidic chip 31. For example, the shoulder 3222 may restrain movement of the chip in the Z-direction, particularly if the chip receiving section and thus the chip 31 is positioned in a plane parallel to the X-Y plane. The shoulder 3222 may also prevent that the chip 31 slips out of the chip receiving section when the chip 31 is inserted or removed. For example, the chip 31 may initially be inserted into the chip receiving section at an angle, particularly to guide a portion of the chip underneath the shoulder 3222 and/or to guide any alignment aid 3221 (e.g. contact pin 3226) into (or through) the corresponding alignment orifice 314 (e.g. pin orifice 315). In such an arrangement, the shoulders may prevent that the chip slides (or jumps) out of the chip receiving section, e.g. when the drawer is closed.

That is, when the drawer 322 comprising the chip receiving section and thus the chip 31 is moved into (or out of) the body 321 the chip 31 may be securely restrained in the chip receiving section due to the at least one alignment aid 3221 and/or the at least one shoulder 3222.

In some embodiments, the chip cover 312 and/or sealing element may also be placed on the drawer and/or the chip 31. Thus, alignment aids 3221 and/or shoulders 3222 may also aid with alignment and/or restriction of movement of the chip cover 312 and/or sealing element 313. Further, for example additional alignment aids 3221 may be provided to facilitate proper alignment of all elements Again, the chip cover may be fixed in a cover mount 313, which may also aid with the correct alignment of the chip cover 312.

Thus, when in the open configuration, i.e. the loading position, a microfluidic chip 31 can be placed in the drawer 322 in a predetermined position, which may for example ensure proper alignment with other elements of the chip holder 32 and/or the synthesiser system 1. Particularly, it may ensure leak tight sealing and/or reliable connection of fluidic and/or electric connections when the chip holder may be closed and the chip cover 312 pressed onto the chip 31.

Furthermore, the drawer 322 may in some embodiments comprise a handle structure 3223, which may be configured to aid in pulling out the drawer 322 from the body 321. Such a handle structure 3223 may for example be a handle or a knob. That is, the handle structure may advantageously provide means to easily and securely pull the drawer 322 out of the main body 321. Particularly, it may enable a user of the chip holder 32 to pull the drawer 322 out of the main body 321 in a secure and reliable fashion. It will be understood, that the handle structure 3223 may similarly aid with pushing and/or guiding the drawer 322 back into the body 321.

To facilitate an easy and secure movement of the drawer 322 in and out of the body 321, the chip holder 32 may comprise a guiding and/or gliding mechanism. That is, the drawer may for example be moved in and out of the body 321 utilizing a rail guide and/or slide mounting. Thus, the drawer 322 may comprise at least one gliding element 3224, which may be received by a guiding element 3211 of the body 321. For example, the gliding element 3224 may be a runner and the guiding element 3211 a complementary track for receiving and guiding the runner. That is, the gliding and guiding element may form, or be part of, a runner mechanism (e.g. slide mounting) such as mechanisms known from a drawer in a cabinet. Another example may be a drawer slide assembly, for example comprising two runners, wherein one runner is attached to, or part of, the drawer 322 and one runner is attached to, or part of, the body 321. It will be understood, that also other mechanisms may be utilized to enable moving the drawer 322 in and out of the body 321.

Alternatively, the chip holder 32 may not comprise a drawer 322 and the chip receiving section may for example be comprised by the body 321. In particular, the chip holder 32 may in some embodiments comprise a slot-loading mechanism, e.g. comprising a slit in the body and motorized rollers configured to draw the chip in. That is, the slot-loading mechanism may for example be similar to the slot-loading mechanism known for CD drives. With such a mechanism, the chip 31 may be placed in (e.g. inserted into) the respective slit and once inserted and/or pushed in, it may automatically be transported to the desired position within the chip holder 32, e.g. by motorized rollers. Such a mechanism may advantageously automatically ensure the correct positioning and the user may merely be required to push the chip into the respective slit.

The chip holder 32 may further comprise a cover plate 323, wherein the cover plate 323 may be configured such that it may be located above the chip receiving section of the drawer 322, when in the processing position, i.e. when the drawer 322 is closed. Thus, if a chip 31 is placed in the chip receiving section of the drawer 322, the cover plate 323 may be located above the chip 31 when the drawer 322 is closed.

Again, it will be understood, that a chip holder 32 may also be realized without a drawer 322 and that in such embodiments, the chip receiving section may for example be comprised by the body 321.

Very generally, the cover plate 323 may be configured to be pressed (directly or indirectly) onto the chip 31 and/or the chip cover 312 and corresponding sealing element to establish the leak-tight connection thereof. That is, the cover plate 323 may for example be in direct contact with the chip cover 312 and thus press the chip cover 312 onto the chip 31, wherein the connection between the chip cover 312 and the chip 31 may further comprise a sealing element, preferably mounted to the chip cover 312. In such an embodiment, the cover plate 323 may be configured to be pressed onto the chip via the chip cover 312 (and preferably the sealing element), i.e. it may be configured to be indirectly pressed onto the chip 31, while it may be configured to be directly pressed onto the chip cover 312.

The cover plate 323 may comprise fluid connectors 3231 configured to establish a fluidic connection between the active surface 311 of the chip 31 and external fluid conduits, e.g. to establish a fluidic connection between the chip 31 and the fluid supply unit 10 and/or the valve assembly 50. That is, the cover plate 323 may comprise fluid connectors 3231 configured to establish a leak-tight (and pressure resistant) connection to the sealed volume above the active chip surface 311.

For example, the chip cover 312 may comprise fluid ports, e.g. orifices, onto which the fluid connectors 3231 may be pressed, wherein for example gaskets may be utilized as sealing elements to ensure a leak-tight connection. That is, the chip 31 may for example be placed in the chip receiving section, and the chip cover 312 and the sealing element may be placed on top of the chip 31 prior to closing the drawer 322. After closing the drawer 322 the cover plate 323 may be pressed onto the chip cover 312, the sealing element and/or the chip 31 to establish a leak-tight connection therebetween. Further, the fluid connectors 3231 may be pressed onto corresponding fluid valve connections to establish a fluidic, leak-tight connection between the fluid connectors 3231 and the sealed volume between the chip 31 and the chip cover 312.

Thus, proper relative alignment between chip 31, chip cover 312, sealing element, drawer 322 and/or cover plate 323 may be provided for example by means of the chip receiving section, alignment aids 3221 and/or shoulders 3222. It will be understood that the chip receiving section, alignment aids 3221 and/or shoulders 3222 may additionally or alternatively also aid with alignment and/or restriction of movement of the chip cover 312. For example, the chip cover 312 may be attached to the cover plate 323 by means of the cover mount 313, e.g. an elastomer frame 313.

In some embodiments the cover plate 323 may comprise the chip cover 312. That is, the chip cover 312 may be part of the cover plate 323 (as depicted in FIG. 3A). For example, it may be held by a frame (i.e., cover mount 313) composed of an elastomer, i.e. a polymer comprising elastic properties such as e.g. silicone, ethylene propylene diene (EPDM). Alternatively, the cover mount 313 may for example be composed of a rigid material, such as polyimide (PA), acrylonitrile butadiene styrene (ABS) or polyether ether ketone (PEEK). In particular a rigid cover mount 313 may further comprise structurally elastic portions, e.g. extendable and/or compressible portions, such as springs, to provide elasticity to the cover mount 313.

The cover mount 313 may advantageously hold the chip cover 312 in a predefined position relative to the chip holder 32 and in particular the cover plate 323, which may ensure a correct alignment of the cover plate 312. Preferably, a sealing element may further be fixedly attached, e.g. mounted to, the cover plate 312 or alternatively be integrally formed with the cover plate 312. Thus, one may only place the chip 31 in the correct position for establishing a leak-tight connection between the chip cover 312 and the chip 31, which may advantageously reduce the chances of a relative misalignment of chip and chip cover.

An exemplary embodiment of a cover mount 313 is shown in FIG. 4. The cover mount 313 may comprise at least two retaining portions 3131 configured to receive a portion of the cover plate 312. For example, the retaining portions 3131 may comprise a groove into which a portion of a rim of the chip cover 312 may be inserted. Preferably the retaining portions 3131 are oriented such that they house opposite rim portions of the chip cover 312. Furthermore, the retaining portions 3131 may preferably be configured to each house a corner of the chip cover, that is a rim portion that comprises a corner of the chip cover 312. For fixing the cover mount 313 to the chip holder 32, and preferably to the cover plate 323, the cover mount 313 may comprise attachment portions 3132, which may for example be realized through plugs that may be received by corresponding sockets (or orifices) in the cover plate 323, and/or threads or orifices for receiving a portion of a screw. Therefore, the cover mount 313 may be mounted to the cover plate 323 by means of (or with the aid of) the attachment portions 3132.

As mentioned, the cover mount 313 may be formed or composed of an elastomer or a more rigid material. Particularly for embodiments, wherein the cover mount 313 is formed of a rigid material (e.g. PA, PEEK or ABS), it may further comprise elastic portions 3133, such as springs 3133. The elastic portions 3133 may preferably be arranged between the retaining portions 3131 and the attachment portions 3132 and may advantageously enable a secure mounting of the cover plate 312 in the cover mount 313. For example, the rim of the cover plate 312 may be inserted into at least two retaining portions 3131 and the elastic portions 3133 may provide a force such that the cover plate 312 may be clamped between the two retaining portions 3131. Furthermore, the elastic portions 3131 may enable slight movements of the cover plate 312 when pressing it down onto the chip cover to ensure the correct alignment, e.g. by compensating small deviations. It will be understood that the discussed embodiment of the cover mount 313 merely serves as an example, and that other implementations of a cover mount may be realised. Particularly, the cover mount 313 and the cover plate 312 may for example be integrally formed, that is, the cover plate 312 may comprise attachment portions 3132 for mounting it to the cover plate.

The cover mount 313 may preferably be formed of a single part. For example, it may be manufactured through additive manufacturing (3D-printing).

It will be understood that the cover mount 313 may also serve as an alignment aid. That is, it may for example ensure the correct alignment of the cover plate 312 and/or the sealing element with respect to the chip receiving section of the drawer (when in the closed position) and thus the chip 31, if placed in the chip receiving section. Additionally, the chip 31 and/or the drawer may comprise alignment aids that interact with the cover mount 313 in order to ensure correct relative alignment of the chip 31 and the cover mount 313 and thus the cover plate 312 and/or the sealing element.

Alternatively or additionally, the chip cover 312 may be attached to, e.g. connected to, the cover plate 323 via the fluid connectors 3231. That is, the fluid connectors 3231 may for example be permanently mounted to the chip cover 312 or be part of the chip cover 312 and may be mounted to (e.g. fixed to) the cover plate 323.

In some embodiments, the chip cover 312 may be an integral portion of the cover plate 323, that is cover plate 323 and chip cover 312 may be formed in a single piece. In other words, a portion of the cover plate 323 may constitute the chip cover 312.

Generally, it may be advantageous for the usability if the chip cover 312 and/or the sealing element are comprised by, e.g. mounted to, the cover plate 323 as the chip cover 312 and/or sealing element 313 may consequently not require placing and/or positioning by a user. Particularly, the user may merely be required to place the chip 31 in its predetermined position in the drawer 322 and further elements may already be aligned accordingly.

As discussed, the chip cover 312 may comprise at least two fluid ports, e.g. orifices, for establishing a fluidic connection of the sealed volume to external fluid conduits, for example by means of the fluid connectors 3231 of the cover plate 323. In some embodiments, the fluid connectors 3231 may be ferrules, e.g. flat ferrules, which may be in contact with the chip cover 312 to form a leak-tight connection such that a fluid may be guided from an external fluid conduit into the sealed volume comprising the active surface 311 of the chip 31 and vice-versa. The connection between the fluid connector 3231 and the chip cover 312 may further comprise a gasket for sealing purposes. In some embodiments, the fluid connectors 3231 and the chip cover 312 may be attached to each other. Thus, the chip cover 312 may be mounted to the cover plate 323 by means of the fluid connectors 3231. Particularly, the fluid connectors 3231 may be permanently attached to the cover plate 312 or formed integrally with the cover plate 312, e.g. manufactured from a single block of material.

Thus, when the drawer 322 is in the processing position (FIG. 3B), a fluid may be guided from an external fluid conduit through one of the fluid connectors 3231 into the sealed volume, and in particular to the synthesis spots, e.g. wells, on the active surface 311 of the microfluidic chip 31, and from the sealed volume through the second fluid connector 3231 into another external fluid conduit.

In general, the cover plate 323 may be attached to other portions of the body 321 by means of a sealing mechanism 324 or a locking mechanism 325. The sealing mechanism 324 may provide a sealing force to bring the cover plate 323 in a position, wherein the elastomer frame 313 holding the chip cover 312 is pressed onto the chip 31 and/or the drawer 322 to form a leak-tight connection, i.e. to establish the sealed volume above the active chip surface 311. That is, the sealed volume may cover the active chip surface 311 such that for example a fluid filling the sealed volume may be in contact with the active chip surface 311.

One such sealing mechanism 324 is described with reference to FIGS. 3A and 3B. The cover plate 323 may be attached to a portion of the body 321, e.g. a mounting bracket 3213 (of the body 321), wherein the connection may comprise at least one biasing element 3241, e.g. 2 or 4 biasing elements 3241. The at least one biasing element 3241 may be arranged such that it may exert a sealing force on the cover plate 323 that is directed towards the drawer 322. That is, in FIG. 3A, downwards to the bottom of the chip holder 32 or in other words in the −Z-direction. Thus, the sealing force may generally act in the direction of the chip 31. That is, the at least one biasing element 3241 may exert a sealing force configured to press the cover plate 323 and thus the chip cover 312 and the cover mount 313 onto the chip 31 (cf. FIG. 3B).

FIGS. 3A and 3B depict a chip holder 32 comprising four biasing elements 3241, e.g. springs 3241, which are configured to provide a sealing force that urges the cover plate 323 in the direction of the drawer such that the chip cover 312 and/or the sealing element are pressed onto the chip 31 and/or the drawer 322 to provide a sealed volume above the active surface 311 of the chip 31.

In some embodiments, the cover plate 323 may comprise one or a plurality of guiding aids 3242, e.g. bolts or screws, which may extend from the cover plate 323 downwards, i.e. perpendicular to a major surface of the cover plate 323 and in the direction of the bottom of the body 321. In other words, the guiding aids 3242 may be directed in the −Z-direction from the cover plate 323. The cover plate 323 may for example comprise at least one guiding aid 3242 for each biasing element 3241. However, in many instances guiding aids 3242 and biasing elements 3241 are independent of each other so that any suitable number of guiding aids 3242 and biasing elements 3241 may be present.

The guiding aids 3242 may be guided through respective orifices in the body 321, e.g. the mounting bracket 3213. Further, the guiding aids 3242 may comprise an extended portion 32421 at the end furthest away from the cover plate 323, that is, they may comprise a portion with an increased diameter which is located at the lowest portion (i.e. furthest in −Z-direction) of the guiding aid 3242. Thus, biasing elements 3241 may for example be mounted (e g clamped) between the extended portion 32421 of the guiding aids 3242 and the respective portion comprising the orifice, e.g. the mounting bracket 323. Thus, the biasing element 3241 may exert a force, that is directed to pull the guiding element 3242 through the orifice and thus pull the cover plate 323 towards the drawer 322.

In other words, the biasing elements 3241 may be arranged such that the cover plate 323 is pulled downwards, i.e. towards the drawer 322 and the chip 31, if the chip holder 32 assumes the closed configuration. This may for example be realized by using springs which are arranged such that they provide a force acting in the desired (downward) direction.

That is, the biasing element 3241 may be a spring 3241 and the guiding aid 3242 may for example be a screw 3242 with a wide, flat head which may provide the extended portion 32421. The spring 3241 may be chosen such that its inner diameter is larger than the diameter of the screw 3242 and smaller than the diameter of the screw head 32421. Thus, the screw 3242 may be guided through the spring 3241 and through the respective orifice in the mounting bracket 3213 such that it may be screwed into a respective hole in the cover plate 323. Thus, the spring 3241 may be clamped between the screw head 32421 and the mounting bracket 3213 such that the spring force may pull the cover plate 323 towards the mounting bracket 3213 and consequently towards the chip 31 if the drawer 322 is closed.

The body 321 may further comprise a locking mechanism 325 to keep the cover plate 323 at a certain distance to the chip 31, e.g. for enabling an exchange of the chip 31 by opening the drawer 322. Since the sealing mechanism 324, e.g. as described above, may in some embodiments constantly provide a force, that pulls the cover plate 323 downwards, a locking mechanism 325 may be required to lock the cover plate 323 in an elevated position, e.g. for exchanging the chip 31. That is, the cover plate 323 may be locked in an elevated position such that the drawer 322 may be opened and/or closed smoothly and safely without any obstruction through the cover plate 323 and/or any parts attached to it. Thus, if for example the chip cover 312 and/or the cover mount 313 are mounted to the cover plate 323, the locking mechanism 325 may lock the cover plate 323 in an elevated position, such that the chip cover 312 and/or the respective cover mount 313 may not contact and/or interfere with any portion of the drawer 322 (and the chip 31) when opened and/or closed.

The locking mechanism 325 may for example be provided through at least one locking device 3251, which may be configured to lock the cover plate 323 at a predetermined distance over the drawer 322 (when in the closed position). Such a locking device 3251 may in some embodiments also be a biasing element, such as a spring (c.f. FIGS. 5A and 5B).

That is, generally the cover plate 323 may be lifted (i.e. moved away from the drawer 322 and the body 321) by applying a force working against the sealing mechanism 324, e g manually by a user or through an electrically, mechanically or pneumatically driven actuator. Once the cover plate 323 has reached the predetermined height one or a plurality of locking devices 3251 may lock the cover plate 323 and thus prevent it from moving back down.

With reference to FIGS. 3A and 3B, the at least one locking device 3251 may for example be a locking device 3251 configured to provide a mechanical interlock. Very generally, the locking device 3251 may be rotatably mounted to the body 321, wherein the axis of rotation may preferably be closer to the top of the main body 321 than to the bottom of the main body. For example, the axis around which the locking device 3251 may rotate may be located in terms of height in the upper third of the body 321. Further the axis around which the locking device 3251 may rotate may be aligned with the X-axis, such that the locking device 3251 may be confined to a plane parallel to the Y-Z plane.

In a first position (cf. FIG. 3B), the locking device 3251 may be in a non-locking position, that is it may not be in contact with the cover plate 323. That is, in the non-locking position the locking device 3251 may substantially extend downwards from the axis of rotation, i.e. in the direction of the bottom of the body 321. Ina second position (cf. FIG. 3A), the locking device 3251 may be in a locking position, that is it may lock the cover plate 323 in an elevated position. That is, the locking device 3251 may prevent the cover plate 321 from going back down, e.g. due to the sealing mechanism 324 and/or gravity. Thus, in the locking position, the locking device 3251 may substantially extend upwards from the axis of rotation, such that it extends beyond a main portion of the body 321 in Z-direction, i.e. beyond portions of the body 321 excluding the cover plate 323, and particularly beyond any portion of the drawer 322 (in Z-direction).

Thus, in the second position the cover plate 323 may be locked in a position which may enable unrestricted movement of the drawer 322 with respect to any portion comprised by and/or attached to the cover plate. In other words, it may allow for a secure and unhindered exchange of the chip 31.

The at least one locking device 3251 may be configured to aid with lifting the cover plate 323. That is, the at least one locking device 3251 may be configured to transmit a force, e.g. a force providing a movement of the locking device 3251 around the axis it is mounted to, to the cover plate 323, wherein the transmitted force may act in a direction to push the cover plate 323 up (i.e. in Z-direction).

For example, the locking device 3251 may comprise a contact surface 3252, wherein the contact surface 3252 may be the surface that can be in contact with the cover plate 323. Further, a portion of the locking device 3251 may be formed such that the distance from the point at which the locking device 3251 is rotatably mounted to the contact surface 3252 may increase continuously from a first end of the contact surface 32521 to a second end of the contact surface 32522. When the locking device 3251 is moved from the non-locking (FIG. 3B) into the locking position (FIG. 3A) generally the first end of the contact surface 32521 may get into contact with the cover plate 323 prior to the second end 32522 of the contact surface 3252. Specifically, locking device 3251 may comprise circularly shaped portion, e.g. resembling a quarter of a circular area (i.e. a quadrant), as depicted in FIGS. 3A and 3B, or for example resemble a “P”-shape, wherein the locking device may be rotatably mounted at the bottom of the “P”.

Thus, when the locking device 3251 is transferred from the non-locking to the locking position, e.g. by applying a force to rotate the locking device 3251, the first end 32521 of the contact surface 3251 may at some point get into contact with the cover plate 323, which may at that point still be in its lowest position. That is, the cover plate 323 may be in a position wherein the chip cover 312 may be sealingly connected to the chip 31, e.g. via the sealing element. By moving the locking device 3251 further into the direction of the locking position, the increase in the effective length of the locking device 3251 (due to the increasing distance of the contact surface to the point where the locking device 3251 is rotatably mounted), the cover plate 323 may be forced in an upwards direction, i.e. lifted, provided the force with witch the locking device 3251 is moved is sufficient to overcome the force exerted by the sealing mechanism 324.

In some embodiments, the cover plate 323 may comprise at least one angled surface 3232 which may serve as receiving portion for receiving the at least one locking device 3251, e.g. for the contact surface 3252 of the at least one locking device 3251. The at least one angled surface 3232 may advantageously provide a larger working surface for receiving the locking device, particularly if the at least one locking device 3251 is a locking device 3251 configured to aid with lifting the cover plate 323.

Thus, in some embodiments a force may be applied through the at least one locking device 3251 which may lift the cover plate 323 when pushed against it, e.g. against the at least one angled surface 3232.

Further, the chip holder 32 may also provide a connecting mechanism configured to provide an electrical connection for the chip 31. That is, an electrical connection, e.g. for the electrodes comprised by the chip 31, may also be established when fixing the chip 31 in the chip holder 32. The chip 31 may comprise a plurality of electrical contacts, which may for example be electrically connected to the electrodes of the chip. Similarly, the chip holder 32 may comprise corresponding electrical contacts configured to provide an electrical connection of the chip 31, i.e. the electrical contacts of the chip 31, to the chip holder 32 and thus for example to an external device. That is, the chip holder 32 may for example comprise a socket for receiving a plug or it may provide a cable with a plug, which may be configured for establishing an electrical connection to an external device, respectively. Alternatively, the chip holder 32 may comprise spring-loaded contacts.

For example, the electrical contacts of the chip 31 may be located at an underside of the chip 31, that is, the side opposing the side comprising the synthesis spots, e.g. wells, and the active chip surface 311. Accordingly, the electrical contacts of the chip holder 32 may be located at corresponding positions within the chip receiving section, configured such that an electrical connection between the electrical contacts may be established when pressing the chip 31 onto the chip receiving section, e.g. onto electrical contacts of the holder 32 comprised by the chip receiving section, which may for example be spring-loaded pins.

In particular, the electric contact may in some embodiments be established independently of the position of the cover plate 323. That is, the electric contact may be established without requiring the sealing force applied through the cover plate 323 when in contact with the chip 31 (e.g. through chip holder and respective frame). In other words, the connecting mechanism may be independent of the sealing mechanism 324 of the holder 32. This may allow for electrical communication with the chip in the absence of a fluidic connection. In addition, the sealing force provided by sealing mechanism 324 is independent of the force provided by the electric (e.g. spring-loaded) contact.

The connection mechanism may for example be realised by utilizing at least one tappet 3225, which may interact with an eccentric element (not shown), e.g. an eccentrically mounted wheel, when the drawer 322 is moved in or out of the body 321, wherein the eccentric element may be configured to provide a connecting force acting on at least a portion of the chip 31 such that an electrical contact is established between opposing electrical contacts on the chip 31 and within the chip holder 32. That is, the electrical connection may for example be established prior to the fluidic connection, which may only be established once the chip cover 312 is pressed onto the chip 31.

Alternatively, the connecting mechanism may for example be established by means of an oblique area. That is, an oblique area may be mounted such that it exerts a force onto the chip 31 when it is inserted into the body 321, e.g. when the drawer 322 is closed, e.g. pushed into the body 321. Particularly, the oblique area may be arranged such that the force exerted on the chip 31 increases with the movement of the chip in the X-direction by continuously reducing the space between the oblique area and the chip receiving section. The oblique area may be comprised by a restriction element 326 (cf. FIG. 3B).

With reference to FIG. 5, an exemplary embodiment of a restriction element 326 comprising an oblique area 3261 is shown. The restriction element 326 may generally be mounted to the body 321, e.g. screwed to the body 321, in a location that allows for the oblique area 3261 to interact with the chip 31 comprised by the drawer 322, when said drawer 321 is closed 322. Particularly, the oblique area 3261 may be arranged such that the space between the chip receiving section and the oblique area 3261 decreases in x-direction, i.e. direction into which the drawer 322 may be moved. Thus, when the chip 31 is placed in the chip receiving section of the drawer 322 and the drawer 322 is subsequently pushed into the body 321 (i.e. pushed in x-direction), the oblique area 3261 may get into contact with the chip surface and exert a force onto the chip surface that acts in the direction of the chip receiving recess when the drawer 322 is closed. In other words, when closing the drawer 322, the chip 31 may at some point get into contact with the oblique area 3261, which will force at least a portion of the chip 31 into the direction of the chip receiving surface due to the decreasing space between chip 31 and chip receiving surface when pushing the drawer 322 further into the body. That is, the chip may be clamped between the restriction element 326 and the chip receiving surface. The oblique area 3261 may comprise a continuous surface at a fixed or changing angle, or, alternatively, comprise a plurality of portions, each at a different angle, wherein the portions follow each other in the direction the drawer 322 is pushed. Generally, the oblique area may lead to a flat surface 3262, that may be parallel to the chip receiving surface when the restriction element 326 is mounted to the body 321 and the drawer is closed (cf. FIG. 3B).

In some embodiments, the chip cover 312 may comprise at least one cover electrode, e.g. counter electrodes to the electrodes comprised by the chip 31 and particularly the active area 311 of the chip 31. The electrical connection to the at least one cover electrode may for example be provided to at least one contact pin 3226 which may be comprised by the chip holder 32 and preferably the chip receiving section. The at least one contact pin 3226 may for example be a spring-loaded contact pin 3226, which may be guided through a respective pin orifice 315 in the chip 31. Thus, when the chip cover 312 is pressed onto the chip 31, the at least one contact pin 3226 may be pressed against a respective contact surface comprised by the cover plate 323??? (e.g. a portion of the at least one cover electrode) to establish the desired electrical connection Again, the contact pin 3226 and the pin orifice 315 may advantageously also serve as alignment aid 3221 and alignment orifice 314, respectively.

Alternatively, an electrical contact to the at least one cover electrode may for example be provided through the cover mount 313 and the cover plate 323.

FIGS. 6A and 6B show a different embodiment of a chip holder 32 comprising a different sealing mechanism 324. Generally, the chip holder 32 may be similar to the embodiment discussed above with reference to FIGS. 3A and 3B. That is, it may comprise a body 321, a drawer 322 and a cover plate 323. However, the at least one gliding element 3224 may be provided by one or a plurality of freely rotating rods which may be restrained in the guiding element 3211, such as a notch or a slot to limit the range of movement.

The chip 31 may again be placed in a chip receiving section in the drawer 322, which may hold the chip 31 in a predefined position. Further, alignment aids 3221 may be utilized to ensure correct placement and/or to secure the chip 31 in the predefined position. Furthermore, alignment aids 3221 and/or cover mount 313 may also be utilized to ensure correct placement of the chip cover 312 and/or a sealing element in embodiments, where the chip cover 312, sealing element and/or the cover mount 313 are not attached to the cover plate 323. In the depicted embodiment, chip cover 312 and/or cover mount 313 may be placed manually in the correct positions, e.g. by a user. The correct alignment may be supported by an additional alignment aid 3221, for example by a framing element 3227, which may particularly aid with the correct placement of the chip cover 312, the sealing element, and/or the cover mount 313 with respect to the chip 31. That is, the framing element 3227 may generally be an alignment aid 3221. However, similarly to before, they may also be attached to the cover plate 323, in which case the alignment may be ensured by the combination of the cover mount 313 and the cover plate 323 and their defined position with respect to the drawer 322 in the closed configuration.

Moreover, the chip holder 32 may provide a different sealing mechanism 324. Here, the cover plate 323 may again provide fluidic connectors 3231, such as flat ferrules, which may comprise sealing elements such as a gasket or a conical sealing element.

The sealing mechanism 324 may comprise at least one magnet 3243. The at least one magnet 3243 may for example be placed in a recess of the body 321 and oriented towards the cover plate 323. The cover plate 323 may comprise a corresponding magnet or simply be composed of a magnetic material. Thus, once the cover plate 323 is in close proximity to the magnet 3243, the magnetic force may pull the cover plate 323 towards the body 321, i.e. it may exert a force on the cover plate 323 that is directed towards the chip receiving section, and thus restrain the cover plate 323 in a position wherein the chip cover 312 and the sealing element 313 may be pressed onto the chip 31 within the chip receiving section, to form a sealed volume (cf. FIG. 6B).

The locking mechanism 325 in such an embodiment, may for example be provided by at least one biasing element 3253, e.g. a spring. The biasing element 3253 may be arranged such that it exerts a force on the cover plate 323 that pushes the cover plate 323 up, that is away from the chip receiving section (e.g. in Z-direction). Thus, the cover plate 323 will be locked in an elevated position above the chip receiving section such that the drawer 322 may be moved in and out of the body 321 without any interference of the cover plate 323 (and any parts attached to it) with the drawer 322 and/or chip 31.

To seal the chip cover 312 to the chip surface a force may be required to overcome the force of the locking mechanism 325 and thus to press down the cover plate 323. This may for example be done manually by a user or for example with an electrical, mechanical or pneumatic actuator. Again, once the cover plate 323 is in close proximity to the at least one magnet 3243 it may be pulled down by the magnetic force (sealing force), and thus restrain the cover plate 323 in a position wherein the chip cover 312, cover mount 313 and/or the sealing element, e.g. elastomer frame, is pressed onto the chip 31. In particular, in this position, the sealing force exerted onto the cover plate 323 by the at least one magnet 3243 is greater than the force of the locking mechanism 325 that acts in the opposite direction. That is, once the cover plate 323 is in a position wherein the chip cover 312, cover mount 313 and/or sealing element is pressed onto the chip 31 it may not move upwards, i.e. break the sealing, without applying an additional force to overcome the magnetic force (sealing force). In other words, once the cover plate 323 is pressed down it remains in this position until a force overcoming the magnetic force (sealing force) is applied to break the leak-tight connection between the chip cover 312 and the chip 31 and lift the cover plate 323.

Again, the electrical connection may be established by a separate connecting mechanism, i.e. not through the pressure applied by the cover plate 323 but for example through an eccentric element or an oblique area that exerts a connecting force on a portion of the chip 31 comprising electrical contacts when the drawer 322 is moved into the closed position.

The valve assembly 50 may very generally comprise at least one or a plurality of valves, wherein each valve may be configured to assume a plurality of configurations. That is, the at least one valve of the valve assembly 50 may be a multiport valve. Generally, the valve assembly 50 may be configured to direct fluids between the synthesis unit 30 and the collection unit 70, as well as between the fluid supply unit 10 and the synthesis unit 30 and/or the collection unit 70. Furthermore, the valve assembly 50 may also assume configurations wherein a fluid may be guided to waste.

With reference to FIG. 7, the valve assembly 50 may comprise at least one distribution valve 51, e.g. two distribution valves 51A, 51B, wherein the at least one distribution valve 51 may comprise at least 10 valve connections, preferably at least 15 valve connections, more preferably at least 20 valve connections, such as 25, 28 or 30 valve connections. Moreover, the at least one distribution valve 51 may be configured to fluidly connect a single valve connection to any of the remaining valve connections of the distribution valve 51. In other words, a distribution valve 51 may be configured to establish a maximum of one direct fluidic connection between two valve connections in any configuration it assumes. For conventional multiport valves a valve connection may correspond to a port.

For example, the at least one distribution valve 51 may be a rotary valve 6 (see FIG. 8), wherein one valve connection may be arranged at the centre of the rotary valve 6, while the remaining valve connections may be arranged equidistantly on a circle around the centre. In such a rotary valve 6, for example a single, radial groove may connect the central valve connection to any other valve connection of the valve.

Furthermore, the valve assembly 50 may comprise a selection valve 52, wherein the selection valve 52 may be configured to select which fluid source may be connected to the at least one distribution valve 51. In embodiments, where the valve assembly 50 comprises a plurality of distribution valves 51, the selection valve may further be configured to select which fluidic source is connected to which distribution valve 51. A fluidic source may for example be the synthesis unit 30 and/or a valve manifold 106, 106A, 106B of the fluid supply unit 10.

The valve assembly 50 depicted in FIG. 7 comprises a selection valve 52 which may for example be a 4/2-way valve, that is it may comprise 4 valve connections and be configured to assume 2 configurations. The depicted selection valve 52 may for example assume a first configuration I (not shown), wherein valve connection 1 is directly fluidly connected to valve connection 2 and valve connection 3 is directly fluidly connected to valve connection 4. Further, the depicted selection valve 52 may assume a second configuration II (see FIG. 7), wherein valve connection 1 is directly fluidly connected to valve connection 4 and valve connection 2 is directly fluidly connected to valve connection 3.

It will be understood that in the context of a valve, directly fluidly connected refers to a fluid connection within the valve, e.g. via a groove. That is, if valve connection 1 and 2 are directly fluidly connected a fluid may flow from valve connection 1 to valve connection 2 (or vice versa) without leaving the valve.

The valve assembly 50 may in some embodiments comprise a plurality of distribution valves 51. In some embodiments, the plurality of distribution valves 51 may be identical to each other, whereas in other embodiments, the distribution valves 51 may be different to each other, e.g. with respect to the number of valve connections and/or the number of configurations they may assume.

In an exemplary embodiment, the valve assembly 50 may comprise two distribution valves 51A, 51B (see FIG. 7). The distribution valves 51 may for example be 25/24-way valves. That is, they may each comprise 25 valve connections and may assume 24 configurations. For example, each distribution valve 51 may be a rotary valve 6 comprising one valve connection 25 at the centre of a stator and 24 valve connections (1, 2, . . . , 24) equidistantly arranged on a circumference around the centre of the stator. Further, a rotor may comprise a single groove or notch, which may be oriented radially outward from the centre of the rotor, wherein the length of the groove or notch may be such that it may directly fluidly connect the valve connection in the centre of the stator to another valve connection of the stator. That is, it may selectively couple the central valve connection 25 to any of the surrounding valve connections (1, 2, . . . , 24) depending on the rotor position. Thus, the central valve connection 25 may also be referred to as distribution valve connection 25 as the valve is configured to distribute a fluid to or from the central valve connection 25.

The distribution valve connection 25 of each distribution valve 51 may be fluidly connected to a valve connection of the selection valve 52. A plurality of the surrounding valve connections (1, 2, . . . , 24) of each distribution valve 51 may for example be connected to the collection unit 70. Typically, one of the surrounding valve connections may be connected to waste. Furthermore, in some embodiments one or a plurality of the surrounding valve connections may be connected to the fluid supply unit 10, i.e. to a fluid source. That is, one or a plurality of the surrounding valve connections may for example be fluidly connected to a fluid container 100 of the fluid supply unit 10 or an outlet 1041 of the gas supply unit 104.

In some embodiments, a fluid may also be guided into a spectrometer which may be fluidly connected to one of the surrounding valve connections (1, 2, . . . , 24) of a distribution valve 51. That is, at least one of the at least one distribution valve 51 may in some embodiments be fluidly connected to a spectrometer. This may for example be advantageous for analysing processes, e.g. synthesis steps, performed on the synthesis unit 30.

That is, two valve connections of the selection valve 52 may be fluidly connected to one of the two distribution valves 51A, 51B, respectively. For example, valve connection 2 of the selection valve 52 may be connected to a first distribution valve 51A and valve connection 4 of the selection valve may be connected to a second distribution valve 51B. Furthermore, valve connection 1 of the selection valve 52 may be fluidly connected to the synthesis unit 30 and valve connection 3 of the selection valve 52 may be fluidly connected to the fluid supply unit 10, without the synthesis unit 30 being part of said fluid connection. Particularly, valve connection 3 of the selection valve 52 may be fluidly connected to one of the at least one valve manifold 106 of the fluid supply unit 10, wherein the fluid supply unit 10 may typically comprise two valve manifolds 106A, 106B in such an embodiment. That is, the first valve manifold 106A may be fluidly connected to the synthesis unit 30 and the second valve manifold 106B may be fluidly connected to the selection valve 52, without the synthesis unit 30 being part of that fluid connection.

In other embodiments, the selection valve 52 may not be fluidly connected to the fluid supply unit 10 without the synthesis unit 30 being part of that connection, e.g. if the fluid supply unit 10 only comprises a single valve manifold 106. In such embodiments, the selection valve 52 may for example be a 3/2-way valve, or valve connection 4 of the selection valve 52 may be directly fluidly connected to a fluid container 100, the gas supply 104 or a waste.

Thus, if the selection valve 52 assumes the first configuration I, a fluid may flow from the synthesis unit 30, and particularly from the chip 31, to the first distribution valve 51A through valve connections 1 and 2 of the selection valve 52 from where it may be guided to one of the valve connections 1 to 24. That is, it may for example be guided to waste or to the collection unit 70.

Furthermore, at the same time, a fluid from the fluid supply unit 10 may be guided, e.g. via valve manifold 106B, to the second distribution valve 51B through valve connections 3 and 4 of the selection valve 52 and without passing through the synthesis unit 30. The second distribution valve 51B may for example guide the fluid to waste or the collection unit 70.

That is, in some configurations the valve assembly 50 may allow to provide the collection unit 70 with two fluids at the same time through 2 separate fluidic connections, e.g. capillaries or tubes. In particular, the collection unit 70 may in some embodiments be supplied with a fluid from the synthesis unit 30 and, at the same time, with a fluid from the fluid supply unit 10, e.g. via valve manifold 106B. This may for example be advantageous for guiding a fluid to the collection unit 70 that may be harmful to the synthesis unit 30 and/or the synthesis process happening in the synthesis unit 30. In addition, this may advantageously allow for simultaneous (i) retrieval and transport of individual beads (comprising selected oligonucleotides) with a first fluid from the synthesis unit 30 to selected wells of the collection unit 70 and (ii) post processing (e.g. cleavage and deprotection) of collected oligonucleotides by one or more second fluids delivered by the fluid supply unit 10 to selected wells of the collection unit 70.

As mentioned, the system 1 may comprise a plurality of multiport valves. With reference to FIG. 8, a multiport valve may be a rotary valve 6, comprising a stator 61 and a rotor 62, wherein the stator 61 may comprise a plurality of valve connections, e.g. channels, and the rotor 62 may comprise at least one groove. During operation the stator 61 and rotor 62 may be pressed together to form a leak-tight interface. That is, between portions of the stator 61 which are not comprising a valve connection and portions of the rotor 62 not comprising a groove, a leak-tight interface may be formed when pressed together, such that for example no fluid (or only a negligible amount) introduced through any of the valve connections may leak out of the rotary valve 6 through the interface between the stator 61 and the rotor 62. For example, the stator 61 may be mounted to a frame 63 and the rotor 62 may be pressed onto the stator 61 by applying a force, e.g. a biasing element 64 such as a spring 64 may be configured to press the rotor 62 onto the stator 61. Further, the multiport valve 6 may comprise an actuator 65, for example an electric motor 65 such as a step motor 65, configured to rotate the rotor 62 with respect to the stator 61.

An exemplary embodiment of an assembled rotary valve 6 is depicted in FIG. 8. Very generally, the rotary valve 6 may comprise a frame 63 (or housing 63) to which non-moving parts of the rotary valve 6 may be fixedly mounted. The frame 63 may for example comprise a plurality of elements, such as at least one plate 631, at least one rod, and/or optionally at least one connecting element 632, which may be fixedly assembled to form the frame 63, e.g. utilizing fastening means such as screws or rivets.

Attached to a portion of the frame 63 may be the actuator 65, e.g. the electric motor 65, which may be connected to the rotor 62 either directly, e.g. via a rigid connection or a drive shaft, or by means of a gearing, such that a rotational force exerted by the actuator 65 may be transferred to the rotor 62, which may rotate accordingly.

The stator 61 may also be mounted to a portion of the frame 63, e g utilizing fastening means such as screws or rivets, or for example by means of gluing or welding. Thus, the stator 61 may not move independent of the frame 63. Typically, the stator 61 may be fixed to a portion of the frame 63 that is opposite to the portion the actuator 65 is mounted to. In the following, the portion of the frame 63, to which the stator 61 is mounted, may be referred to as the front of the frame 63 and consequently the portion of the frame 63 the actuator 65 is mounted to may be referred to as the back of the frame 63. In the depicted embodiment, the stator 61 is fixed to the front of the frame by means of screws 633.

While in FIG. 8 the actuator 65 is shown to be mounted outside of the frame 63 (or housing 63), it will be understood that this merely serves as an example and that the actuator 65 may also be mounted within the frame 63. That is, it may extend from the back of the frame 63 in the direction of the front of the frame 63.

The stator 61 may typically comprise a disc-like shape, i.e. the stator 61 may comprise a circular shape with a finite thickness, wherein one of the circular faces may be a connection face 611, i.e. the circularly-shaped face at which fluid conduits may be connected and/or inserted into the stator 61 (cf. FIG. 10A) and the second circular face may be a gliding face 612 (cf. FIG. 10B), i.e. the face that may be (at least partially) in contact with the corresponding rotor 62. Fluid conduits may for example be capillaries or tubes.

Very generally, the stator 61 may comprise a plurality of channels, which may each be connected to a fluid conduit which is connected to and/or inserted into the channel at the connection face 611. Each channel may be an orifice running through the stator 61, establishing a fluidic connection between the two circular faces of the stator 61, i.e. the connection face 611 and the gliding face 612. A channel in the stator 61 may also be referred to as valve connection.

With reference to FIGS. 9A and 9B, the rotor 62 may comprise at least one groove 623, configured to establish a fluidic connection between at least two channels of the stator 61 when aligned accordingly Similar to the stator 61, the rotor 62 may generally comprise a disc-like shape, i.e. the rotor may also comprise a generally circular shape and a finite thickness. However, the rotor 62 may further comprise a rear extension 624, which may for example be connected to the actuator 65 and/or be configured to be inserted into the biasing element 64. The rotor 62 may comprise a gliding face 621, configured to be pressed on the corresponding gliding face 612 of the stator 61. Thus, the at least one groove 623 of the rotor 62 may be comprised by the gliding face 621 of the rotor 62. The second circular face of the rotor 62 may be a back face 622, which may be configured to be connected to the actuator 65 in a way that enables to provide the rotor 62 with any force exerted by the actuator 65. In some embodiments, the back face 622 may be connected to the actuator 65 through the rear extension 624, which may generally extend away from the back face 622. It will be understood that the diameter of the disc-shaped rotor 62 may be different to the diameter of the disc-shaped stator 61. In particular the rotor 62 may comprise a smaller diameter than the stator 61, since the stator 61 may for example comprise additional space for mounting to the frame 63.

Furthermore, the back face 622 of the rotor 62 may be configured to receive a force configured to press the rotor 62 onto the stator 61 to form a leak-tight interface between the gliding surface 612 of the stator 61 and the gliding surface 621 of the rotor 62. For example, the back face 622 of the rotor 62 may be configured to receive a first end of a biasing element 64, e.g. a spring 64, configured to exert a force on the rotor 62 that acts in the direction of the stator 61, i.e. that presses the rotor 62 onto the stator 61. A second end of the biasing element 64 may be (directly or indirectly) biased against the frame 63 (or housing 63). Very generally the first end of the biasing element 64 and the second end of the biasing element 64 may be aligned along an axis running from the front to the back of the frame 63, such that the force that the biasing element 64 exerts onto the rotor 62 is perpendicular to the back face 622 of the rotor 62. This may advantageously provide a uniform sealing force which evenly presses the gliding surface 621 of the rotor 62 onto the gliding surface 612 of the stator 61. In other words, the biasing element 64 may be configured to exert a force on the rotor 62 that is perpendicular to the back face 622 of the rotor 62. The biasing element 64 may for example surround the rear extension 624 of the rotor 62, which may preferably extend perpendicularly away from the centre of the back face 622 of the stator 62.

The second end of the biasing element 64 may for example be mounted to or biased against a clamping plate 634, which may be rigidly fixed to the frame 63, e.g. by means of screws 67 or threaded rods 67, which may also be referred to as guiding elements 67. The clamping plate 634 may be arranged between the rotor 62 and the back of the frame, particularly between the rotor 62 and the actuator 65. Furthermore, the clamping plate 634 may comprise an orifice, e.g. a central orifice, to enable any element required for force transmission (e.g. a drive train and/or the rear extension 624 of the rotor 62) between the actuator 65 and the rotor 62 to pass through the clamping plate 634 without any hindrance. Thus, the biasing element may be arranged between the clamping plate 634 and the rotor 62 such that it presses the rotor 62 on the stator 61 and the force it exerts may be configured to establish a leak tight interface between the two gliding surfaces 612, 621, while still enabling the rotor 62 to be turned by the actuator 65.

With reference to FIG. 8 the rotary valve 6 may in some embodiments further comprise a ball bearing 66 or other suitable means for reducing friction between the biasing element 64 and the back face of the rotor 622. That is, the ball bearing 66 may be mounted between the back face 622 and the first end biasing element 64, such that the force exerted by the biasing element 64, which generally is directed perpendicular to the back face 622 of the rotor 62, may be transferred through the ball bearing, while reducing frictional forces when rotating the rotor 62 with respect to the stator 61 and the biasing element 64. Thus, the ball bearing 66 may advantageously reduce the friction between the rotor 62 and the biasing element 64, particularly when the rotor is rotated by means of a force provided through the actuator 65. Said force may, due to the reduced frictional forces, consequently be lower compared to an embodiment with no ball bearing 66.

With reference to FIG. 9C, the rotor 62 may in some embodiments comprise a sealing lip 625, which may surround the at least one groove 623 and cover the area of the gliding surface 621 which generally lies opposite to the channels of the stator 61. That is, the sealing lip 625 may be configured to seal all channels comprised by the stator 61, except for the at least two channels that may be connected by the groove 623. In some instances, the sealing lip 625 may be made of the same material as the rotor 62. For example, the sealing lip 625 and the rotor 62 may be milled from a single block of material. Alternatively, the sealing lip 625 may be formed of an elastomer, e.g. silicone or ethylene propylene diene (EPDM). The sealing lip 625 may advantageously reduce the force required to press the stator 61 and rotor 62 together to form a leak-tight interface. That is, the force exerted for example by the biasing element 64 may be reduced compared to an embodiment wherein no sealing lip 625 is present.

Very generally stator 61, rotor 62, biasing element 64 and actuator 65, as well as ball bearing 66 and clamping plate 634 where applicable, may be aligned along an axis between the front and the back of the frame 63. That is, the central axis of each element running from the front to the back of each element, may coincide with an axis running (preferably centrally) from the front to the back of the frame 63.

In particular the rotor 62 may be aligned to the stator 61 such that the two gliding surfaces 612, 621 are aligned to each other and the rotor 62 may be restricted in a way that only allows rotational movement of the rotor 62 and movement along an axis between the front and the back of the frame 63 and perpendicular to the stator 61. In other words, the rotor 62 may be confined, e.g. mounted, such that it may not move laterally with respect to the stator 61. That is, the two gliding surfaces 612, 621 may stay aligned to each other even when the rotor 62 is moved by a rotational force from the actuator 65 and/or pressed against the stator by a force exerted by the biasing element 64. It will be understood that the gliding surface 612 of the stator 61 may be larger than the gliding surface 621 of the rotor 62 and that aligning the two gliding surfaces may generally refer to aligning the gliding surfaces 612, 621 such that the respective centres of the two surfaces overlap. That is, the centre of the gliding surface 612 of the stator 61 and the centre of the gliding surface 621 of the rotor 62 may lie on an axis running, preferably centrally, from the front to the back of the frame 63 (or housing 63).

With reference to FIGS. 10A and 10B, the stator 61 comprises a plurality of channels 619, wherein each channel 619 may be fluidly connected to a fluid conduit, also referred to as tube. That is, a tube, may be any type of fluid conduit. Typically, each tube may be connected to the corresponding channel 619 by means of a connector. However, this may lead to a very complex design with a plurality of parts, particularly with an increasing number of channels 619, as one connector is required for each channel 619. Thus, the number of channels 619 for a given size of the stator 61 may be limited by the dimensions of the connectors.

Therefore, the connection may advantageously be established without utilizing separate connectors. In a first embodiment, the channels 619 in the stator 61 may be through bores running from the connection face 611 to the gliding face 612. That is, each channel 619 may be an opening running through the stator 61. Each such channel 619 may comprise an inner diameter D1 (cf. FIG. 13C). The inner diameter D1 may be constant throughout the channel 619 and preferably the inner diameter D1 may be substantially the same for all channels 619. Here, and in general in this application, the word “substantially” serves to include deviations due to technical limitations and/or error margins in the fabrication process. The inner diameter D1 of the through bores, i.e. the channels 619, may be in the range of 0.5 mm to 5 mm, preferably 0.8 mm to 4 mm, more preferably 1.4 mm to 3.1 mm (e.g. if 1/16 and ⅛ tubes are used, respectively).

The tubes, which may be connected to the channels 619 may generally be made of a polymer (e.g. plastic), preferably a flexible polymer (such as e.g. PTFE, PEEK or PFA). That is, the tubes may be polymer tubes. In other words, the tubes providing the valve connections to and from the rotary valve 6 may be made of flexible polymer tubing. A tube may comprise an outer diameter D2 (cf. FIG. 11) and generally the tubes comprised by the rotary valve 6 may comprise substantially the same outer diameter D2. The outer diameter D2 of the tubes may be in the range of 0.8 mm to 6 mm, preferably 1 mm to 5 mm, more preferably 1.6 mm to 3.2 mm (e.g. if 1/16 and ⅛ tubes are used, respectively).

Very generally, every tube may extend into the respective channel 619 it may be connected to. The inner diameter D1 of the channels 619 may be chosen, such that it is smaller than the outer diameter of the tubes D2 in an uncompressed state. Thus, when inserting tubes into the channels 619, i.e. the through bores, they may be squeezed to accommodate for the reduced diameter. Due to the squeezing of the tube, the outer surface of the tube may be pressed against the inner surface of the channel 619, which may provide a leak tight connection between the outer surface of the tube and the inner surface of the channel 619. In other words, the outer surface of the tube and the inner surface of the channel 619 may provide sealing surfaces and the squeezing of the tube due difference in diameter may provide the necessary sealing force. The inner diameter D1 of the channel 619 may be smaller than the outer diameter D2 of the tube by 0.01 mm to 0.5 mm, preferably 0.05 mm to 0.2 mm, such as 0.1 mm.

With reference to FIG. 12, an exemplary embodiment of a stator 61 with fitted tubes is illustrated. The upper panel shows a view of an exemplary gliding face 612 of the stator 61 and the lower panel shows a cross-sectional cut through the stator 61 and two of its channels 619 along the line indicated in the upper panel. In order to insert a tube into a channel 619 whose inner diameter D1 is smaller than the outer diameter D2 of the tube, the tube may be cut at an inclined angle and then guided through the channel 619. That is, the tube may be inserted at the connection face 611 and through the channel 619, such that the tube extends beyond the gliding face 612 of the stator 61. Once the tube is guided through (e.g. pulled through) to an extend that the tube within the channel 619 is not cut, i.e. the tube inside the channel 619 is fully intact, the portion of the tube that extends beyond the gliding face 612 of the stator 61 may be cut off such that the tube is flush with the gliding face 612. That is the tube may be cut such that it does no longer extend beyond the gliding surface 612 of the stator 61, but instead forms a single planar surface with the gliding surface 612 of the stator 61. In other words, an end face of each tube may form a planar surface with the gliding surface 612 of the stator 61.

Such a connection between the stator 61 and the tubing, particularly between each channel 619 and the corresponding tube may advantageously be significantly less complex than utilizing a fluid connector. Further it may also be less space demanding, allowing to reduce the rotary valve 6 in size and/or to accommodate more channels 619 in the stator 61. That is, in this embodiment (cf. in FIG. 12), the tubes extend into and through the complete length of the channel 619. Yet further it may allow for an essentially dead-volume free fluid connection between the tube and the channel.

Very generally the stator 61 and the rotor 62 may comprise polymer material, such as a thermoplastic or a thermosetting polymer including e.g. PEEK, polytetrafluorethylene (PTFE) or polyimide (PA).

With reference to FIGS. 13A to 13C (cf. also FIGS. 10A and 10B), a further embodiment of a stator 61 will be described. The stator 61 may comprise two portions, a first portion 613 and a second portion 614, wherein each portion may be shaped disc-like. The first portion 613 may comprise the connecting face 611 and a sealing face 615, and the second portion 614 may comprise the gliding face 612 and also a sealing face 616. Further the two portions may be connected to each other, such that the two sealing faces 615, 616 abut in a leak-tight manner. That is, the two portions 613, 614 may be combined and connected to form the stator 61, wherein the two sealing faces 615, 616 provide a leak-tight interface of the two portions 613, 614 of the stator 61. It will be understood that during operation of the valve, a rotor would be in contact with the gliding face 612 of the stator 61.

The first portion 613 generally corresponds to the stator 61 as previously discussed. That is, it comprises through bores for the channels 619, which comprise an inner diameter D1 that is smaller than the outer diameter D2 of the tubes. However, in the embodiment presently discussed, after inserting the tubes into the corresponding channels 619 and guiding (e.g. pulling) them through, they may be cut in such a way that they all protrude by substantially the same amount. For example, they may protrude from the sealing surface 615 by at least 0.5 mm to 5 mm, preferably at least 1 mm to 4 mm, more preferably at least 2 mm.

Furthermore, the first portion 613 may comprise additional fastening through bores for fastening means, preferably screws 617. The fastening through bores may comprise an inner diameter in the range of 1 mm to 5 mm, preferably in the range of 2 mm to 4 mm, such as 4 mm. In some embodiments, the fastening through bores may be threaded.

The second portion 614 may comprise fluid orifices 618 which may be aligned with the through bores for the tubes of the first portion 613 to form the respective channel 619. That is, when the first portion 613 and the second portion 614 are combined, i.e. connected to each other, the fluid orifices may align with the protruding tubes 66, such that a fluid may be guided from the tube into the fluid orifice 618 of the second portion 614 and vice versa. The fluid orifices 618 may extend through the second portion 614 such that they provide a fluidic connection to the gliding surface 612. Thus, a channel 619 of the stator 61 may be formed by the combination of a through bore in the first portion 613 and a respective fluid orifice 618 in the second portion 614.

Furthermore, the fluid orifices 618 may comprise a shoulder 6181 at the sealing face 616 of the second portion 614, as is depicted in FIG. 13C. That is, the fluid orifice 618 may comprise a first inner diameter D4 at the gliding face 612 and a second inner diameter D5 at the sealing face 616, wherein the inner diameter of the fluid orifice 618 may change in one step to form a shoulder 6181. The shoulder 6181 may be at a distance L1 to the sealing face 616, wherein the distance L1 may be in the range of 0.05 mm to 5 mm, preferably 0.1 mm to 2 mm, more preferably 0.5 mm to 1 mm. In other words, the depth of the shoulder 6181 with respect to the gliding surface 616 is given by the distance L1.

The first inner diameter D4 may generally be greater than the outer tube diameter D2 and therefore greater than the inner diameter D1 of the through bores in the first portion 613 of the stator 61. The inner diameter D4 may for example be in the range of 1 mm to 10 mm, preferably 1 mm to 5 mm, more preferably 1.5 mm to 3 mm.

The second inner diameter D5 of the fluid orifice 618 may be smaller than the first inner diameter D4. Generally, the second inner diameter D5 may be smaller than the outer diameter of the tube D2 and greater or equal to an inner diameter of the tube D3. The second inner diameter D5 of the fluid orifice 618 may for example be in the range of 0.3 mm to 5 mm, preferably 0.4 mm to 3 mm, more preferably 0.5 mm to 1.6 mm.

The second portion 614 may further comprise fastening orifices, which may be configured to complement the fastening through bores in the first portion 613 of the stator 61. That is, they may be oriented such that they align with the fastening through bores when the first portion 613 and the second portion 614 are combined (e.g. connected), in the same way that the through bores of the first portion 613 and the fluid orifices 618 of the second portion 614 may align to form the respective channel 619 when the two portions 613, 614 are combined. The fastening orifices may be configured to receive fastening means, e.g. screws, and further, the fastening orifices may be threaded.

The fastening orifices may comprise an inner diameter which is less than or equal to the inner diameter of the fastening through bores of the first portion. The inner diameter of the fastening orifices may be in the range of diameter in the range of 1 mm to 5 mm, preferably in the range of 2 mm to 4 mm, such as 4 mm. The fastening orifices may not go through the whole second portion 614 of the stator 61. That is, the fastening orifices may only provide an opening at the sealing face 616 and not at the gliding face 612.

Thus, a screw may for example run through a fastening through bore of the first portion 613 and be inserted into a fastening orifice of the second portion 614, where it may be fixed and held in place by means of a corresponding threading of the fastening orifice. Thus, the two portions 613, 614 of the stator 61 may be combined and pressed together by a force exerted by fastening means, e.g. screws, connecting the two portions. The force with which the two portions 613, 614 may be pressed together, e.g. the force exerted onto the two portions 613, 614 through the fastening means, may be such that the two sealing faces 615, 616 form a leak-tight interface. That is, any fluid that may flow through any of the through bores and/or fluid orifices 618, i.e. the channels 619, may substantially not leak into and/or through the leak-tight interface between the two sealing faces 615, 616.

Generally, during assembly, the tubes may initially protrude from the sealing surface 615 of the first portion 613 by more than the distance L1 of the shoulder 6181 from the sealing surface 616. In other words, the extent to which the tubes may extend beyond the sealing face 615 of the first portion 613 may generally be greater than the distance L1 of the shoulder 6181 from the sealing face 616 of the second portion 614.

Thus, when the two portions 613, 614 may be combined to form the stator 61, end faces of the tubes will be pressed against the shoulder 6181, particularly as the second inner diameter D5 of the fluid orifice 618 in the second portion 614 may generally be smaller than the outer diameter D2 of the tube. The friction forces exerted onto the tubes in the first portion 613 of the stator 61 due to the squeezing of the tubes may be smaller than the force exerted onto the end face of a tube when the two portion 613, 614 are combined. Thus, the tubes, which may initially protrude from the first portion 613 by more than the distance L1 of the shoulder 6181 from the sealing surface 616 may be pushed back through the through bore of the first portion 613 by an amount, required to establish the leak-tight interface between the two sealing faces 615, 616. This may advantageously ensure that the end face of each tube is pressed against the corresponding shoulder 6181 of the fluid orifice 618.

Therefore, the interface between the shoulder 6181 and the end face of the tube may advantageously provide an additional sealing mechanism which may lead to a better overall sealing of the tube to the respective channel 619. Further, in such an embodiment the tubes 618 and in particular the end faces thereof, may advantageously not be part of the gliding surface 612. That is, the gliding surface 612 may only comprise openings of the fluid orifices 618 and thus the corresponding channels 619. This may advantageously reduce the risk of frictional forces and/or leaks due to misaligned tubes at the gliding surface 612, e.g. slightly protruding tubes at the gliding surface 612.

It will be understood, that the combination of a through bore in the first portion 613 and the corresponding fluid orifice 618 in the second portion 614 of the stator 61 may constitute a channel 619. That is, when referring to a channel 619 said combination is meant.

Very generally the stator 61 may comprise a plurality of channels 619. In some embodiments, the plurality of channels 619 may be arranged on a circle. That is, all openings of the channels 619 may lie on a single circle on either face of the stator 61 (i.e. connection face 611 or gliding face 612), e.g. distributed equidistantly. The corresponding rotor 62 may comprise one or a plurality of grooves 623 configured to fluidically connect at least two channels 619 when stator 61 and rotor 62 assume a corresponding relative alignment. That is, it may depend on the position of the rotor 62 relative to the stator 61, if and when which channels 619 the at least one groove 623 in the rotor 62 fluidically connects.

It will be understood, that the word “tube”, may include any fluid conduit, e.g. capillaries, provided they comprise the necessary characteristics, e.g. compressibility for squeezing them into and through the channels.

In an alternate embodiment of the present invention, the fluid conduits connected to the stator 61 may be solid tubes, such as stainless steel tubes. In such an embodiment, the required compressibility for inserting the tube may be provided by the material of the stator 61. That is, instead of the fluidic conduit, the channel may be slightly broadened when pushing the solid tube into the channel 619 with sufficient force. The broadening of the channel 619 may be enabled through a stator 61 formed of a compressible material. Thus, again the inner surface of the channel 619 and the outer surface of the solid tube may form a leak-tight interface.

Generally, to aid with the insertion of a tube, the opening of a channel 619 on the connection face 611 of the stator 61 may be slightly tapered. That is, it may comprise an inner diameter slightly larger than D1, which consequently narrows down to the inner diameter D1 of the channel. Preferably, a length of the tapered portion of a channel 619 may at most constitute 10% of a total length of the channel 619.

With reference to FIG. 8 and FIGS. 10A and 10B, the rotary valve 6 may further comprise a plurality of guidance elements 67 for the stator 61, which may be configured to aid with the correct alignment of the stator with respect to the frame 63 (or housing 63) and further prevent any rotational movement of the stator 61. That is, the stator 61 may comprise a complementary borehole 671 (see FIGS. 10A and 10B) for each guidance element 67, such that the guidance elements 67 may be guided through the complementary borehole 671. Each guidance element may be mounted to the frame 63 (or housing 63) and extend from the front of the frame 63 in the direction of the back of the frame 63. Thus, the stator may be mounted in the frame by guiding it onto the guidance elements 67 which may only allow movement along the guidance elements 67, i.e. along an axis running from the front to the back of the frame 63, while preventing movement perpendicular to the guidance elements 67 and particularly any rotational movements of the stator. Furthermore, the guidance elements 67 may advantageously be utilized to mount the clamping plate 634 configured to receive the second end of the biasing element 64. Very generally, the guiding elements 67 may be screws 67 or (at least partially) threaded rods 67. Thus, the guiding elements may advantageously help with mounting and restraining the stator 61 as well as mounting the biasing element 64 in order to press the rotor 62 onto the stator 61. The diameter of the gliding face 621 of the rotor 62 may be chosen such that the rotor 62 may fit in between the guidance elements 67. That is, the circularly-shaped portion of the rotor 62 may generally comprise a smaller diameter than the stator 61 such that it may freely rotate, particularly without any hindrance through the guiding elements 67.

In some embodiments, the stator 61 may further comprise at least one centring orifice 681 (see, e.g., FIG. 10B) configured to receive a centring pin. Furthermore, the rotor 62 may comprise complementary centring grooves 682 (see, e.g., FIGS. 9A and 9B) configured to receive a portion of the centring pin. Therefore, the combination of centring orifice 681 and centring groove 682 may advantageously allow for correct alignment of stator and rotor with respect to each other. That is, a centring pin may be inserted into a respective centring orifice 681 such that it extends beyond the gliding face 612 of the stator 61. Consequently, the rotor may be mounted such that the centring pin is partially comprised by the respective centring groove 682. Thus, when at least two such centring orifices 681 and centring grooves 682 are present, an unambiguous positioning of the rotor 62 with respect to the stator 61 may be achieved, in particular if the centring orifices 681 and the respective centring groves 682 are not distributed equally along a circle defined by the circumference of the disc-like shaped portion of the rotor 62. In particular, this may be useful for alignment after exchanging or cleaning at least one of the components.

With reference to FIG. 14, the stator 62 may for example comprise 4 channels A, B, C, D and the rotor 62 may comprise two corresponding grooves G1, G2. In a first configuration I, the first groove G1 may for example connect channels A and B and the second groove G2 may for example connect channels C and D. In a second configuration II, e.g. if the rotor 62 is turned by 90°, the first groove G1 may fluidly connect channels B and C and the second groove G2 may fluidly connect channels D and A. Therefore, for example a 4/2-way valve may be realized.

Alternatively, the stator 61 may for example comprise a central channel in addition to a plurality of channels which may be arranged in a circle surrounding the central channel (cf. FIG. 7). The corresponding rotor 62 may for example comprise a single groove 623 configured to fluidly connect the central channel of the stator 61 to a selected channel on the circle surrounding the central channel. That is, the groove 623 may for example be oriented radially outwards from the centre of the rotor 62, comprising a length corresponding to the distance of the plurality of channels to the central channel. Thus, a multiport valve with a single fluid connection (i.e. 1 way) may be realized, which may for example comprise more than 10 or more than 20, in some embodiments more than 30 channels 619.

The valve assembly 50 may be fluidly connected to a collection unit 70. For example, a plurality of tubes, i.e. fluid conduits, comprised by (or connected to) the at least one distribution valve 51 may be fluidly connected to the collection unit 70. That is, for example a plurality of valve connections of the first distribution valve 51A and a plurality of valve connections of the second distribution valve 51B may be fluidly connected to the collection unit 70. Very generally, the collection unit 70 may be configured to collect beads and/or oligonucleotides, e.g. released from the synthesis unit 30 and guided to the collection unit 70 through the valve assembly 50. Furthermore, the collection unit 70 may also provide means to separate oligonucleotides from the respective beads, e.g. beads that were synthesised on.

That is, very generally, if a bead (e.g. with at least one oligonucleotide attached to it) is guided into the collection unit 70 it may be deposited in a well 721 comprised by a well plate 72. Each well 721 may comprise a filter material 722, for example at the bottom of the well, which filter material 722 may be configured to be permeable to fluids, i.e. liquid or gas, and small particles, e.g. oligonucleotides, but not to the beads.

Generally, the filter material 722 may be chosen to be resistant to the chemicals utilised in the system. In some embodiments, it may for example be formed of the same material as the well plate 72. In such instances, it may for example be integrally formed with the well plate 72. However, the filter material 722 may also be made of a different material than the well plate, e.g. a chemically more resistant material, such as glass fiber.

In some embodiments, the filter material 722 may be placed separately into each well 721 of the well plate 72 (as indicated in FIG. 15A). That is, for example at the bottom of each well 721, there may be a separate piece of filter material 722. The filter material may be secured (e.g. fixed) in the respective position. For example, a pressure stamp may be pressed into the well 721, which may be configured to deform a portion of the inner wall of the well close to the filter material such that the filter material may be clamped between the deformed portions of the inner wall of the well and for example a restriction or diminution at the bottom of the well. In particular, pressure may be applied for example through a pressure stamp which may be configured to scrape small portions of material off the side walls of the well and press them onto the outer portions of the filter material to clamp the filter material at the bottom of the well. In some embodiments, the filter material may instead be placed in the middle of, or within the lower half of the wells.

Alternatively, a mat of filter material 722 can be placed underneath the well plate 72, that is, at the downstream side of the well plate 72, wherein it may cover the bottom of each well of the well plate 72. In such embodiments, the mat of filter material may be applied such that the individual wells remain isolated from each other. The mat of filter material may for example be pressed onto the filter plate 72 in order to ensure that individual wells are fluidically separated from each other, i.e. not fluidly connected via the mat of filter material. Additionally or alternatively, the mat of filter material may be glued to the well plate or fused to the well plate utilizing heat, e.g. heat-sealed to the well plate, in order to isolate each well and avoid cross contamination between the wells 721. Again, in embodiments, wherein the filter material 722 is formed of the same material as the well plate 72, the filter material 722 may be formed integrally with the well plate 72, or formed separately and then added to the well plate as described above.

Thus, in general, each well may comprise a filter material, e.g. at the bottom of the well or in the middle or somewhere in between, wherein the filter material may for example be individually placed in each well or attached to the bottom of the wells, e.g. by means of a filter mat.

The filter material 721 may generally comprise a pore size, which may typically refer to the median of pore sizes of the filter material 721. The pore size may be from about 0.05 μm to about 200 μm, preferably from about 0.1 μm to about 20 μm. Typically, the filter material 722 may be a membrane. The filter material may be formed e.g. of PEEK, PTFE, ethylene tetrafluoroethylene (ETFE), polypropylene (PP), polyethylene (PE) or glass fiber.

The filter material 722 may for example be configured such that oligonucleotides may pass through the filter material 722, while beads may not pass through the filter material 722. This may be realized by choosing the pore size of the filter material 722 accordingly. Thus, oligonucleotides which are attached to a bead may not pass through the filter material 722 and be contained in the corresponding well 721 at least until they are released from the bead.

Thus, a desired number of beads and/or assembly of oligonucleotides may be collected in a well 721. This step may also be referred to as concentration or bead pooling. For example, all oligonucleotides required to synthesise a larger nucleic acid such as for example a gene, i.e. a portion of DNA, may be collected in a well 721 of the well plate 72.

Once all required beads comprising the respective oligonucleotides are collected in the respective well 721, the oligonucleotides may be separated from the beads and deprotected for further processing, e.g. enzymatic synthesis of nucleic acid molecules such as enzymatic gene assembly.

Typically, following synthesis, the oligonucleotides are cleaved off the synthesis support (e.g. bead) and treated to remove the protective groups on the bases and the cyanoethyl protecting groups from the phosphate backbone, which may generally also be referred to as cleavage and deprotection. Cleavage and deprotection may either be performed in two separate steps (cleavage followed by deprotection) or may be achieved in a single step. Cleavage and deprotection may be achieved by different means depending on the required conditions and the protective groups present. For example, gaseous amines such as ammonia or methylamine are routinely employed under pressure to achieve mild and rapid deprotection conditions. Alternatively, deprotection may be achieved utilizing aqueous solutions of methylamine and ammonium hydroxide. Furthermore, oligonucleotides are solvable in water, such that they may be immediately eluted from the support when using aqueous solutions. Thus, when applying a mixture of methylamine and water, the oligonucleotides may be separated from the respective support (e.g. beads) and subsequently be washed off, i.e. eluted, in a single step. Due to the configuration of the filter material 722, the beads may remain above the filter material 722 while eluted oligonucleotides may pass through the filter material 722, where they may be collected for further processing, e.g. gene assembly.

In some embodiments of the present invention a different method may be utilized for separating the oligonucleotides from the respective support (e.g. beads). In many instances nucleic acids synthesized on a solid support such as, e.g., a bead, may be physically coupled to the support by a linker. In certain exemplary embodiments, the linker, when present, may be a chemical entity that attaches the 3′-O of the nucleic acid molecule to the solid support (e.g., a functional group on a solid support). In other exemplary embodiments, the linker, when present, may have a structure such that it allows for attachment of other functionalities in addition to the 3′-O. Such linker structures are disclosed, for example, in U.S. Pat. No. 7,202,264, and may be used according to certain embodiments disclosed herein. In most cases, the linker will be stable to all the reagents used during nucleic acid molecule synthesis, but cleavable under specific conditions at the end of the synthesis process. One linker commonly used in nucleic acid molecule synthesis is the succinyl linker. Additionally, universal linkers such as e.g. a Unylinker™ (ChemGenes, Wilmington, Mass.) may be used for nucleic acid synthesis. A universal linker is a linker that allows for the synthesis of nucleic acids regardless of the nature of the 3′-terminal base of the first nucleotide. Different linkers with different properties are known to those skilled in the art and can be selected by the skilled person depending on the downstream process requirements.

For the complete removal of the linker and the 3′-terminal phosphate from the synthesized nucleic acid, some of the (universal) solid supports known in the art require gaseous ammonia, aqueous ammonium hydroxide, alcohols, aqueous methylamine or a mixture thereof. It has been found that in particular a mixture of methylamine and ethanol (e.g. a methylamine solution in 33% of ethanol as commercially available from SIGMA Aldrich; CAS Number 74-89-5) may be utilized, wherein this mixture does not contain water (or only a small amount thereof). Due to the lack of water, which elutes the oligonucleotides, application of this mixture may cleave the oligonucleotides off the support (e.g. beads) due to the methylamine. More specifically and without wishing to be bound by any theory, the methylamine is believed to act in a stepwise manner which includes 1) cleavage of the linker to release the oligonucleotide from the support, 2) deprotection of the nucleobases of the oligonucleotide, and 3) cleavage of the linker off the oligonucleotide, wherein step 3) is considered the last and rate-limiting step. However, upon cleavage the oligonucleotides may still stick to the support and/or the filter material 722 of the filter plate 72. That is, the oligonucleotides may remain attached to the support or filter material even though the molecular connection to the support (e.g. bead) may have been destroyed by the methylamine. In other words, the ethanol may not elute the oligonucleotides which therefore stick to the support or filter material and may not (or at least not substantially) be washed off by the methylamine-ethanol mixture. It will be understood that alternative organic solvents that do not readily dissolve/elute the oligonucleotides can be used instead of ethanol. To ensure that any residual water is removed, the support (e.g. collected beads) may be dried prior to the treatment with methylamine and ethanol as described above. Alternatively or in addition, the support may be dried by heating at a temperature of about 65-70° C. However, where no water is present, a drying step may not be required.

The oligonucleotides may consequently be eluted and washed off in a second step utilizing water or a suitable aqueous buffer (such as e.g. a Tris buffer). This may be advantageous, as the two-step process may allow to elute the oligonucleotides at a later stage of the process. For example, the well plate 72 may be moved after separating the oligonucleotides and prior to eluting them. Thus, the well plate 72 (and the oligonucleotides) may for example first be moved to a different apparatus, e.g. an apparatus for the gene assembly. For this purpose, the well plate 72 (hereinafter also referred to as “first compartment”) may be removed from the collection unit 70 and connected to, e.g. be put on top of, a second well plate (hereinafter also referred to as “second compartment”) to collect the pooled oligonucleotides in wells of the second well plate after elution. Therefore, this new two-step process may advantageously provide a great flexibility for separating and eluting the oligonucleotides from the support (e.g. beads).

Thus, in various aspects the current disclosure comprises a two-step method for processing nucleic acids such as oligonucleotides, wherein in a first step the nucleic acids are cleaved and deprotected in the presence of methylamine and an organic solvent and are eluted in a second step in the presence of an aqueous solution. With reference to FIGS. 15A and 15B an exemplary collection unit 70 is described. Very generally, a collection unit 70 may comprise an adapter plate 71, the well plate 72 and at least one sealing member 73. Further, the collection unit 70 may comprise a support element 74. The support element 74 may support the well plate 72. Furthermore, in the embodiments discussed herein, the support element 74 may also be configured to heat the wells and liquids contained therein. Thus, it may also be referred to as a heating element 74 or a heating block 74.

The well plate 72 may comprise at least one or a plurality of wells 721, wherein each well 721 may comprise a filter material 722 (e.g. positioned at the bottom or in the mid or lower portion of the well). The filter material 722 may be permeable to fluids and thus fluids may drain out of the bottom of the well 721, after being filtered by the filter material 722. Thus, when a fluid comprising beads is introduced to the well 721, the fluid may drain through the filter material 722 positioned in, or at the bottom of, the well 721, while the beads may remain above or within the filter material 722. That is, the filter material 722 may be configured such that beads cannot pass through, e.g. by choosing an appropriate pore size for the filter material 722. Furthermore, the filter material 722 may be configured such that oligonucleotides may pass through when eluted, e.g. detached from the beads and eluted in liquid. That is, the filter material 722 may be configured to allow for fluids and oligonucleotides to pass through the filter material 722, while beads may not pass through. In other words, the filter material 722 may be permeable to fluids and oligonucleotides. Furthermore, it may be configured such that a risk of clogging of the filter material with beads may be minimized, e.g. by comprising a high pore density. The filter material 722 may preferably be formed of a chemically inert material and may for example be a membrane.

The well plate 72 may for example be formed of polymer, such as a thermoplastic. Preferably the material may be chemically inert such as polyether ether ketone (PEEK), PP, PE or polyphenylene sulphide (PPS). In general, the well plate 72 may for example be manufactured by injection moulding or three-dimensional printing. Alternatively, well plates may be formed of aluminium or stainless steel, which may be advantageous for reusing the well plates 72 multiple times.

The individual wells 721 may be tapered, that is the diameter of the wells 721 on the top surface of the well plate 72 may be larger than the diameter of the bottom of the well 721. In some embodiments, the well plate 72 may be of rectangular shape and the wells 721 may be arranged in a periodic grid. The filter material 722 may be placed at the bottom of the wells 721 or may be placed at a position in the mid or lower part of the well such that a bead can securely occupy a well when the filter is present.

The well plate 72 may comprise a plurality of wells, such as 32 wells, 48 wells, 96 wells, 384 wells, or 1536 wells. Preferably, the well plate may comprise at least 48 wells, more preferably at least 96 wells.

Very generally, the well plate 72 may be an off-the shelf well filter plate, readily available for chemistry and biochemistry applications. That is, the well plate 72 may be a commercially available well filter plate, for example for use in a laboratory. Suitable well plates may be sourced from various providers including Povair, Millipore or PALL.

The adapter plate 71 may comprise at least one, or a plurality of fluid connectors 711, i.e. connection means for fluid conduits, e.g. tubes or capillaries. Said fluid connectors 711 may for example be sockets for receiving a complementary fluid connector attached to the end of a fluid conduit, or a fluid conduit itself. That is, the adapter plate 71 may be configured to be fluidically connected to a plurality of fluid conduits, for example for establishing a fluidic connection between adapter plate 71 and the valve assembly 30.

Generally, the adapter plate 71 may be configured to fluidly connect each fluid connector 711 to a different well 721 of the well plate 72. The number of fluid connectors 711 may be less than or equal to the number of wells 721 of the well plate 72. In other words, there may be one fluid connector 711 for each well 721 of the well plate 72, such that each well 721 may be connected to a separate fluid conduit, e.g. tube or capillary, or there may only be fluidic connections to a subset of the wells 721 of the well plate 72.

The adapter plate 71 may cover the whole width and/or length of the well plate 72. Well plate 72 may vary in form or shape. For a rectangular well plate 72, the length may correspond to the longer side of the rectangle and the width may correspond to the shorter side of the rectangle. Typically, the adapter plate 71 may cover the whole width, but not necessarily the whole length. That is, with reference to FIG. 15B, the well plate 72 may for example be of rectangular shape and comprise 96 wells which may be arranged in a grid of evenly spaced wells 721 such that the grid comprises 12×8 wells, wherein 12 denotes the number of wells 721 in the length direction and 8 denotes the number of wells in the width direction. That is, a cross section of the well plate 72 along its width may comprise 8 wells and a cross section of the well plate 72 along its length may comprise 12 wells. In such a case, the adapter plate 71 may for example comprise 5 rows of 8 fluid connectors 711, i.e. in total 40 fluid connectors 711, which may be arranged in a grid of 5×8 wherein 5 denotes the number of fluid connectors 711 in the length direction and 8 denotes the number of fluid connectors 711 in the width direction.

Again, the adapter plate 71 may be configured to guide the fluid of each fluid connector 711 to a separate, individual well. That is, when the collection unit 70 is assembled and in operation, each fluid connector 711 of the adapter plate 71 may be fluidly connected to a different well of the well plate 72.

The adapter plate 71 may for example comprise threaded fittings as fluid connectors 711 into which complementary fluid connectors may be inserted, e.g. fluid connectors mounted to the downstream end of a fluid conduit. The upstream end of said fluid conduit may for example be connected to the valve assembly 30, alternatively said fluid conduit may be comprised by a rotary valve 6 of the valve assembly 30 as described above.

Each of the fluid connectors 711, e.g. threaded fittings, may enable a fluid-tight connection of an attached fluid conduit to a corresponding fluid channel 712 guiding the fluid further downstream, through the adapter plate 71. The adapter plate 71 may comprise at least one extension 713, wherein the number of extensions 713 may preferably match the number of fluid connectors 711, here, the number of threaded fittings. Further, the extensions 713 may be arranged on a downstream side of the adapter plate 71, that is the opposite side to the side comprising the threaded connectors 711, where a fluid may be introduced to the adapter plate 71, i.e. the upstream side. Each extension 713 may be arranged opposite to a fluid connector 711 and may further comprise the fluid channel 712 connected to the respective fluid connector. Furthermore, the extension 713 may comprise an outlet for the fluid channel 712 at the downstream end of the extension 713, that is, the side furthest away from the fluid connector 711 of the adapter plate 71.

Thus, a fluid introduced to a fluid connector 711 of the adapter plate 71 may be guided through a fluid channel 712 to the outlet on the downstream side of the corresponding extension 713. When assembled, the extension 713 may reach into a well 721 and thus guide the fluid introduced at the fluid connector 711 into the well volume, where it may be exposed to the filter material 722 and any fluid passing through the filter material 722 may for example be guided into waste, e.g. a waste system, or collected for further processing as described elsewhere herein.

In an alternative embodiment, the adapter plate may be integrally formed with at least one distribution valve 51. In particular, the top side of the adapter plate 71 may be configured as a stator of the at least one distribution valve 51. That is, the top side of the adapter plate may comprise a plurality of channels instead of fluid connectors 711, which may preferably be arranged on a circle, similar to the stator 61 previously discussed with reference to FIGS. 10, 12 and 13. The circularly arranged channel openings on the side of the adapter plate (i.e. the upstream side) are connected to outlets on the downstream side of the adapter plate 71, e.g. outlets at the downstream side of corresponding extensions 713, which may be arranged or match the pattern of the wells of the well plate 72. Thus, the channels may be configured to fluidly connect circularly arranged channel openings (e.g. inlets) on the upstream side of the adapter plate 71 to outlets on the downstream side of the adapter plate 73. The adapter plate may further comprise a channel providing a fluid connection to a fluid source, e.g. the selection valve 52, which may preferably connect the fluid source to an opening that is located in the centre of the circularly arranged channels. The fluid connection to the fluid source may for example comprise a fluid connector and a tube. Alternatively, the fluid source may be centrally connected to the rotor 62. Thus, the groove of the rotor may be fluidly connected to a fluid source, e.g. the selection valve 52. It will be understood that the adapter plate may also comprise two or more stators 61 of rotary valves 6. For example, the stators 61 of the two distribution valves 51A and 51B of the valve assembly 50 may be integrally formed with the adapter plate 71.

Very generally an intrinsic combination of adapter plate 71 and stator 61 may advantageously reduce the required tubing and consequently the required connections which may be potential spots for a leak. Further, it may allow for a more compact and less complex overall design of the synthesis system 1.

Again with particular reference to the depicted embodiments, the adapter plate 71 may further be configured to be heated to a predetermined temperature. That is, the adapter plate 71 may for example comprise at least one heating element, which may for example be an electrical heating element, e.g. a resistance wire. This may be advantageous as chemical processes which may take place in the well plate 713 may require or benefit from an elevated temperature as described below. In some embodiments the adapter plate 71 may be formed of stainless steel, aluminium or another heat conductive material. The at least one heating element may for example be mounted in respective bores 715 within the adapter plate 71.

In some embodiments, the adapter plate 71 may further comprise at least one temperature sensor to measure the current temperature and provide a feedback to the at least one heating element. For example, a PID-controller may control the heating element to achieve a stable, pre-set temperature. For example, a temperature sensor may be placed in close vicinity to the at least one heating element, which may be beneficial to ensure that a maximum temperature is not exceeded. That is, the maximum temperature of the heating element may for example be limited based on a signal of a temperature sensor placed in close proximity of the heating element. The maximum temperature may for example be chosen such that the well plate 72, which may typically be formed of a polymer, is not damaged due to too high temperatures.

In some embodiments, the extensions 713 may be designed to reach far enough to the well 721 such that they may reach into a fluid comprised by the well 721, which may be advantageous for improving the heating efficiency and/or minimize the filling capacity.

Additionally or alternatively, the adapter plate 71 may comprise at least one temperature sensor configured to be located in one or more wells 721 of the well plate 72. That is, the at least one temperature sensor may be configured to provide a temperature which may at least approximate the process temperature, i.e. the temperature within the wells of the well plate. The at least one temperature sensor may be comprised by an extension, e.g. an extension 713, of the adapter plate 71 and preferably be configured to determine the temperature close to (or at) the downstream end of the extension, which may be configured to reach into a well of the well plate 72. Therefore, the temperature sensor may allow to determine or at least approximate the temperature within the respective well and thus the processing temperature, which may be relevant for chemical processes taking place within the wells of the well plate 72. In an embodiment of the adapter plate 71 comprising a plurality of extensions 713 as described above, one such extension may be fitted with a temperature sensor. For example, the fluid channel running through said extension may be adapted, e.g. widened, in order to accommodate a temperature sensor and/or the downstream end may be sealed.

It will be understood that in some instances a well in which a temperature sensor is located, e.g. through an extension of the adapter plate 72, may not be utilized for processing, i.e. it may not be filled with support structures (e.g. beads), oligonucleotides and/or processing chemicals.

In some embodiments, the adapter plate 71 may not comprise extensions 713, or merely an extension for a temperature sensor to be located inside a well 721 of the well plate. Thus, the outlet of the channels 712 running through the adapter plate 71 may in some embodiments be located directly at the downstream side of the adapter plate 71, without any extension from said surface. In such an embodiment, the fluid may simply drip and/or stream from the outlet into the well due to a pressure difference and/or gravity.

The at least one sealing member 73 may ensure a fluid-tight connection between the adapter plate 71 and the well plate 72, when the collection unit 70 is assembled and the parts are pressed together. That is, the sealing member 73 may seal the fluid connection between the adapter plate 71 and the well plate 72 when a corresponding force is applied, in particular the fluidic connection between each well 721 and the respective fluidic connection to the adapter plate 71. Thus, each well 721 may be fluidically separated from the other wells 721 and may only receive a fluid provided through the respective fluid connector 711 in the adapter plate 71. This may be advantageous as it may prevent any cross-contamination between neighbouring wells 721 in the well plate 72.

Furthermore, it may also ensure that a pressure applied through the fluid conduit connected to the adapter plate 71 may advantageously force any fluid within the well 721 through the filter material 722, if a pressure gradient is present across the filter material 722. Typically, the downstream side of the filter material 722 may be at atmospheric pressure, which may generally be lower than the pressure of a fluid supplied to the collection unit 70, e.g. from the fluid supply unit 10. Thus, a fluid in the well 721 may be guided through the filter material 722 without a need for applying a reduced pressure at the other side (i.e. downstream of the well plate 72) as a pressure difference may be established through the pressure of the applied fluid. This may be advantageous, as a vacuum pump, commonly utilized at the downstream side of the well plate to establish a pressure difference, may not be required which may render the system less complex. Further, it may also reduce the risk of creating a hazardous atmosphere, as fluids may gasify in reduced pressure environments.

Furthermore, the filter material 722 may be configured such that it is only permeable to fluids (and small enough particles) if a pressure difference is present across the filter material. Thus, if no pressure difference is present, a fluid in the well may at least substantially stay within the well 731 and for example not seep through the filter. Thus, a fluid may be contained in a well 721 for a prolonged amount of time, e.g. hours, which may be advantageous for slow chemical processes. Conditions with substantially no pressure difference may be established for example by disconnecting the fluid conduit from the fluid supply, e.g. by means of the valve assembly 50. Once any fluid flow into the well is stopped and the respective fluid conduit is disconnected from any pressurized source, the pressure in the well 721 may generally equilibrate to the pressure downstream of the filter material, e.g. to atmospheric pressure, such that no pressure difference is maintained across the filter material 722 and any fluid within the well is substantially contained until a new pressure difference across the filter material is established.

Alternatively, the filter material 722 may be configured such that it is generally permeable to fluids. That is, a fluid which is pipetted onto such a filter material 722 may flow and/or drain through the permeable filter material 722. However, since each well 721 may be sealed with respect to the adapter plate 71 by means of the at least one sealing element 73, no fluid may leak out of the sealed well 721 and through the filter material 722 as long as no fluid is supplied to the well 721. That is, for a fluid to leak through the filter material 722 a corresponding volume of fluid, e.g. air, must be supplied to the well so as to not create a negative pressure. Therefore, also for such a filter material 722 fluids may be contained in a well 721 for a prolonged amount of time, provided the well volume is sealed and no pressure difference is present and/or no further fluid is supplied through the respective fluid conduit connected to the well 721 via the adapter plate. That is, again the valve assembly 50 may assume a configuration wherein the respective fluid conduit is disconnected from the well 721, such that no further fluid may be supplied to the well Again, the well 721 may equilibrate to atmospheric pressure, such that no pressure difference is maintained across the filter material 722 and since no further fluid is supplied to the well, any remaining fluids may substantially be contained until a fluid is again supplied to the well and/or a pressure difference is established.

In other words, the sealing member 73 may be utilized to establish a fluid-tight connection between individual wells 721 and the adapter plate 71. In particular, it may level out unevenness of a top surface of the well plate 72 (i.e. the upstream surface of the well plate) and/or the bottom side of the adapter plate (i.e. the downstream side). This may be advantageous as it may allow a pressurized flow of fluid and to create a pressure drop across the filter material 722 of the well plate 72. That is, it may enable to maintain a pressure within the well volume. Further it may advantageously prevent any cross contamination between the individual wells 721 of the well plate 72, e.g. it may inhibit any spillage from one well to for example a neighbouring well. Yet further, it may also enable to prevent any uncontrolled flow of fluid, e.g. air, into the well and thus allow to contain a defined amount of fluid within the well for a predetermined period of time, e.g. hours, even if the filter material 722 is generally permeably to fluids, e.g. liquids. This may allow for volume- and time-controlled reaction conditions in the wells which may be advantageous e.g. to achieve (i) quantitative cleavage and deprotection of the oligonucleotides based on optimum incubation time and (ii) quantitative and concentrated elution of the cleaved oligonucleotides into a predetermined volume.

The sealing member 73 may for example be a sealing mat 731 comprising holes arranged to allow the adapter plate extensions 713 to pass through and/or to allow for a fluid provided at an outlet of a fluid channel 712 on the downstream side of the adapter plate 71 to flow/drip into the well below. That is, the sealing mat 731 may comprise substantially the same dimensions as the adapter plate 71 in the plane perpendicular to the flow direction. In other words, the sealing mat 713 may substantially completely cover the bottom side of the adapter plate 71 (i.e. the downstream side), except for the extensions 713 which may extend beyond the sealing mat 713 through appropriate orifices 732 and/or outlets of the fluid channels 712 on the downstream side of the adapter plate 71.

The sealing mat 731 may be formed of an elastic material. In some embodiments, the sealing mat 731 may for example be formed of foamed silicone, which may provide the advantage of being highly accessible and sufficiently durable for involved chemicals. Further, it may easily be exchangeable and/or replaceable, which may allow to ensure good sealing properties. In addition, such sealing mat 731 may be easily replaced if contaminated with beads, oligonucleotides and/or fluids, which may be harmful/detrimental to certain processing steps. For example, the sealing mat 731 may be regularly exchanged based on the number of uses, e.g. the sealing mat may be replaced every time the well plate and/or the microchip is exchanged, which may be after each synthesis run. Alternatively, it may for example be exchanged after every fifths or tenths run of the synthesiser system.

Alternatively, another material may be utilized, for example FFKM, i.e. perfluoroelastomer, e.g. Kalrez. FFKM may advantageously be highly durable and provide very good sealing properties. Thus, a sealing mat 731 manufactured from FFKM may not require replacing during normal operation.

The support element 74 (in these embodiments also referred to as heating block 74) may typically be located below the well plate 72 (i.e. spatially and/or with respect to the direction of flow), when the collection unit 70 is assembled. The heating block 74 may be configured to heat the well plate 72 to a predetermined temperature. When assembled, the well plate 72 may be placed on top of the heating block 74, which may therefore be configured to guide any fluid and/or material passing through the filter material 722 of the well plate 72 for example to a waste. Thus, the heating block 74 may for example comprise a fluid connection for each well 722, guiding the respective fluid and any comprised material through the heating block 74. Downstream of the heating block 74, the fluids and any comprised materials may be collected and for example guided to waste. The waste may generally collect fluids that are no longer required to allow for subsequent disposal thereof.

The heating block 74 may generally be formed out of metal or another thermally conductive material and may comprise at least one heating element, such as an electrical heating element, e.g. a resistance wire. The at least one heating element may be utilized to heat the heating block to a predetermined temperature. Furthermore, the heating block may comprise at least one temperature sensor for determining the temperature of the heating block 74. In some embodiments, the determined temperature may be utilized as a feedback signal to control the temperature of the heating block to establish a stable predetermined temperature, for example, by utilizing a PID controller. For example, a first temperature sensor may be located in close proximity to, e.g. directly at, the heating element in order to control/limit the temperature of the heating element to a maximum temperature value which may be chosen/defined based on the well plate 72 and particularly the well plate material, to ensure that the well plate is not damaged by the heat. Further, a second temperature sensor may be located inside a well and can be used to control the process temperature.

It will be understood, that heating the well plate 72 may for example be advantageous for chemical processes which may take place within the wells, e.g. the cleavage and deprotection of the oligonucleotides. Thus, generally the aim may be to heat the liquid in the well plate 72 to a desired temperature, which may be approximated by choosing an appropriate temperature of the heating block 74 and/or the adapter plate 71, which may in some embodiments also comprise at least one heating element.

For example, liquid in the well plate 72 may be heated to a temperature of at least about 40° C., at least about 50° C., at least about 65° C. or at least about 75° C. for about 60 min to about 360 min, preferably about 120 min to about 240 min, more preferably about 150 min to about 180 min to allow quantitative deprotection and cleavage of the oligonucleotides from the support (e.g. beads contained in the well plate 72). In one example, cleavage and deprotection may be conducted at a temperature between 65° C. and 75° C. for about 150 to 180 min.

In embodiments, a collection unit 70 may comprise both, a heatable adapter plate 71 as well as a heating block 74 to allow for heating of wells from below and above.

Generally, data and/or signals of the temperature sensors comprised by the adapter plate 71 and/or the heating block 74 may be combined for controlling the heating elements and particularly the processing temperature in the wells of the well plate 72. Again, n some embodiments, the adapter plate 71 may comprise a temperature sensor, which may for example be located at an extension 713 of the adapter plate 71. This may be particularly advantageous if the extension is configured such that it may reach into a well as it may provide a temperature reading which may generally be a good approximation of (e.g. substantially correspond to) the temperature in the well 722 and/or the processing temperature, particularly in the neighbouring wells, which may comprise support structures (e.g. beads), oligonucleotides and/or fluids.

Furthermore, the collection unit 70 may also comprise a connection mechanism 75, to hold the adapter plate 71 in place once pressed onto/in the direction of the well plate 72. For example, the adapter plate 71 in combination with the sealing mat 731 (i.e. the sealing member 73) may be pressed onto the well plate 72 to establish a leak tight connection and the connection mechanism 75 may be configured to restrain the corresponding parts of the collection unit 70 in a position, wherein the leak-tight interface between the adapter plate 71 and the well plate 72 may be maintained.

The connection mechanism 75 may comprise a plurality of fastening plates 751, which may be configured to be received by a respective locking portion 752 of the connection mechanism 75. That is, generally the fastening plates may be received in a corresponding locking portion 752 of the connection mechanism 75 which may be configured to lock the fastening plate 751 in a predetermined position. Once the fastening plate 751 is locked in the respective locking portion 752 it may remain locked until the locking portion 752 is manipulated, e g manually, to release the fastening plates 751. That is, the locking portion 752 may generally be configured to lock and release the respective fastening plate 751 deterministically. In some embodiments, the locking portion may be configured to automatically lock a fastening plate 751 inserted into the locking portion 752, while releasing the mechanism may require application of a force, e.g. manually, electrically or pneumatically.

That is, generally the locking portion 752 may comprise a mechanism to arrest the fastening plate 751 within the locking portion 752. The connection mechanism 75 may for example comprise locking pins or locking bolts that keep the adapter plate 71 in a fixed position, in which a fluid-tight connection may be established and maintained between the well plate 72 and the adapter plate 71. Alternatively, it may comprise a snap-on or latching mechanism, or a detent.

The fastening plates 751 may comprise an orifice, which may be configured to receive a portion of the locking portion 752. For example, the orifices may be configured to receive a locking pin or locking bolt. Such a locking pin or locking bolt may be spring-loaded, such that it may automatically arrest the fastening plate 751 in the corresponding locking portion 752 when inserted. That is when the fastening plate 751 is inserted into the locking portion 752, the locking pin or locking bolt may be retracted to allow insertion of the fastening plate 751, e.g. manually or due to a force applied through the fastening plate 751. However, when the orifice reaches the position of the spring-loaded locking pin or locking bolt, it may protrude into the orifice and thus lock the fastening plate 751 at a position predetermined by the position of the orifice in the fastening plate 751.

The fastening plates 751 may typically be mounted to the adapter plate 71, e.g. by fastening means such as screws. Particularly, the fastening plates 751 may be mounted to the sides of the adapter plate, that is outer portions of the adapter plate 71 in a direction generally perpendicular to the direction of flow. Very generally the fastening plates 751 may be arranged such that they extend beyond the adapter plate 71, in the direction of flow as well as perpendicular to the direction of flow. That is, the fastening plates may be arranged such that they do not interfere with the sealing member 73, the well plate 72 and/or the heating block 74 when assembled. Typically, the fastening plates 751 may extend in the direction of flow at least up to the heating block 74, when the collection unit 70 is assembled, i.e. a leak-tight connection is formed between the adapter plate 71, the sealing member 73 and the well plate 72. In some embodiments, the fastening plates 751 may be integrally formed with the adapter plate 71.

The fastening plates 751 and locking portion 752 may typically allow to release the adapter plate 71 and for example exchange or rearrange the well plate 72 and or the sealing member 73. That is, in general the collection unit 70 may allow for exchanging parts, such as the at least one sealing element 73 or the adapter plate 71, and in particular the well plate 72. In other words, the well plate 72 may be exchanged and/or its relative position to the adapter plate 71 may be altered. That is, in some embodiments the well plate 72 may for example provide a higher number of wells than the number of fluid connectors provided by the adapter plate 71 (cf. FIG. 15B). Thus, the relative position of well plate 72 and adapter plate 71 may be altered to utilize all wells of the well plate 72. Furthermore, the well plate 72 may be exchanged, for example a well plate 72 may be removed for further processing in a different apparatus and thus another well plate 72 may be installed.

It will be appreciated that the relative position between the well plate 72 and the adapter plate 71 may for example be altered by moving the adapter plate 71 and the respective locking portions 752, while the well plate 72 and the support element 74 remain in their respective position. Alternatively, the collection unit 70 may comprise locking portions 752 for different positions of the adapter plate 71, such that merely the adapter plate 71 may require repositioning in order to access all wells of the well plates. In such an embodiment, only a subset of locking portions 752 may be utilized to lock the fastening plates 751 and thus the adapter plate 71, wherein the subset depends on the position of the adapter plate 71.

FIG. 15B shows an assembled collection unit 70 according to the embodiment described above, wherein the adapter plate 71, the sealing member 73 (not shown) and the well plate 72 are sealingly connected. That is, they may form a leak-tight connection, which may be maintained by the connection mechanism 75 locking the fastening plates 751 within the locking portions 752.

An alternative embodiment of the collection unit 70 is discussed with reference to FIGS. 16A and 16B Again, the collection unit 70 may comprise an adapter plate 71, a well plate 72, at least one sealing element 73 and a support element 74 (which again, may also be referred to as a heating block 74).

Well plate 72 and/or support member 74 (i.e., heating block 74) may be as described for the previously discussed embodiment (cf. FIGS. 15A and 15B). However, in contrast to the above discussed embodiment, the adapter plate 71 may not comprise any fluid connectors 712. Instead, the adapter plate 71 may comprise at least one or a plurality of openings 714, each configured to guide a fluid conduit, e.g. a tube, from the top surface (i.e. upstream side) to a respective cavity 715. Furthermore, the adapter plate 71 may comprise an orifice 716 in the bottom surface for each cavity 715, wherein the orifice 716 extends from the bottom surface to the cavity 715 and wherein the inner diameter of the orifice 716 may be smaller than the diameter of the cavity 715. Thus, each opening 714 in the top surface may lead to a respective cavity 715 and further there may be an orifice 716 in the adapter plate 71 for each opening 714, extending between the cavity 715 and the bottom surface of the adapter plate 72. Preferably, the centre of the orifice 716 and the opening 714 from the top surface may be vertically aligned. Furthermore, they may also be aligned with the respective cavity 715.

Each cavity 715 may house a portion of a respective sealing extension 733. In the depicted embodiment, the sealing extensions 733 are cone shaped, and may also be referred to as conical stamps 733. Each conical stamp 733 may extend through the orifice 716 and beyond the bottom surface of the adapter plate 71. The circumference (and/or diameter) of each conical stamp 733 may decrease with increasing distance to the bottom surface of the adapter plate 71. In other words, each conical stamp 733 may generally be tapered, wherein the diameter may decrease in the downstream direction. Further, each conical stamp 733 may comprise an extension 7331 within the cavity 715 such that it may not entirely fit through the orifice 716, but instead be locked when the extension 7331 reaches the bottom of the cavity 715. Yet further, the cavity 715 may comprise a biasing element 717, such as a spring, configured to exert a force on the conical stamp 733 in the downstream direction. That is, the biasing element 717 may press the conical stamp 733 out of the cavity 715 until the extension 7331 of the conical stamp 733 prevents further movement out of the cavity 715. In other words, the conical stamps 733 may at least partially be pushed back into the cavity 715 provided the biasing force of the biasing element 717 is overcome, i.e. the conical stamps 733 may for example be spring-loaded.

It will be understood that instead of the extension 7331, the tapering of the conical stamp may be such that the upstream side of the conical stamp 733, i.e. the side within the cavity 715, comprises a diameter larger than the orifice 716, such that the conical stamp 733 cannot be completely pushed out of the cavity 715 through the orifice 716.

The conical stamps 733 may further be configured to be directly attached to a fluid conduit, e.g. a tube, made from an elastic (e.g. deformable) material such as e.g. silicone, PTFE, PEEK, PUN or perfluoroalkoxy (PFA). Each conical stamp 733 may comprise a channel 7332 extending to the downstream side, which may comprise a smaller diameter than the fluid conduit, such that the fluid conduit may be squeezed into the channel 7332, similarly to the tubes extending into the channels of the rotary valve 6 described above. That is, the tubes may be guided through the channels 7332 of the conical stamps 733 until they extend out of the downstream side of the conical stamps 733, i.e. the side in the direction of the wells 721 (when assembled). Subsequently the portions of the tubes extending out of the downstream side of the conical stamps 733 may be cut such that the end face of the tube and the downstream side of the conical stamp form a planar surface. Due to the reduced diameter of the channel compared to the outer diameter of the tube, the outer surface of the tube and the inner surface of the channel may be pressed together to form a substantially leak-tight interface. That is, the fluid conduit, e.g. tube, may form a fluid-tight connection to the conical stamp 733.

Again, the tube may alternatively be formed of a solid material, e.g. stainless steel, in which case the conical stamp may provide the elastic deformation required to fit the tube through the channel 7332 with reduced inner diameter compared to the outer diameter of the tube. It will be understood that such a configuration similarly allows for a fluid-tight connection.

Upstream of the channel 7332, there may also be a shoulder portion 7333, which may serve to aid with the insertion of a tube. That is, upstream of the channel 7332, there may be a passage 7334 which comprises an inner diameter that is larger than the outer diameter of the tube to be inserted, whereas downstream channel 7332 comprises an inner diameter that is smaller than the outer diameter of the tube to be fitted into the conical stamp 733. In other words, the inner diameter may change in the direction of flow, i.e. in the upstream to downstream direction, from the upstream passage 7334 to the downstream channel 7332, which are separated by a shoulder 7333. The change may be gradually, i.e. tapered, such that the inner diameter reduces Again, this may advantageously aid with the insertion of a tube into the conical stamp 733 in order to form a fluid-tight connection. In general, the conical stamp 733 may therefore also function as a connector and no additional fitting may be required, which may render the connection unit less complex.

The minimal diameter of the conical stamps 733 may be smaller than the maximum diameter of the wells 721 in the well plate 72, and the conical stamps 733 may, similarly to before, be arranged in a grid in line with the grid that the wells 721 are arranged in. Thus, when assembling the parts of the collection unit 70, the conical stamps 733 may be inserted into the wells 721 of the well plate 72 up to a point, where the diameter of the conical stamp 733 may be equal to the maximum diameter of the well 721 it is inserted into. This way, a fluid-tight connection may be established. That is, a cone-cone sealing may be established. Thus, the conical stamps 733 may be the at least one sealing member 73. Preferably the tapering of the conical stamps 733 is substantially identical to the tapering of the wells 721 in order to achieve a large contact surface between the conical stamp 733 and the well 721, i.e. a large sealing surface. That is, the rate of change of the outer diameter of the conical stamp 733 may be substantially identical to the rate of change of the inner diameter of the well 721.

When pressing the adapter plate 71 onto the well plate 72, a force may be exerted on each conical stamp 733 that may counteract the force exerted by the biasing elements 717 in the cavities 715. Thus, the conical stamps 733 may be able to move with respect to each other to accommodate for an uneven surface and other limitations of the well plate 72, e.g. due to the production of the well plate 72. That is, the biasing elements 717, e.g. springs, may enable to compensate for an uneven surface of the well plate 72 and advantageously enable an individual leak-tight connection between each conical stamp 733 and the respective well 721.

In particular, a conical stamp 733 that is in contact with the well plate 72 earlier than the remaining conical stamps 733 may experience a greater force than the other stamps 733 and may consequently retract further into the cavity 715 than the other conical stamps 733, such that every conical stamp 733 may establish a sealed, fluid-tight connection to the respective well 721.

In some embodiments, the cavities 715 may be interconnected, that is, there may be only one cavity 715 wherein a plurality of openings 714 may allow for fluid conduits to be inserted into the cavity 715 from the upper side (i.e. the upstream side) of the adapter plate 71 and wherein a plurality of orifices 716 may extend from the bottom surface of the adapter plate 71 (i.e. the downstream side) to the cavity 715, wherein the number of openings 714 may be equal to the number of orifices 716 and wherein the openings 714 and the orifices 716 may be vertically aligned with respect to each other, such that their centres may overlap. The biasing elements 717 and conical stamps 733 may be present for each pair of opening 714 and orifice 716 analogously to the description above.

This embodiment may be advantageous, as it does not require additional fittings or sealing elements made from specific materials. Thus, it may be less complex and more convenient to use while providing the same functionality as previously discussed embodiments. Further, it may also be more robust to errors and thus require less servicing time. In particular, the wear and tear of the at least one sealing element may be greatly reduced compared to for example a sealing mat 731 formed of foamed silicone, which may at least reduce the necessity of changing the at least one sealing element.

That is, fluid conduits, e.g. tubes or capillaries may be guided through the adapter plate 71 and be squeezed into biased, e.g. spring-loaded, conical stamps 733 to form a leak-tight connection thereto. When assembling the collection unit 70 the conical stamps 733 may be pressed into the wells 721 to provide a cone-cone sealing, while the biasing mechanism may level out any uneven surface of the well plate 72, e.g. due to fabrication uncertainties.

FIG. 16B shows an assembled collection unit 70 according to the above described embodiment, wherein the adapter plate 71 and thus the conical stamps 733 are pressed into the well plate 72 resting on a heating block 74 to form a leak-tight connection between fluid conduits (not shown) connected to the conical stamps 733 and the wells 721 of the well plate 72. All components of the collection unit 70 may be held in place by the connection mechanism 75 configured to maintain a leak-tight connection of the components by locking the fastening plates 751 attached (e.g. mounted) to the adapter plate 71.

FIG. 17A depicts an embodiment of a support element 74 of a collection unit 70, e.g. of a collection unit 70 as depicted in FIGS. 15A, 15B and 16A, 16B. The support element 74 may generally comprise at least one heating element 742, preferably a plurality of heating elements 742, which may each be located within a respective bore 743 in the support element 74 (particularly a main portion 740 of the support element 74) configured to host the respective heating element 742. The at least one heating element 742 may for example be a resistive heater providing an electrical resistance to an electric current. Additionally, the support element 74 may comprise at least one temperature sensor 744 configured to determine a temperature surrounding the temperature sensor 744, e.g. a temperature of the support element 74 or at least of a portion of the support element 74. Similar to the at least one heating element 742, the temperature sensor 744 may be hosted, i.e. located or placed within a respective bore in the support element 74. Thus, the support element 74 may be configured to be heated, e.g. controllably heated, and/or controlled to assume and/or maintain a desired temperature, e.g. through a feedback loop.

The support element 74 can comprise well plate sealing element 745, also referred to as well plate sealing component 745 or first sealing component 745 (i.e. an element or part configured for providing a sealing functionality) positioned on an upstream side of the support element 74 and towards a downstream side of the well plate 72, in other words between the main portion 740 of the support element 74 and the well plate 72. The first sealing component 745 may be configured to seal around nozzles of the well plate 72 (e.g. to level out irregularities of the well plate 72, which may result from moulding and the like) and/or may be configured to seal flat against the well plate 72. For example, the downstream side of the well plate 72, i.e. the side oriented towards the support element 72, may comprise a nozzle for each well and the well plate sealing element 745 may for example comprise holes fitting the nozzles to seal against or around each nozzle or alternatively comprise smaller holes and seal flat against the nozzles. However, other embodiments of the well plate 72 may comprises a substantially flat surface on the downstream side, e.g. a surface that is flat up to a point comprising manufacture uncertainties, and the well plate sealing element 745 may seal flat against the downstream side of the well plate.

This may advantageously prevent leakage or evaporation of vaporized chemicals and may allow to keep the (possibly gaseous reagents) inside a waste bin fluidly connected to the downstream side of the support element 74.

In some embodiments, the support element 74 may further comprise a sheet 746 configured to hold the well plate sealing element 745 in place. The sheet 746 may be mounted on top of the well plate sealing element 745, such that the sheet 746 is located more upstream than the well plate sealing element 745. Thus, the sealing component 745 may be located between the main portion 740 and the sheet 746 and therefore fixed by means of the sheet 746. In other words, a sheet 746, preferably made of metal, may be fixed on top of the first sealing component 745 to keep the first sealing component 745 in position.

With reference to FIG. 17B, embodiments of the collection unit 70 may further comprise a waste bin 76. The waste bin may generally be located below the support element 74 such that any fluid that is guided through the well plate 76 and the support element 74 may be collected in the waste bin 76 and/or disposed of by means of the waste bin 76, e.g. through a waste bin outlet 762 which may be connected to waste. That is, the waste bin outlet 762 may be configured to guide fluids collected in the waste bin to waste, e.g. to the waste system.

Generally, the waste bin 76 may comprise at least one waste bin chamber 761, configured to collect fluids at the downstream side of the support element 74, i.e. fluids that have been guided through the well plate 72 and the support element 74. Each of the at least one waste bin chamber 761 may be fluidly connected to a waste bin outlet 762, which may be configured to guide fluids from the at least one waste bin chamber 761 to waste.

In other words, the waste bin 76 may be positioned beneath the support element 74 to drain and dispose liquid (or more generally fluid) passing through the well plate 72. The waste bin 76 may preferably be made of material that is resistant to the applied chemicals and allows for isolation when heated. In some embodiments, the waste bin 76 may be made of PEEK.

The waste bin 76 may further comprise at least one flushing element 763 configured for flushing a cleaning reagent (e.g. a liquid or a gas) into the waste bin 76 and particularly the at least one waste bin chamber 761. That is, the at least one flushing element 763 may be configured to flush the waste bin 76 and more particularly the at least one waste bin chamber 761 with a fluid, e.g. a cleaning agent. It is preferred that the flushing element 763 is configured to guide the liquid or gas to inner walls of the waste bin 76, i.e. to an inner (circumferential) surface of the at least one waste bin chamber 761 that gets into contact with any fluids (and/or reagents) collected in the waste bin chamber 761. Thus, the flushing element 763 may be configured to clean the inner surface of the at least one waste bin chamber 761 or in other words the inner walls of the waste bin 76 that form the waste bin chamber 761. This may advantageously prevent (or avoid) depositing or sedimentation of any reagents (e.g. salt) on the inner surface, respectively within the waste bin chamber 761. This may be achieved by various means. In one example, the flushing element 763 may comprise drilling holes with outlets directed towards the inner surface of the wall of the waste bin, respectively to the inner surface of the waste bin chamber 761. The waste bin 76 may comprise at least one flushing inlet 764 configured to receive a fluid for flushing the waste bin or respectively the at least one waste bin chamber 761 and to guide the received fluid to a respective one of the at least one flushing element 763. For example, the flushing element 763 may comprise a frame-like structure that is configured to receive a fluid for flushing through a flushing inlet 764 comprised by the waste bin 76 and to distribute the fluid by guiding it through the frame-like structure and out of respective holes. The holes may be distributed (e.g. equally distributed) around the circumference of the frame-like structure to distribute the fluid around the entire flushing element 763. Advantageously an outer circumference of the at least one flushing element 763 matches an inner circumference of the respective at least one waste bin chamber 761.

Preferably the number of flushing elements 763 comprised by the waste bin matches the number of waste bin chambers 761 comprised by the waste bin. Furthermore, the waste bin preferably comprises a flushing inlet 764 for each waste bin chamber 761 and/or a waste bin outlet 762 for each waste bin chamber 761 (as illustrated in FIG. 17C).

Furthermore, the waste bin 76 may comprise fastening means, e.g. screws and respective bores, configured for mounting the waste bin to the downstream side of the support element 74.

In some embodiments, the waste bin 76 may be divided (i.e. it may comprise two or more separate waste bin chambers 761) as illustrated in FIG. 17B. This may be advantageous, if the adapter plate 71 is connected only to a selected portion of the well plate 72, e.g. multiwell filter plate. For example, if liquid or gas is pushed through selected positions of the well plate 72, the divided waste bin 76 prevents that gas or liquid is pushed from below the well plate 72 through the unused positions of the well plate 72 into the environment. If the waste bin 76 is divided, there may be a waste bin outlet 762 for each waste bin chamber 761. If a divided waste bin 76 is present, there may be a flushing element 763 for flushing and cleaning the waste bin 76 for each waste bin chamber 761 to prevent that fluid (e.g. gas) flows through channels of the flushing element 763 to the unused waste bin chambers 761. In some instances, there may be a pressure sensor to check the tightness of the collection unit 70 prior to each synthesis run.

With reference to FIG. 17C the waste bin 76 may be mounted to the downstream side of the support element 74, i.e. the side of the support element 74 opposite to the side connected to the well plate 72. For example, the waste bin 76 may be mounted to the support element 74 by means of fastening means, such as screws.

The collection unit 70 may further comprise a waste bin sealing element 77, also referred to as waste bin sealing component 77 or second sealing component 77. The waste bin sealing element 77 may be located between the waste bin and the support element and configured to seal a connection between the support element 74 and the waste bin 76. This may advantageously prevent fluids that are guided through the support element and/or into the waste bin to escape (e.g. leak or evaporate) from the waste bin 76 and particularly form the waste bin chambers 761.

In some embodiments, the collection unit 70 may further comprise a positioning element configured to aid with the positioning of the waste bin sealing element 77 relative to the waste bin 76 and/or the support element 74. In some embodiments the positioning element may further be configured to predetermine a compression of the waste bin sealing element 77 when the collection unit is in an assembled (i.e. mounted) state. Additionally or alternatively, the positioning element 78 may be configured for insulating the waste bin 76 from the support element 74, which may also be referred to as heating block 74 due to the heating elements 742 it may comprise.

Finally, the collection unit 70 may in some embodiments comprise a support element sealing component 79, also referred to as third sealing component 79 or support element sealing element 79. The support element sealing component 79 may comprise an aperture with dimensions corresponding at least to the dimension of the first sealing component 745 and/or the sheet 746 such that it fits around these elements. Therefore, the support element sealing component 79 may be configured to account for any leakage between the first sealing component 745 and the well plate 72. Thus, the support element sealing component 79 may advantageously provide an additional level of sealing in case the sealing between the first sealing component 745 and the well plate is not leak tight. The support element sealing component 79 may provide a seal for a connection or respectively an interface between the support element 74 and the well plate 72, e.g. an outer rim of the well plate 72.

In other words, in some instances, there may be a second sealing component 77 between the support element 74 and the waste bin 76 to further restrict evaporation or leakage of chemicals. In some embodiments there may be a third sealing element 79 to compensate for any leakage that may occur under exceptional circumstances at the first sealing component 745 positioned between the support element 74 and the well plate 72. Sealing components, respectively sealing elements may be formed of materials including silicone or ethylene propylene diene (EPDM), polytetrafluorethylene (PTFE) or perfluoroelastomeric (FFKM), or other suitable elastomers as described elsewhere herein. In some embodiments a positioning element 78 may be present to position the waste bin sealing component 77. In addition the positioning element 78 may also function to define the compression of the waste bin sealing component 77 and/or to provide further means of isolation of the heating block 74. In one example, the positioning element 78 may be formed of polyimide material.

With reference to FIG. 18, a system according to the present invention may comprise a fluid supply unit 10, a synthesis unit 30, a valve assembly 50 and a collection unit 70. Such a system may be utilized to synthesise, collect and process different oligonucleotides in a controlled and reproducible manner.

Very generally, a plurality of reagents may be provided to the synthesis unit 30 comprising the chip holder 32 and the microfluidic chip 31 through the first valve manifold 106A, which may selectively couple the reagents which may each be comprised in a fluid container 100.

It has further been found that the valve manifold 106/106A can be used to mix reagents before they are delivered to the synthesis unit 30. This may be advantageous where certain reagents are applied in combination to initiate a reaction in the synthesis unit 30. For example, during oligonucleotide synthesis activator reagent and phosphoramidites are mixed to allow activation of the phosphoramidites before they are contacted with deprotected base on the synthesis support. Likewise, Cap A and Cap B reagent used for capping of the oligonucleotides are mixed prior to delivery to the synthesis support. Efficient mixing of the respective fluids in the valve manifold 106/106A can be achieved by alternate injection through the inlets 1061 into the valve manifold by alternately opening and closing the corresponding coupling valves of the fluid containers 100 comprising the reagents to be mixed. It has been observed that efficient mixing of fluids in the valve manifold 106 may be achieved if the fluids are alternately supplied to the valve manifold 106/106A. In contrast, if the fluids enter the manifold concurrently, they may adopt a laminar flow and remain separate without getting mixed prior to reaching the synthesis unit 30. The opening time of a given valve to allow injection of a liquid may depend on the flow rate and thus, the pressure in the fluid container 100. For purpose of illustration only, in some instances a first valve of a first fluid container may be opened for a defined period of time to allow injection of a first fluid into the valve manifold. After the first valve is closed, a second valve of a second fluid container may be opened for a defined period of time to allow injection of a second liquid into the valve manifold. Efficient mixing of first and second fluids may be achieved by repeating the opening and closing of the valves of the respective fluid containers multiple times (e.g. 2 times, 3, times, 5, times, 10 times etc.). In general, valves may be opened for between about 100 ms and about 1 s, such as e.g. for about 500 ms. The opening time can further be used to regulate the ratio or concentration of fluids to be mixed. If a first valve is opened for 500 ms and then a second valve is opened for 300 ms, the second fluid will be present in the mixture at a lower concentration. By way of example, a 1:1 mixing ratio of activator and phosphoramidite would be achieved if the valves of the respective fluid containers would both be alternately opened for 300 ms. If activator is to be added at a higher concentration, 500 ms pulses could be used.

The microchip 31 within the chip holder 32 may comprise a plurality of wells, wherein each well may comprise a structure (e.g. a bead) for synthesising oligonucleotides on the surface thereof. Thus, by supplying the required fluids through the fluid supply unit and spatially controlling the synthesis conditions on the microfluidic chip 31, a plurality of different oligonucleotides may be deterministically synthesised.

Subsequently, synthesised oligonucleotides may be deterministically released from the synthesis unit 30, e.g. by applying a voltage or current to selected electrodes of the chip 31, and guided through the valve assembly 50 and ultimately to the collection unit 70. The valve assembly 50 may be configured to guide the oligonucleotides and the support structures (e.g. beads) they are typically still attached to, fully automatically to a desired well of the well plate 72 comprised by the collection unit 70. Thus, for example a desired combination or sub-population of different oligonucleotides synthesized on individual positions, e.g. individual synthesis spots (or beads in wells), on the microchip 31 may be collected within a well.

The collection unit 70 may further be configured to separate the oligonucleotides from the beads and to remove any protective groups from the phosphate backbone and bases as described above (cleavage and deprotection). The required fluids may be provided by a second valve manifold 106B of the fluid supply unit 10 (shown separately for clarity), which may be connected to the valve assembly 50, without the synthesis unit 30 being part of the fluid connection. This may be advantageous as some of the fluids may be detrimental to the synthesis unit 30 and/or processes therein. In addition, higher flow rates may be achieved (e.g. during washing steps) when bypassing the synthesis unit 30 which typically provides for a more restricted flow rate. Further, the valve assembly 50 may be configured such that it may supply fluids for cleavage and deprotection to one well 721 of the well plate 72, while guiding oligonucleotides released by the synthesis unit 30 simultaneously to another well 721 of the well plate 72. This may be advantageous as it may reduce the overall time required and thus increase the throughput of the system.

The entire system 1 may be sealed such that a pressure difference may be established between the fluid containers 100 of the fluid supply unit 10 and the downstream side of the filter material 722 comprised by each well 721 of the well plate 72. Generally, the pressure difference may be established by means of the gas supply 104, which may pressurize the fluid containers 100 within the fluid supply unit (as described above). Therefore, the fluids may be guided through the system 1 by relying on the pressure difference and no further pumps, e.g. vacuum pumps or fluid pumps, may be required, which may reduce the complexity and the footprint of the synthesis system 1. In addition, the sealed system may limit exposure to any toxic fumes or vapours that may be generated therein.

The gas supply 104 may further be fluidly connected to the valve assembly 50 and/or at least one of the valve manifolds 106A, 106B, which may advantageously enable the provision of gas, e.g. argon or N₂, to components of the synthesis system 1, e.g. the synthesis unit 30 or the collection unit 70. Furthermore, it may allow for purging fluid conduits within the system 1, e.g. for cleaning purposes.

It will be understood that the gas supply 104 and the two valve manifolds 106A, 106B may typically be comprised by the fluid supply unit 10 and are only shown as separate system portions for the sake of clarity.

Moreover, the synthesis system 1 may comprise at least one additional multiport valve 40, which may also be referred to as purge valve 40, in the fluid flow path between a valve manifold 106 of the fluid supply unit 10, e.g. the first valve manifold 106A, and the synthesis unit 10. The multiport valve 40 may comprise at least 3 valve connections, wherein one valve connection is connected to the first valve manifold 106A, one valve connection is connected to the synthesis unit 30 and one valve connection is connected to the waste, e.g. a waste system configured to collect the waste for the entire synthesis system 1. Thus, the multiport valve 40 may be configured to directly fluidly connect the valve manifold 106, e.g. the first valve manifold 106A, to the synthesis unit 30 and to directly fluidly connect the valve manifold 106 and/or the synthesis unit 30 to waste.

Preferably, the multiport valve 40 comprises 4 valve connections and two grooves, wherein the valve 40 is configured to assume two configurations, wherein in each configuration each groove directly fluidly connects two valve connections. That is, the multiport valve 40 may be as described with reference to FIG. 14. Particularly, it may be similar to the selection valve 52 described earlier with reference to FIG. 7. Preferably, two valve connections may be fluidly connected to waste, such that the multiport valve 40 may assume a first configuration wherein the valve manifold 106 is directly fluidly connected to the synthesis unit 30 and second configuration wherein the valve manifold 106 and the synthesis unit 30 are each connected to waste.

Therefore, the additional multiport valve 40 may advantageously allow to purge different fluidic paths of the system efficiently and guide the respective fluids utilized for purging to waste.

Generally, the additional multiport valve 40 may be a rotary valve 6 as described above. However, in some instances, the multiport valve 40 may be a 3/2-way valve.

In some embodiments, particularly if the fluid supply unit 10 only comprises a single valve manifold 106, the multiport valve may also comprise a valve connection fluidly connected to the valve assembly 50 without first passing through the synthesis unit 30. That is, the multiport valve 40 may be configured to guide a fluid from the fluid supply unit 10, e.g. the valve manifold 106, to the valve assembly without the fluid passing through the synthesis unit 30.

The system may comprise a controller (not shown) configured to control and/or operate the system. In particular, the controller may be operatively connected to components of the system. That is, the controller may send and/or receive electrical signals to/from the connected components. For example, the controller may be operatively connected to the fluid supply unit 10, such that it may send instructions for supply of fluids, e.g. signals for controlling valves of the fluid supply unit, and/or receive signals of sensors, e.g. pressure and/or flow sensors. Similarly, the controller may operatively be connected to the valve assembly 50 and/or the purge valve 40 to control and/or read out the valve configurations. Furthermore, the controller may be operatively connected to the synthesis unit 30 and particularly to the microfluidic chip comprised by the synthesis unit, e.g. to apply potentials across the electrodes of the microchip and thereby at least partially control synthesizing nucleic acids and releasing synthesized nucleic acids (e.g. in concert with controlling the supplied fluids).

The controller may comprise a data processing unit and may be configured to control the system and carry out particular method steps. The controller may comprise a microprocessor and may be contained on an integrated-circuit chip. In particular, the controller may include a processor with memory and associated circuits. A microprocessor is a computer processor that incorporates the functions of a central processing unit on a single integrated circuit (IC), or sometimes up to a plurality of integrated circuits, such as 8 integrated circuits. The microprocessor may be a multipurpose, clock driven, register based, digital integrated circuit that accepts binary data as input, processes it according to instructions stored in its memory and provides results (also in binary form) as output. Microprocessors may contain both combinational logic and sequential digital logic. Microprocessors operate on numbers and symbols represented in the binary number system.

Generally, the present invention may further comprise a computer program product comprising instructions for carrying out at least some method steps. The computer program product may be comprised by the controller. More precisely, the computer program product may be stored on a computer readable medium, which may be accessible to or comprised by the controller.

Thus, when executed by the controller, the instructions comprised by the computer program product may cause the controller to carry out at least some of the herein described method steps.

In particular, the controller and or the separate processing unit may be accessible through a user interface, e.g. comprising a screen, and an input device such as a keyboard and/or a mouse. Alternatively or additionally the screen may be a touch screen.

In particular, the computer program product may comprise a user guided synthesis procedure that enables a user with means for starting and/or performing synthesising nucleic acids on the microfluidic chip and optionally also further method steps such as selectively releasing synthesised nucleic acids from the microfluidic chip, particularly selectively releasing synthesis supports carrying nucleic acids from the microfluidic chip (e.g. bead lifting), as well as post-processing (e.g. cleavage and deprotection) of nucleic acids collected in the collection unit.

Such a synthesis procedure for synthesising nucleic acids may comprise insertion (or replacement) of a microfluidic chip into the synthesis unit of the system, e.g. into a chip holder comprised thereby. That is, the user may manually insert a respective microfluidic chip into the synthesis unit. In some instances the computer program product may prompt the user to insert the microfluidic chip and/or provide guidance for the user. Subsequently, the user may choose a desired process to be run on the system or parts thereof. Such processes may for example include synthesis of nucleic acids, releasing synthesis supports from the microfluidic chip, post processing nucleic acids, e.g. cleavage and deprotection, and/or an automated cleaning of the system.

Furthermore, the synthesis procedure may for example comprise a checking of the system flow paths, particularly a check for any leaks or blockages in the system flow path. Such a check may be performed by pressurizing a respective flow path with a fluid and monitoring the pressure drop in the flow path. Such a check may also reveal if a flow path is blocked.

More generally, the synthesis procedure may comprise an automated pressure test for the tightness of the system, wherein the tightness of the system components and flow paths therebetween, i.e. fluidic connections therebetween, may automatically be tested by pressurizing the system and monitoring signals of respective pressure sensors. This may enable to detect any unexpected pressure drop which may indicate a leak.

Furthermore, the synthesis procedure may comprise the user or system scanning the chip holder, the microfluidic chip and/or the well plate to automatically download relevant synthesis data for synthesising nucleic acids and/or lifting data for releasing synthesis supports (e.g. synthesis supports such as beads). Scanning the respective components may refer to scanning a code such as a bar code or QR code on the respective components. That is, by scanning the respective system components, corresponding data designated for using these components may automatically be retrieved from a data base, e.g. a manufacturing execution system (IVIES) server. The data may also comprise respective protocols for synthesising the nucleic acids and/or releasing synthesis supports from the microfluidic chip. Alternatively, the user may for example choose synthesis data, lifting data and/or corresponding protocols from a database.

Furthermore, the synthesis procedure may comprise calculating an expected fluid consumption based on the synthesis data, the lifting data and/or the protocols. In particular, the synthesis procedure may comprise calculating an expected reagent consumption based on the synthesis data and the respective protocol for synthesising nucleic acids. Based on the expected fluid and/or reagent consumption the system may for example check if the actual consumption matches the expected consumption and/or indicate if the supplies comprised by the system suffice for performing the designated protocols or whether for example fluid reservoirs of the fluid supply system need to be replenished. The expected fluid and/or reagent consumption may also be indicated to the user, e.g. via the user interface, such that the user may check whether the required fluids and/or reagents are present before starting a chosen process.

Furthermore, the synthesis procedure may comprise displaying information to a user during the process, particularly during synthesis, releasing of synthesis support, e.g. bead lifting, and/or post processing of nucleic acids, e.g. cleavage and deprotection.

The displayed information may for example include runtime information, which may for example concern the runtime of single commands, sub-cycles of a running process and/or the overall process.

The displayed information may comprise a status of the microfluidic chip and for example the well positions selected for the actual synthesis step and/or for the step of releasing the synthesis supports, e.g. the selected electrodes and/or the potential applied thereto.

Similarly, the displayed information may comprise a status of the chip power supply, i.e. the power supply connected to the microfluidic chip. Such status information may for example comprise current, voltage and/or charge for the actual synthesis and/or for the step of releasing the synthesis supports.

Furthermore, the information may comprise sensor readings, e.g. pressures, temperatures and/or flow rates within the system, e.g. the fluid supply system, the synthesis unit, or the collection unit.

Additionally the synthesis procedure may also comprise a post process. The post process may for example comprise confirmation of sensor readings, preferably all sensor readings, and check of the reagent and/or fluid consumption. Furthermore, the post process may comprise creating a final report. The final report may for example comprise any problems/issues detected prior to, during or after the process and/or summarise the applied procedures. That is, the final report may for example comprise warnings and errors that occurred during the process, the name of the user, the name of the protocol used for the process and/or the synthesis and/or lifting data.

The computer program product may for example also comprise instructions for a supply pressure test as a separate procedure or module, wherein the fluid supply system and particularly separate strands of the fluid supply system may be leak tested. Each strand of the fluid supply system may be configured to provide a different reagent, i.e. each strand may be linked to and comprise a different fluid container. The leak testing may be performed by monitoring a pressure in the tested strand for a pressure drop over time, which may indicate a leak and potentially a leak rate. This may, e.g., be displayed to a user who can then decide how to proceed.

Similarly, the computer program product may also comprise instructions for a system pressure test as a separate procedure or module, wherein flow paths of the system, preferably all flow paths of the system, may be tested for leaks. Each strand of the fluid supply system may be configured to provide a different reagent, i.e. each strand may be linked to and comprise a different fluid container. Again, the leak testing may be performed via monitoring pressure measured by one or more pressure sensors of the system to detect a pressure drop over time.

Similarly, the computer program product may also comprise instructions for an automatic system cleaning as a separate procedure or module. The automatic system cleaning may comprise cleaning substantially all tubing of the system downstream of the fluid supply system. In some embodiments, the automatic cleaning may comprise cleaning all tubing and fluid containers.

Similarly, the computer program product may also comprise instructions for a fluid container change procedure or module. The fluid container change procedure may support a user during changing of one or more fluid containers of the fluid supply system. The fluid container change procedure may particularly aid the user with changing fluid containers comprising amidites, e.g. phosphoramidites or nucleobases such as cytosine, guanine, adenine, thymine and/or uracil. Amidites and/or nucleobases may be provided as powder and may be mixed with acetonitrile within the fluid supply system, i.e. in the fluid container. Thus, the fluid container change procedure may comprise mixing the powder with acetonitrile once the fluid container is placed in the fluid supply system and for example providing gas to the fluid container to create bubbles within the fluid container, which may advantageously aid with mixing.

Further, the computer program product may also comprise instructions for event handling, e g a module for event handling, wherein event handling may comprise tracking events during operation of the system. For example, event handling may track standard events such as parameter changes, user logins or the like. Further, event handling may track warning events, which may particularly comprise warnings relating to pressure drop, flow rate issues, e.g. deviations from an expected/desired flow rate, and/or anomalies of the chip power supply during synthesis and/or releasing of synthesis supports. Additionally, event handling may track error events which may comprise errors due to over pressure (i.e. too high pressure) in a part of the system, leaks, errors of the microfluidic chip etc.

Furthermore, event handling may be configured to automatically send messages, e.g. emails, for certain events, like warning events and/or error events. For example, the event handling may send messages to an operator or to maintenance, depending on the cause for the message.

Further, the computer program product may also comprise instructions for user management, e.g. a module for user management, wherein user management may allow for managing users and user information, such as passwords, and adjusting respective rights of users. In particular, user management may allow for managing over 25 different system rights separately for each user. System rights may for example comprise the right to start certain processes on the system or change certain parameters or parameter clusters.

Further, the computer program product may also comprise instructions for a backup (e.g. a backup module), wherein a backup may allow to load and safe parameter sets, e.g. locally or on a remote server.

Further, the computer program product may also comprise instructions for adjusting system parameters (e.g. a parameter module), wherein adjusting system parameters may comprise adjusting controller parameters, e.g. programmable logic controller parameters. Such controller parameters may for example comprise system time, IP address, etc. Furthermore, a wide variety of system parameters may be adjusted, e.g. more than 400 system parameters, which may for example relate to maintenance, certain system processes, a fluid container change, valves of the system, e.g. rotary valves, the synthesis unit and particularly the microfluidic chip, the chip power supply, internet connectivity, e.g. settings relating to HTTP, email, fluid supply system, e.g. reagents supply, filter for the synthesis support release, waste, reagents, fluidics, sensors such as pressure sensors or flow sensors, e.g. flow meters, a spectrometer, heating, etc.

Furthermore, the computer program product may also comprise instructions for non-automatic operation of the system, e.g. a non-automatic operation module. Non-automatic operation may enable an operator of the system, e.g. a user of the system, to interact with the system and its components outside of an automated procedure or process. For example, non-automatic operation may enable interaction with the synthesis unit and particularly the microfluidic chip, and/or with the chip power supply. Similarly non-automatic operation may enable checking of connection to the internet (e.g. via HTTP) or email systems, signal lights that may indicate information to a user, and/or a relay output.

For example, if a HTTP protocol is used to communicate with a manufacturing execution system (IVIES), the use can verify by non-automatic operation which data have been sent to or received by the MES.

Similarly, it may enable checking of the reagent supply, which may for example comprise checking the status of the safety housing comprising fluid containers, valves, the gas distribution unit, pressure regulators and/or pressure sensors.

Further, non-automatic operation may comprise manually switching valves, that is manually changing the configuration of a valve. It will be understood that the term “manually” in this context refers to without utilizing an automated process, i e manual operation refers to non-automatic operation and the term “manually” is to be understood as “non-automatically”. That is, the configuration may still be changed via an electric signal of the controller and the term manually merely refers to a user (or operator) “manually” sending the signal, e g utilizing the computer program product. That is, the user may for example click on a respective button on a user interface.

Non-automatic operation may further comprise interacting with waste and components thereof, i.e. non-automated operation of all components relevant for waste, including valves and pressure and/or level sensor.

Non-automatic operation may further comprise non-automatic operation of the barcode scanner.

Non-automatic operation may also comprise manually altering parameters of and/or accessing information on components related to heating of the collection unit.

Furthermore, the computer program product may also comprise instructions for a log system (e.g. a log module), wherein the log system may enable individualised logging for system components, for example to generate maintenance intervals for the respective components.

The computer program product may also comprise instructions for monitoring of hardware and controller inputs and outputs, e.g. a monitoring module. In particular monitoring may comprise monitoring that the controller, such as the PLC modules, is working correctly and monitoring the inputs and outputs of the controller, e.g. the PLC modules. For example, the user interface may display respective information to the user.

The computer program product may also comprise instructions for data handling (e g a data module), wherein data handling may comprise transferring data between the system and external data systems, e.g. a USB-Stick, an external hard drive or a network storage.

The computer program product may also comprise instructions for diagnosis (e.g. a diagnosis module), wherein diagnosis may comprise saving and/or showing communication logs, wherein communication between the controller and the microfluidic chip and/or the controller and the power supply is saved.

The computer program product may also comprise instructions for creating statistics, e.g. a statistics module, for creating statistical data concerning the system lifetime.

The computer program product may further comprise instructions for sampling sensor measurements or system parameters to generate respective traces, e.g. a sampling module. This may allow to plot graphs of different sensor measurements or system parameters. For example, the current, voltage and/or charge of the chip power supply may be sampled, an absorption of a spectrometer may be sampled, a temperature of the collection unit may be sampled, and/or a temperature of the safety housing and/or the instrument surrounding may be sampled.

Whenever a relative term, such as “about”, “substantially” or “approximately” is used in this specification, such a term should also be construed to also include the exact term. That is, e.g., “substantially straight” should be construed to also include “(exactly) straight”, and, e.g., “about 20 N” should be construed to also include “(exactly) 20 N”.

Whenever steps were recited in the above or also in the appended claims, it should be noted that the order in which the steps are recited in this text may be accidental. That is, unless otherwise specified or unless clear to the skilled person, the order in which steps are recited may be accidental. That is, when the present document states, e.g., that a method comprises steps (A) and (B), this does not necessarily mean that step (A) precedes step (B), but it is also possible that step (A) is performed (at least partly) simultaneously with step (B) or that step (B) precedes step (A). Furthermore, when a step (X) is said to precede another step (Z), this does not imply that there is no step between steps (X) and (Z). That is, step (X) preceding step (Z) encompasses the situation that step (X) is performed directly before step (Z), but also the situation that (X) is performed before one or more steps (Y1), . . . , followed by step (Z). Corresponding considerations apply when terms like “after” or “before” are used.

While in the above, a preferred embodiment has been described with reference to the accompanying drawings, the skilled person will understand that this embodiment was provided for illustrative purpose only and should by no means be construed to limit the scope of the present invention, which is defined by the claims.

1. A chip holder, comprising:
a body;
a cover plate;
a chip cover;
a chip receiving section, configured to accommodate a microfluidic chip;
a sealing mechanism configured to maintain a leak-tight connection between the microfluidic chip and the chip cover; and
a connecting mechanism configured to establish an electrical connection between a plurality of electrical contacts comprised by the microfluidic chip and corresponding electrical contacts comprised by the chip holder, and
wherein the connecting mechanism is independent of the sealing mechanism.

2. (canceled)

3. The chip holder according to claim 1, wherein the chip holder is configured to assume a configuration wherein at least a portion of the cover plate is located above a portion of the chip receiving section; and
wherein the chip holder is configured to assume a configuration wherein the microfluidic chip, the chip cover, the sealing element and the cover plate are aligned with respect to each other, such that by applying a force to the cover plate, that is directed towards the chip receiving section, the chip holder may be brought into a sealing position wherein a leak-tight connection is established between the chip cover and the microfluidic chip.

4. The chip holder according to claim 1, wherein the sealing mechanism is configured to provide a sealing force to the cover plate in the sealing position.

5. The chip holder according to claim 3, wherein the chip holder is further configured to provide a fluid connection to a volume between the chip surface and the chip cover when the cover plate is in the sealing position.

6. The chip holder according to claim 1, wherein the chip holder further comprises any one or more of:
(a) at least one alignment aid, configured to align the microfluidic chip within the chip holder,
(b) a cover mount, configured to receive the chip cover and (i) align the chip cover within the chip holder, (ii) fix the chip cover within the chip holder, or both (i) and (ii), wherein the cover mount is configured to be attached to the cover plate,
(c) a locking mechanism comprising at least one locking device configured to lock the cover plate in an elevated position, wherein in the elevated position no leak-tight connection between the chip cover and the microfluidic chip is provided.

7. (canceled)

8. (canceled)

9. (canceled)

10. (canceled)

11. (canceled)

12. (canceled)

13. (canceled)

14. (canceled)

15. A collection unit configured to collect nucleic acids, comprising:
an adapter plate, configured to be connected with a plurality of fluid tubes; and
a well plate, comprising a plurality of wells;
wherein the collection unit is configured to maintain a connection between the adapter plate and the well plate; and
wherein the collection unit further comprises a connection mechanism, wherein the connection mechanism is configured to connect the adapter plate and the well plate such that the connection therebetween is maintained.

16. The collection unit according to claim 15, wherein each well comprises a filter material.

17. (canceled)

18. The collection unit according to claim 15, wherein the adapter plate comprises a plurality of channels for guiding a fluid through the adapter plate, wherein the fluid is guided in the direction of the well plate.

19. The collection unit according to claim 15, wherein the collection unit further comprises at least one sealing member.

20. The collection unit according to claim 19, wherein the at least one sealing member is a plurality of sealing members, and wherein each sealing member comprises a sealing extension, wherein each sealing extension is configured to extend into a respective well and to seal against the respective well, optionally wherein each sealing member comprises a biasing element biasing the respective sealing extension towards the respective well.

21. (canceled)

22. The collection unit according to claim 18, wherein each of the plurality of fluid tubes is received (i) in a respective channel of the adapter plate, (ii) in a respective channel of the sealing extension, or both (i) and (ii), and wherein at least a portion of the respective channel of the adapter plate and/or the sealing extension comprises an inner diameter that is smaller than an outer diameter of the respective uncompressed tube.

23. The collection unit according to claim 15, wherein the collection unit comprises at least one heating element configured to heat at least a portion of the collection unit.

24. The collection unit according to claim 15, wherein
(a) the connection mechanism is further configured for providing a plate sealing force that establishes the connection between the adapter plate and the well plate and
wherein the connection mechanism comprises an electric or pneumatic actor configured to apply the plate sealing force configured to establish the connection between the adapter plate and the well plate,
(b) wherein the collection unit further comprises a waste bin that
comprises at least one waste bin chamber configured to collect fluids passing though the well plate and/or the support element, and optionally wherein the waste bin further comprises at least one flushing element configured for flushing the at least one waste bin chamber with a fluid, or
both (a) and (b).

25. (canceled)

26. A system, comprising:
a fluid supply unit;
a synthesis unit comprising a microfluidic chip, configured for the synthesis of nucleic acids;
a valve assembly, comprising at least one multiport valve; and
a collection unit configured to collect nucleic acids;
wherein the valve assembly is configured to direct fluid between
the synthesis unit and the collection unit,
the fluid supply unit and the synthesis unit, and
the fluid supply unit and the collection unit.

27. The system according to claim 26, wherein the valve assembly is configured to establish two fluid streams between fluid connections of the valve assembly without the two fluid streams coming into contact.

28. The system according to claim 26, wherein the system comprises a gas distribution unit and wherein the gas distribution unit comprises an inlet configured to receive a gas;
at least one outlet; and
at least one valve;
wherein the gas distribution unit is configured to supply the gas at the at least one outlet at a predetermined pressure.

29. The system according to claim 26, wherein the fluid supply unit comprises:
a plurality of fluid containers each configured to store a fluid;
a gas supply, configured to provide a gas at a controlled pressure through at least one outlet; and
at least one valve manifold comprising a plurality of inlets and an outlet, wherein each of the at least one valve manifold is configured to selectively fluidly connect at least one inlet to the outlet.

30. The system according to claim 29, wherein the gas supply comprises a gas reservoir configured to provide a gas and the gas distribution unit

31. The system according to claim 26, wherein the system further comprises a chip holder, comprising:
a body;
a cover plate;
a chip cover;
a chip receiving section, configured to accommodate a microfluidic chip;
a sealing mechanism configured to maintain a leak-tight connection between the microfluidic chip and the chip cover; and
a connecting mechanism configured to establish an electrical connection between a plurality of electrical contacts comprised by the microfluidic chip and corresponding electrical contacts comprised by the chip holder, and
wherein the connecting mechanism is independent of the sealing mechanism.

32. The system according to claim 26, wherein the at least one multiport valve comprises a rotary valve, the rotary valve comprising:
a stator comprising a plurality of channels; and
a rotor comprising at least one groove;
a plurality of tubes, wherein each tube extends into a channel, respectively;
wherein the rotary valve is configured such that the at least one groove can fluidly connect the channels.

33. The system according to claim 26, wherein the collection unit
comprises:
an adapter plate, configured to be connected with a plurality of fluid tubes; and
a well plate, comprising a plurality of wells;
wherein the collection unit is configured to maintain a connection between the adapter plate and the well plate; and
wherein the collection unit further comprises a connection mechanism, wherein the connection mechanism is configured to connect the adapter plate and the well plate such that the connection therebetween is maintained.

34. A method for synthesising nucleic acids with a synthesis system according to claim 26, wherein the method comprises
synthesising nucleic acids on the microfluidic chip;
selectively releasing synthesised nucleic acids from the microfluidic chip;
guiding released nucleic acids to the collection unit; and
collecting released nucleic acids in a well plate comprised by the collection unit.

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)
